(19) United States
(12) Patent Application Publication
(10) Pub. No.: US 2026/0267472 A1
(43) Pub. Date: Sep. 10, 2026

(54) DISPLAY CONTROL SYSTEM, DISPLAY CONTROL METHOD, AND INFORMATION STORAGE MEDIUM

(71) Applicant: Rakuten Group, Inc., Tokyo (JP)

(72) Inventor: Sachiko FUKUSHIMA, Tokyo (JP)

(21) Appl. No.: 19/548,906

(22) Filed: Feb. 24, 2026

(30) Foreign Application Priority Data
Feb. 27, 2025 (JP) 2025-030156

(51) Int. Cl. G06F 3/0482; G06Q 20/40

(52) U.S. Cl. CPC G06F 3/0482; G06Q 20/4014

(57) ABSTRACT

Provided is a display control system including at least one processor configured to: acquire usage status information regarding a usage status of a selected application, which is, among a plurality of applications used by a user, one of the plurality of applications that is selected by the user; display a user interface (UI) screen including an application area that includes a first UI part corresponding to each of the plurality of applications and a function area that includes a second UI part corresponding to a function of at least one of the selected application or another application, on a user terminal of the user based on the usage status information on the selected application; and switch the selected application based on a selection made for the first UI part in the application area, and change the second UI part displayed in the function area based on the usage status information on the selected application after switching.

### CROSS-REFERENCE TO RELATED APPLICATION

The present application claims priority from the Japanese patent application JP 2025-030156, filed Feb. 27, 2025, the disclosures of which are incorporated by reference herein.

### BACKGROUND OF THE INVENTION

### 1. Field of the Invention

The present disclosure relates to a display control system, a display control method, and an information storage medium.

### 2. Description of the Related Art

Hitherto, with the spread of the Internet, various services have been provided to users. For example, in Japanese Patent Application Laid-open No. 2024-155099, there is described an electronic commerce service in which the user can purchase products online as an example of a service provided to users. In Japanese Patent Application Laid-open No. 2024-155099, it is also described that products are discounted for users to encourage product purchases, and that promotion of a delivery service provided by a delivery company that delivers products is performed.

### SUMMARY OF THE INVENTION

However, in the technology of Japanese Patent Application Laid-open No. 2024-155099, it has not been possible to sufficiently improve convenience of users because functions of the electronic commerce service provided to users are the same for all users. This point also applies to services other than such an electronic commerce service as described in Japanese Patent Application Laid-open No. 2024-155099. In the related art, it has not been possible to sufficiently improve the convenience of users who use functions of a service.

One object of the present disclosure is to increase convenience of a user.

A display control system according to at least one aspect of the present disclosure includes at least one processor configured to: acquire usage status information regarding a usage status of a selected application, which is, among a plurality of applications used by a user, one of the plurality of applications that is selected by the user; display a user interface (UI) screen including an application area that includes a first UI part corresponding to each of the plurality of applications and a function area that includes a second UI part corresponding to a function of at least one of the selected application or another application, on a user terminal of the user based on the usage status information on the selected application; and switch the selected application based on a selection made for the first UI part in the application area, and change the second UI part displayed in the function area based on the usage status information on the selected application after switching.

### BRIEF DESCRIPTION OF THE DRAWINGS

FIG. 1 is a diagram for illustrating an example of a hardware configuration of a display control system.

FIG. 2 is a view for illustrating an example of a screen displayed on a user terminal.

FIG. 3 is a diagram for illustrating an example of functions implemented by a display control system according to a first embodiment of the present disclosure.

FIG. 4 is a table for showing an example of a user database in the first embodiment.

FIG. 5 is a table for showing an example of a promotion database in the first embodiment.

FIG. 6 is a flow chart for illustrating an example of processing executed by the display control system according to the first embodiment.

FIG. 7 is a diagram for illustrating an example of functions implemented by a display control system according to a second embodiment of the present disclosure.

FIG. 8 is a table for showing an example of a user database in the second embodiment.

FIG. 9 is a table for showing an example of a function database in the second embodiment.

FIG. 10 is a flow chart for illustrating an example of processing executed by the display control system according to the second embodiment.

FIG. 11 is a diagram for illustrating an example of cooperation between a display control system and an external system in a third embodiment of the present disclosure.

FIG. 12 is a diagram for illustrating an example of functions implemented by the display control system according to the third embodiment.

FIG. 13 is a flow chart for illustrating an example of processing executed by the display control system according to the third embodiment.

FIG. 14 is a diagram for illustrating an example of functions implemented in modification examples regarding the first embodiment.

FIG. 15 is a view for illustrating an example of an app screen in Modification Example 1-1.

FIG. 16 is a view for illustrating an example of an app screen in Modification Example 1-2.

FIG. 17 is a view for illustrating an example of an app screen in Modification Example 1-4.

FIG. 18 is a view for illustrating an example of an app screen in Modification Example 1-5.

FIG. 19 is a view for illustrating an example of an app screen in Modification Example 1-6.

FIG. 20 is a view for illustrating an example of an app screen in Modification Example 1-7.

FIG. 21 is a view for illustrating an example of an app screen in Modification Example 1-8.

FIG. 22 is a view for illustrating an example of an app screen in Modification Example 1-10.

FIG. 23 is a view for illustrating an example of an app screen in Modification Example 1-11.

FIG. 24 is a view for illustrating an example of an app screen in Modification Example 1-12.

FIG. 25 is a view for illustrating an example of an app screen in Modification Example 1-13.

FIG. 26 is a view for illustrating an example of an app screen in Modification Example 2-1.

FIG. 27 is a view for illustrating an example of an app screen in Modification Example 2-2.

FIG. 28 is a view for illustrating an example of an app screen in Modification Example 2-3.

FIG. 29 is a view for illustrating an example of an app screen in Modification Example 2-4.

FIG. 30 is a view for illustrating an example of an app screen in Modification Example 2-5.

FIG. 31 is a view for illustrating an example of an app screen in Modification Example 2-6.

FIG. 32 is a view for illustrating an example of an app screen in Modification Example 2-7.

FIG. 33 is a view for illustrating an example of an app screen in Modification Example 2-9.

FIG. 34 is a view for illustrating an example of an app screen in Modification Example 2-10.

FIG. 35 is a view for illustrating an example of an app screen in Modification Example 2-11.

FIG. 36 is a diagram for illustrating an example of functions implemented in modification examples regarding the third embodiment.

FIG. 37 is a view for illustrating an example of an app screen in Modification Example 3-1.

FIG. 38 is a view for illustrating an example of an app screen in Modification Example 3-3.

FIG. 39 is a view for illustrating an example of an app screen in Modification Example 3-5.

FIG. 40 is a diagram for illustrating an example of concepts of a first place and a second place.

FIG. 41 is a table for showing an example of a user database in Modification Example 3-6.

FIG. 42 is a view for illustrating an example of an app screen in Modification Example 3-6.

FIG. 43 is a view for illustrating an example of an app screen in Modification Example 3-12.

FIG. 44 is a view for illustrating an example of an app screen in Modification Example 3-13.

### DETAILED DESCRIPTION OF THE INVENTION

### 1. FIRST EMBODIMENT

A first embodiment of the present disclosure, which is an example of at least one embodiment of a display control system, a display control method, and a program according to the present disclosure, is described.

### 1-1. Hardware Configuration of Display Control System according to First Embodiment

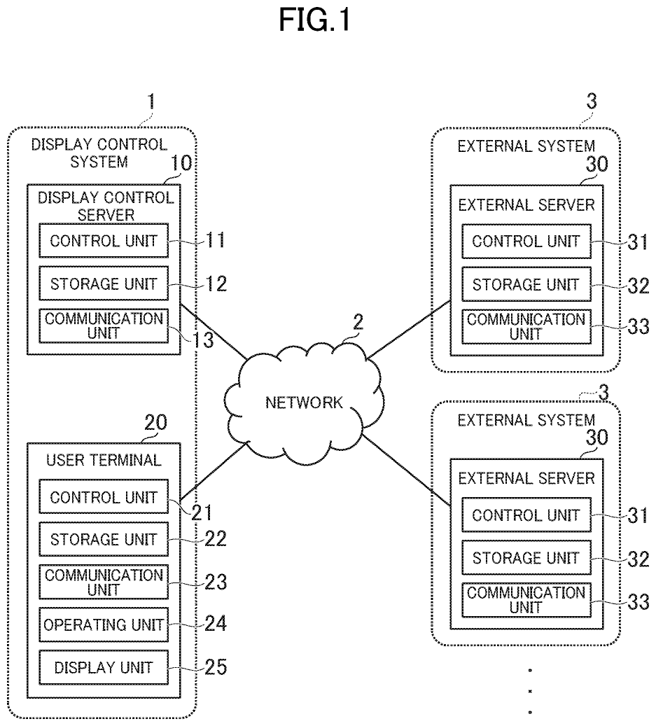

FIG. 1 is a diagram for illustrating an example of a hardware configuration of the display control system. For example, a display control system 1 includes a display control server 10 and a user terminal 20. The display control server 10 and the user terminal 20 are each connected to a network 2 such as the Internet or a LAN. At least one of the display control server 10 or the user terminal 20 may be provided as two or more components.

The display control server 10 is a server computer. For example, the display control server 10 includes a control unit 11, a storage unit 12, and a communication unit 13. The control unit 11 includes at least one processor. The storage unit 12 includes at least one of a volatile memory such as a RAM, or a non-volatile memory such as a flash memory. The communication unit 13 includes at least one of a communication interface for wired communication or a communication interface for wireless communication.

The user terminal 20 is a computer of a user. For example, the user terminal 20 is a smartphone, a tablet computer, a personal computer, or a wearable terminal. The user terminal 20 includes a control unit 21, a storage unit 22, a communication unit 23, an operating unit 24, and a display unit 25. Hardware configurations of the control unit 21, the storage unit 22, and the communication unit 23 may be similar to those of the control unit 11, the storage unit 12, and the communication unit 13, respectively. The operating unit 24 is an input device such as a touch panel or a mouse. The display unit 25 is a display such as a liquid crystal display or an organic EL display.

Programs stored in the storage units 12 and 22 may be supplied to the display control server 10 or the user terminal 20 through the network 2. Further, at least one of a reading unit (for example, a memory card slot) that reads a computer-readable information storage medium or an input/output unit (for example, a USB port) through which data is input from and output to an external device may be included in the display control server 10 or the user terminal 20. For example, a program stored in the information storage medium may be supplied to the display control server 10 or the user terminal 20 through at least one of the reading unit or the input/output unit.

Moreover, the display control system 1 is only required to include at least one computer. The computers included in the display control system 1 are not limited to the example of FIG. 1. For example, the display control system 1 may include only the display control server 10. In this case, the user terminal 20 is present outside the display control system 1. The display control system 1 may include the display control server 10, and another computer which is not shown in FIG. 1.

In the first embodiment, a case in which the display control system 1 can communicate to and from an external system 3 through the network 2 is given as an example. In the example of FIG. 1, the display control system 1 can communicate to and from each of a plurality of external systems 3, but the display control system 1 may be able to communicate to and from only one external system 3. The number of external systems 3 may be any number. The number of external systems 3 is not limited to the example of the first embodiment. For example, the external system 3 includes an external server 30.

The external server 30 is a server computer. For example, the external server 30 includes a control unit 31, a storage unit 32, and a communication unit 33. Hardware configurations of the control unit 31, the storage unit 32, and the communication unit 33 may be similar to those of the control unit 11, the storage unit 12, and the communication unit 13, respectively. Hardware configurations of the individual external systems 3 may be similar to or different from each other. The external systems 3 may have hardware configurations similar to hardware configurations adopted in publicly-known services.

### 1-2. Overview of Display Control System according to First Embodiment

In the first embodiment, a case in which the user operates the user terminal 20 to use a plurality of services is given as an example. The service used by the user may be any service. For example, the user may use an electronic commerce service, a payment service, a financial service, an insurance service, a loyalty point service, a travel reservation service, a communication service, an application receiving service, a transportation service, an identity verification service, or another service.

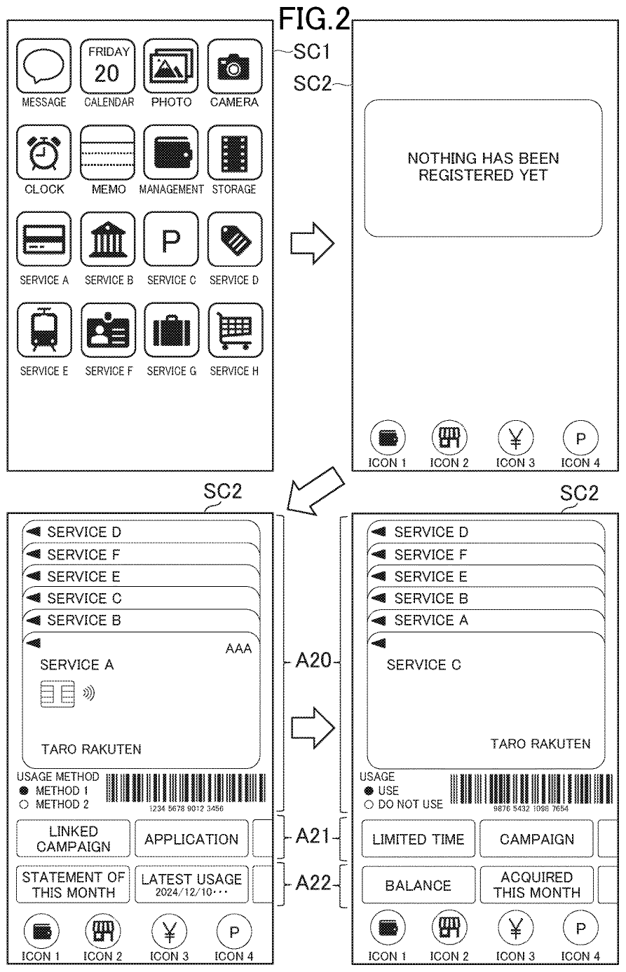

FIG. 2 is a view for illustrating an example of a screen displayed on the user terminal 20. For example, when the user activates the user terminal 20, as illustrated in the upper left part of FIG. 2, the user terminal 20 displays a menu screen SC1 indicating a menu of the user terminal 20 on the display unit 25. In the example in the upper left part of FIG. 2, the menu screen SC1 includes an icon for activating each function included in the user terminal 20. The icon is a rounded rectangular image included in the menu screen SC1. In the example in the upper left part of FIG. 2, reference symbols of the icons are omitted because the number of icons is large.

In the first embodiment, a case in which respective apps of the plurality of services are installed in the user terminal 20 is given as an example. The “app” is an abbreviation for “application.” The app is a kind of program. The user uses the service from the app of each of the plurality of services. The user may use at least one of the plurality of services by means other than the app. For example, the other means may be a browser, a program not classified as an app, an IC chip of the user terminal 20, a wireless communication function of the user terminal 20, or a physical card.

In the example in the upper left part of FIG. 2, the “management” indicates a management app that is an app of a management service. The management service can also be said to be a service for managing management target information, which is information to be managed. For example, the management target information is information registered in an electronic wallet. The management target information may be electronic information similar to information managed by a physical wallet, or may be electronic information similar to information not managed by a physical wallet.

In the first embodiment, a case in which electronic information on each of a card of a service A, a card of a service B, a card of a service C, a card of a service E, a card of a service F, and a ticket corresponds to the management target information is given as an example. The management target information is only required to be information managed by an electronic wallet. The management target information is not limited to the example of the first embodiment. The management target information may be information regarding money or information not particularly relating to money. For example, the management target information may be information on a credit card, electronic money, a balance of some value that is not called electronic money, crypto assets, a debit card, a gift certificate, a coupon, a receipt, an insurance card, an individual number card, a warranty card, an employee ID card, an admission pass, another document, or another matter.

In the example in the upper right part of FIG. 2, management target information has not been registered in the management service yet. For example, when the user issues a card of the service A through the service A, the card of the service A is registered in the management service. When the user issues a card of the service B through the service B, the card of the service B is registered in the management service. When the user issues a card of the service C through the service C, the card of the service C is registered in the management service. When the user issues a card of the service E through the service E, the card of the service E is registered in the management service. Some kind of management target information may be registered in the management service by default (from an initial time point).

For example, when the user performs possession authentication in the service F in which possession authentication of a card of the service F is performed, the card of the service F for which the user has performed possession authentication is registered in the management service. When the user purchases a ticket through a service D provided by a ticket sales company, the ticket is registered in the management service. In regard to other management target information as well, another piece of management target information is registered in the management service. When a plurality of pieces of management target information are registered in the management service, as illustrated in the lower left part of FIG. 2, the user terminal 20 displays an app screen SC2 indicating the respective pieces of management target information on the display unit 25.

In the first embodiment, a case in which the app screen SC2 includes a service area A20 and a promotion area A21 is given as an example. In the example in the lower left part of FIG. 2, a case in which the app screen SC2 also includes a function area A22 is described, but details of the function area A22 are described in a second embodiment of the present disclosure. In the first embodiment, the app screen SC2 is not required to include the function area A22. An aspect in which the app screen SC2 includes the service area A20 and the promotion area A21 and does not include the function area A22 is also within the scope of the present disclosure.

For example, in the service area A20, a service in which management target information is registered in the management service is indicated. That is, in the service area A20, a service that can be used by the user through the management service is indicated. The management service can also be said to be a service mediating between the user and a service used by the user. In the first embodiment, the user can select any service from the plurality of services indicated in the service area A20. The number of services displayed in the service area A20 may be any number. The number of services displayed in the service area A20 is not limited to the example of the first embodiment.

In the example in the lower left part of FIG. 2, six services including the card of the service A, the service B, the service C, the service E, the service F, and the service D are displayed as the plurality of services in the service area A20. For example, as the pieces of management target information of the six services, images (for example, rounded rectangular images) imitating respective card faces of the card of the service A, the card of the service B, the card of the service C, the card of the service E, the card of the service F, and the ticket are displayed in the service area A20. The respective card faces are displayed so as to overlap each other. Among services indicated by the respective card faces, a card face corresponding to the selected service is displayed at the frontmost position.

The service indicated by the frontmost card face in the example in the lower left part of FIG. 2 is hereinafter referred to as “selected service.” In the example in the lower left part of FIG. 2, the management target information of the card of the service A is indicated on the frontmost card face, and hence the selected service is the card of the service A. When the selected service is the card of the service A, a code (for example, a barcode or a two-dimensional code) for the user to make card payment for the service A may be displayed in the service area A20. When the card of the service A is also compatible with payment (for example, electronic money payment or loyalty point payment) other than the card payment for the service A, a code for the other payment may be displayed in the service area A20.

For example, in the promotion area A21, a promotion corresponding to the selected service is indicated. A promotion is information for advertising a product or service. A promotion can also be said to be information for sales promotion or promotion for use of a product or service. An advertisement is an example of a promotion. The format of a promotion may be any format. For example, a promotion may be characters, symbols not classified as characters, images, moving images, a user interface part, or a combination thereof.

For example, the promotion may include a link to a page (for example, a page of the management app, a page of another app, or a web page) of a product or service targeted by the promotion. Details of the promotion may be displayed on those pages. The promotion may be a user interface part for displaying a window, a pop-up, or the like on the app screen SC2. Details of the promotion may be displayed on the window, the pop-up, or the like.

In the example in the lower left part of FIG. 2, the selected service is the card of the service A, and hence a promotion corresponding to the card of the service A is displayed in the promotion area A21. For example, a campaign linked to the service C, a proposal to apply for a second card of the service A, a proposal for installment payment, a proposal for revolving payment, a proposal for bonus-month-increased installment payment, a proposal for cashing, or other information is displayed as the promotion. The promotion corresponding to the card of the service A may be a promotion of the card of the service A itself, or may be a promotion of another service associated with the card of the service A (for example, the service C of a loyalty point operator partnering with a card company).

In the first embodiment, the user can change the selected service by performing an operation on the service area A20. That is, the user can change the card face displayed at the frontmost position by performing an operation on the service area A20. For example, when the user selects a card face (the second or subsequent card face) other than the frontmost card face, the service indicated by the other card face is selected as the selected service. The service indicated by the card face that was frontmost until then ceases to be the selected service. Selection of the other card face may be performed by any operation. For example, the user may select the other card face by an operation such as tap, flick, double tap, long press, click, double click, drag-and-drop, or Selection of a predetermined key of a keyboard, or another operation.

For example, when the user selects the card face of the service C, as illustrated in the lower right part of FIG. 2, the card face of the service C moves to the frontmost position. The card face of the card of the service A, which has been displayed at the frontmost position until then, moves to the second place. The card face of the card of the service A may move to the third or subsequent place (for example, the backmost position). When the selected service becomes the service C, a code (for example, a barcode or a two-dimensional code) for loyalty point payment may be displayed in the service area A20. The user terminal 20 updates the display of the promotion area A21 such that a promotion (for example, a limited-time coupon, a loyalty point increase campaign, or information on stores in which the service C can be used) corresponding to the service C that is the selected service is displayed.

Similarly, when the user changes the selected service to another service, the user terminal 20 updates the display of the promotion area A21 such that a promotion corresponding to the other service is displayed. For example, when the selected service is changed to the service B, a promotion (for example, an advertisement for a time deposit, an advertisement for a housing loan, or a campaign) corresponding to the service B is displayed in the promotion area A21. When the selected service is changed to the service E, a promotion (for example, an event held in a facility such as a station, an advertisement for a discount ticket, a coupon, or a campaign) corresponding to the service E is displayed in the promotion area A21.

For example, when the selected service is changed to the service F, a promotion (for example, details of an authenticated identification card, details of a membership card, an advertisement for a service made available by authentication, or a campaign) corresponding to the service F is displayed in the promotion area A21. When the selected service is changed to the service D, a promotion (for example, an advertisement for an event for which tickets are to be sold, information on a ticket sales method, or a campaign) corresponding to the service D is displayed in the promotion area A21.

As described above, the display control system 1 according to the first embodiment displays, on the user terminal 20, the app screen SC2 including a promotion corresponding to the selected service. This allows the user to more easily identify which promotion belongs to which service, and hence the display control system 1 can improve convenience of the user. Details of the display control system 1 according to the first embodiment are described below.

### 1-3. Functions Implemented by Display Control System According to First Embodiment

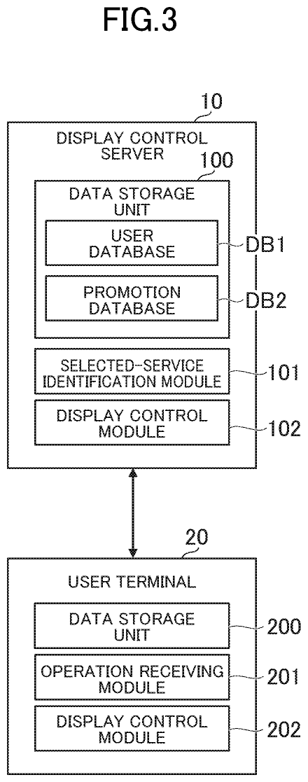

FIG. 3 is a diagram for illustrating an example of functions implemented by the display control system 1 according to the first embodiment. The respective functions of FIG. 3 can be configured by, for example, combining the functions in one device or further distributing the devices.

### 1-3-1. Functions Implemented by Display Control Server in First Embodiment

For example, the display control server 10 includes a data storage unit 100, a selected-service identification module 101, and a display control module 102. The data storage unit 100 is implemented by the storage unit 12. Each of the selected-service identification module 101 and the display control module 102 is implemented by the control unit 11.

### [Data Storage Unit]

The data storage unit 100 stores various kinds of data for processing in the first embodiment. For example, the data storage unit 100 stores a user database DB1 and a promotion database DB2.

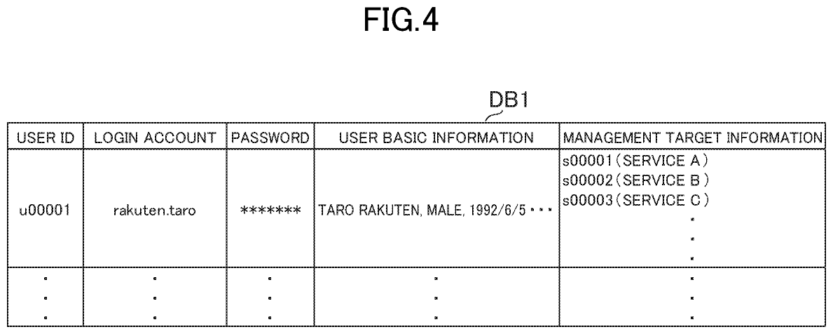

FIG. 4 is a table for showing an example of the user database DB1 in the first embodiment. The user database DB1 is a database in which various pieces of information of each of a plurality of users are stored. For example, a user ID, a login account, a password, user basic information, and the management target information are stored in the user database DB1. Information stored in the user database DB1 is not limited to the example of FIG. 4. Other information may be stored in the user database DB1. For example, information (for example, a number capable of temporarily identifying a user) required to display a code in the service area A20 in the lower left part or lower right part of FIG. 2 may be stored in the user database DB1.

The user ID is an example of user identification information capable of identifying the user. The login account is also an example of user identification information. The login account is user identification information input by the user to log in to each service. The login account may be freely changeable by the user. The user ID is user identification information managed separately from the login account.

In the first embodiment, a case in which a login account is present separately from the user ID (a case in which at least two pieces of user identification information are present) is given as an example, but there may be only one piece of user identification information. That is, the user ID and the login account are not required to be managed separately. The password is authentication information verified at a time of login. The login account and the password may be biological information of the user.

In the first embodiment, a case in which the user ID of the display control system 1 (for example, the user ID of the management service) and the user ID of the external system 3 (for example, the user ID of the service A, the service B, the service C, the service F, the service E, or the service D) are common is given as an example. For that reason, a certain user is identified by the same user ID in the display control system 1 and the external system 3.

The user ID of the display control system 1 and the user ID of the external system 3 may be different from each other instead of being common. In this case, association between the user ID of the display control system 1 and the user ID of the external system 3 is managed in at least one of the display control system 1 or the external system 3. For example, the display control system 1 may manage the association between the user IDs in the user database DB1 or another database. The external system 3 may manage the association between the user IDs in a database stored in the external system 3 itself. At least one of the display control system 1 or the external system 3 can identify which user has which user ID by the association between the user IDs.

The user basic information is basic information regarding the user. The user may be allowed to edit the user basic information of the user. The user basic information may be information called demographics. The user basic information may indicate attributes of the user. For example, the user basic information indicates a full name, a gender, a birth date, an age or age group, an address, preference, occupation, and information on a place of work of the user, types of services in use by the user, and a combination thereof.

The management target information stored in the user database DB1 is the management target information registered in the management service. The management target information is information regarding a service other than the management service. For example, the management target information may indicate a service ID capable of identifying a service indicated by the management target information. The service ID is an example of service identification information capable of identifying a service. The service identification information may be information other than the service ID. For example, the service identification information may be a name of a service, an ID of an operator providing a service, a name of an operator providing a service, or other information. The management target information may indicate information other than the service ID.

For example, the management target information may indicate specific content to be displayed in the service area A20. The management target information may be information of the card of the service A (for example, all or part of a card number of the card of the service A, a cardholder, an expiration date, a card type, or a design), information of the card of the service B (for example, a name of a financial institution, a branch name, all or part of an account number, a cardholder, a card type, or a design), information of the card of the service C (for example, all or part of a card number of the card of the service C, a loyalty point name, or a loyalty point balance), information of the card of the service E (for example, a section, an amount, an expiration date, or a full name) , information of an identification card and a membership card (for example, a type of identification card, a type of membership card, or content stated on the card face of each thereof), or information of a ticket (for example, content stated on the card face of the ticket).

For example, when a certain user logs in to the management service and performs an operation of registering the management target information, the display control server 10 updates the user database DB1 such that the management target information is associated with the user ID of the user. In the first embodiment, it is assumed that the display control system 1 and the external system 3 cooperate with each other, and the display control server 10 can acquire the management target information from the external system 3. The display control server 10 acquires the management target information managed by the external system 3, and stores the management target information in the user database DB1. The external system 3 is assumed to store information serving as a source of the management target information.

The management target information may be input by the user instead of being acquired from the external system 3. In this case, the display control server 10 may acquire the management target information input by the user from the user terminal 20, and store the management target information in the user database DB1. The management target information may be stored in the user terminal 20. The display control server 10 may acquire the management target information stored in the user terminal 20 from the user terminal 20, and store the management target information in the user database DB1. The management target information may be registered automatically by the display control system 1 and the external system 3 cooperating with each other. Processing executed when the management target information is registered automatically is described in a third embodiment of the present disclosure. Processing similar to that in the third embodiment may be executed in the display control system 1 according to the first embodiment as well.

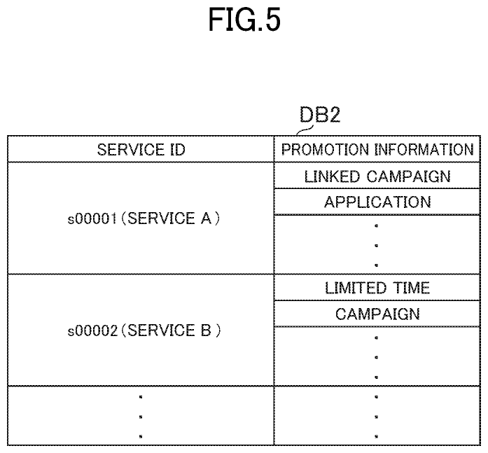

FIG. 5 is a table for showing an example of the promotion database DB2 in the first embodiment. The promotion database DB2 is a database in which various pieces of information for promotion are stored. For example, the service ID and promotion information are stored in the promotion database DB2. Information stored in the promotion database DB2 is not limited to the example of FIG. 5. Other information may be stored in the promotion database DB2. For example, a condition for displaying a promotion may be stored in the promotion database DB2.

The service ID stored in the promotion database DB2 is the service ID of a service targeted by a promotion. For example, service IDs of all services for which the management target information can be registered in the management service may be stored in the promotion database DB2, or service IDs of some services may be stored in the promotion database DB2. When a promotion of a service for which the management target information is not registered in the management service is performed, the service ID of the service may be stored in the promotion database DB2. The promotion information itself may indicate a service to which the promotion belongs. In this case, the service ID is not required to be associated with the promotion information.

The promotion information is information required to display a promotion. A data format of the promotion information may be similar to a data format adopted in a publicly-known promotion. For example, the promotion information indicates characters indicating specific content of a promotion, symbols other than characters, an image of the promotion, a moving image of the promotion, a link to a page of a product or service targeted by the promotion, or a combination thereof. When a plurality of promotions are present for a single service, the promotion information for each of the plurality of promotions is stored in the promotion database DB2.

Data stored in the data storage unit 100 is not limited to the above-mentioned example. The data storage unit 100 may store other data. For example, the data storage unit 100 may store data required to display the app screen SC2 or another screen. The data storage unit 100 may store data such as an image to be displayed in each of the service area A20, the promotion area A21, and the function area A22 of the app screen SC2. The data storage unit 100 may store data required to switch the display of the app screen SC2 or another screen.

### [Selected-Service Identification Module]

The selected-service identification module 101 identifies the selected service that is a service selected by the user from among a plurality of services available to the user through use of an app stored in the user terminal 20. In the first embodiment, the management app is described as an example of the app, but the app may be an app other than the management app. For example, the app may be an app of an electronic commerce service, each of the services A to H, a communication service, an application receiving service, or another service. The app may be an app called a super app, or a regular app that is not particularly called a super app. The management app as used herein as an example can be read as any other app.

In the first embodiment, a case in which the user selects the selected service is given as an example. The selected-service identification module 101 identifies the selected service selected by the user from among a plurality of services. For example, when the user operates the user terminal 20 to select the selected service, the user terminal 20 transmits the service ID of the selected service to the display control server 10. In the example in the lower left part and the lower right part of FIG. 2, the user selects the selected service in the service area A20. The selected-service identification module 101 identifies a service indicated by the service ID received by the display control server 10 as the selected service. It is assumed that the user terminal 20 has received the service ID of each of the plurality of services displayed in the service area A20 from the display control server 10 before the app screen SC2 is displayed.

The user terminal 20 may store the service ID of the selected service that was last selected when the management app was last started. In addition, for example, the user terminal 20 may store the service ID of the selected service designated by the user as a default selected service. In those cases, the user terminal 20 transmits the service ID stored therein to the display control server 10. The selected-service identification module 101 identifies the service indicated by the service ID received by the display control server 10 as the selected service.

In addition, the service ID of the selected service that was last selected when the management app was last started may be stored in the user database DB1. Further, for example, the service ID of the selected service designated by the user as the default selected service may be stored in the user database DB1. In those cases, the selected-service identification module 101 may identify the service indicated by the service ID stored in the user database DB1 as the selected service.

The selected service may be selected automatically by information processing instead of selection by the user. The selected-service identification module 101 may identify at least one of the selected service selected by the user or the selected service selected automatically. When the selected service is selected automatically, the selected-service identification module 101 may identify a service of which a usage frequency by the user is a threshold value or more as the selected service, or conversely, identify a service of which the usage frequency by the user is less than the threshold value as the selected service. The selected-service identification module 101 may identify a service of which the usage frequency by the user is the highest among a plurality of services as the selected service, or conversely, identify a service of which the usage frequency by the user is the lowest as the selected service. The usage frequency of each service may be stored in the user database DB1 or another database.

For example, for a service in which some payment occurs, the selected-service identification module 101 may identify a service in which a payment amount of the user is equal to or greater than a threshold value as the selected service, or conversely, may identify a service in which the payment amount of the user is less than a threshold value as the selected service., The selected-service identification module 101 may identify a service in which the payment amount of the user is the highest among a plurality of services as the selected service, or conversely, may identify a service in which the payment amount of the user is the lowest as the selected service. The payment amount for each service may be stored in the user database DB1 or another database. The selected-service identification module 101 may identify the selected service based on a payment amount of a certain single transaction, or may identify the selected service based on a total amount or an average amount of payment amounts in a certain period (for example, the last one month).

### [Display Control Unit]

The display control module 102 displays, on the user terminal 20, the app screen SC2 regarding the app and including a promotion corresponding to the selected service. As described in the section of the selected-service identification module 101, the management app is described as an example of the app in the first embodiment. The app screen SC2 may be a screen of any other app. The display control module 102 is a function on the display control server 10 side, and hence the display control module 102 displays, on the user terminal 20, the app screen SC2 by transmitting display data of the app screen SC2 to the user terminal 20.

For example, the display control module 102 acquires the promotion information of the selected service from the promotion database DB2, and generates display data of the app screen SC2 based on the acquired promotion information. The display data may be data of the entire app screen SC2 or data of a part of the app screen SC2. The display data may be in any format. For example, the display data may be data in a markup language such as HTML or data in an image format such as JPEG.

In the first embodiment, the display control module 102 displays, on the user terminal 20, the app screen SC2 including the service area A20 for display regarding the selected service and the promotion area A21 for display regarding a promotion. The display control module 102 determines the content of the service area A20 based on the management target information stored in the user database DB1. For example, the display control module 102 determines the content of the service area A20 such that each of a plurality of services for which the management target information is registered in the management service is indicated.

For example, the display control module 102 determines the content of the promotion area A21 based on the promotion information of the selected service stored in the promotion database DB2. The display control module 102 may arrange characters and the like indicated by the promotion information in the promotion area A21 as they are, or may arrange, when a plurality of pieces of promotion information are present, promotions respectively indicated by the plurality of pieces of promotion information in the promotion area A21 in a predetermined order. The display control module 102 displays, on the user terminal 20, the app screen SC2 by generating display data of the app screen SC2 including the service area A20 and the promotion area A21 having the content determined as described above and by transmitting the generated display data to the user terminal 20.

In the example in the lower left part and the lower right part of FIG. 2, a case in which the card face imitating a card is displayed in the service area A20 is given as an example, but individual services can be displayed in any format. Individual services may be displayed in a format other than the card face. For example, individual services may be displayed in a tab format, an icon format, or a window format. Similarly, the promotion area A21 is not limited to the example in the lower left part and the lower right part of FIG. 2. At least one promotion may be displayed in the promotion area A21.

The display control module 102 may display a promotion corresponding to the selected service, on the app screen SC2 that does not include the service area A20 and the promotion area A21. That is, the app screen SC2 is not required to be divided into the service area A20 and the promotion area A21. The app screen SC2 may include the promotion area A21 without particularly including the service area A20. When the app screen SC2 includes the service area A20 and the promotion area A21, a positional relationship between the service area A20 and the promotion area A21 is not limited to the example in the lower left part and the lower right part of FIG. 2. For example, the service area A20 may be arranged below the promotion area A21.

Further, the display control module 102 may display the service area A20 and the promotion area A21 on different screens. In this case, when the user selects the selected service in the service area A20 of a certain screen, the display control module 102 may cause the screen H the user terminal 20 to transition to another screen including the promotion area A21. The other screen may be a screen such as a pop-up or a window. For example, when the user selects the selected service in the service area A20 of a payment source screen for selecting a payment source in payment, the display control module 102 may cause the screen of the user terminal 20 to transition to a top screen including the promotion area A21.

### 1-3-2. Functions Implemented by User Terminal in First Embodiment

For example, the user terminal 20 in the first embodiment includes a data storage unit 200, an operation receiving module 201, and a display control module 202. The data storage unit 200 is implemented by the storage unit 22. The operation receiving module 201 and the display control module 202 are implemented by the control unit 21.

### [Data Storage Unit]

The data storage unit 200 stores data required for the user to use each service. For example, the data storage unit 200 stores the management app and an app of a service other than the management service. When the user uses a service from a browser rather than those apps, the data storage unit 200 stores the browser.

### [Operation Receiving Module]

The operation receiving module 201 receives various operations from the user. For example, the operation receiving module 201 receives an operation on an app. The operation receiving module 201 transmits data indicating the content of the operation of the user to the display control server 10.

### [Display Control Unit]

The display control module 202 displays various screens on the display unit 25. For example, the display control module 202 displays the app screen SC2 on the display unit 25. The display control module 202 communicates to and from the display control server 10, receives display data of the app screen SC2, and displays the app screen SC2 on the display unit 25 based on the display data. The display data is data required to display a screen. The display data may be data of an entire screen, or data of a part of the screen. For example, the display data may be data in a markup language such as HTML, image data, text data, or other data.

### 1-4. Processing Executed by Display Control System According to First Embodiment

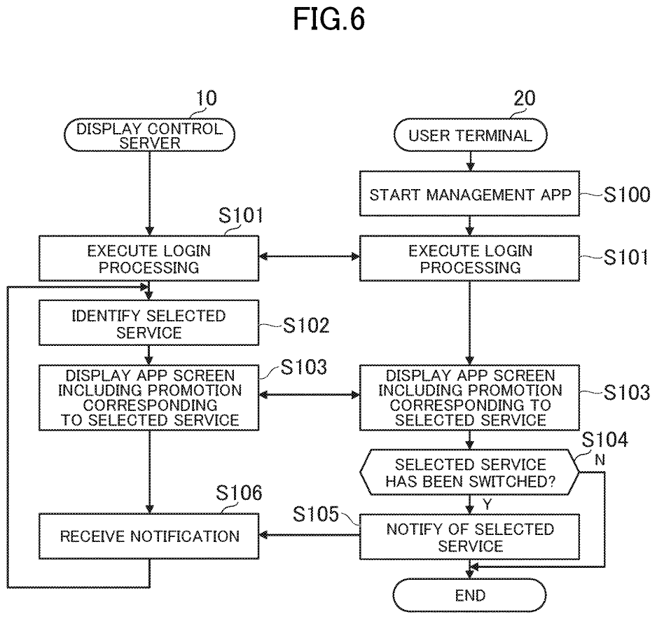

FIG. 6 is a flow chart for illustrating an example of processing executed by the display control system 1 according to the first embodiment. In FIG. 6, processing for displaying the app screen SC2 among processes executed by the display control system 1 is illustrated. The control units 11 and 21 execute programs stored in the storage units 12 and 22, respectively, to thereby execute the processing of FIG. 6. Steps of FIG. 6 are an example of the display control method.

As illustrated in FIG. 6, when the user selects an icon of the management app on the menu screen SC1, the user terminal 20 starts the management app (Step S100). The user terminal 20 cooperates with the display control server 10 to execute login processing for the user to log in to the management service (Step S101). When the login processing is successful, the display control server 10 identifies the selected service (Step S102). The method of identifying the selected service is as described in the processing of the selected-service identification module 101. For example, a previous selected service is identified immediately after the management app is started.

The display control server 10 cooperates with the user terminal 20 to execute processing for displaying the app screen SC2 including a promotion corresponding to the selected service identified in Step S102 based on the user database DB1 and the promotion database DB2 (Step S103). The processing executed in Step S103 is as described in the processing of the display control module 102 in the first embodiment. In Step S103, the display control server 10 generates display data of the app screen SC2 and transmits the display data to the user terminal 20, to thereby display the app screen SC2 on the user terminal 20.

The user terminal 20 determines whether or not the user switches the selected service (Step S104). When it is determined in Step S104 that the user switches the selected service (Y in Step S104), the user terminal 20 notifies the display control server 10 of the selected service selected by the operation (Step S105). When the display control server 10 receives the notification from the user terminal 20 (Step S106), the process proceeds to Step S102, and the display control server 10 identifies a new selected service by referring to the notification. After that, the processing step of Step S103 is executed, and the app screen SC2 is updated.

When it is not determined in Step S104 that the user switches the selected service (N in Step S104), this process ends. When the user selects the promotion displayed in the promotion area A21, the user terminal 20 may access a linked page based on a link indicated by the selected promotion. The user terminal 20 may display, on the app screen SC2, a pop-up or a window corresponding to the promotion selected by the user instead of displaying the linked page. In a case in which a code for payment is displayed in the service area A20, when the code is read by a terminal of a store or the like, processing for payment may be executed by the terminal.

### 1-5. Summary of First Embodiment

The display control system 1 according to the first embodiment identifies the selected service among the plurality of services available to the user in the management app. The display control system 1 displays, on the user terminal 20, the app screen SC2 including the promotion corresponding to the selected service. Thus, the display control system 1 is able to improve the convenience of the user because the user becomes able to more easily grasp which promotion belongs to which service on the app screen SC2.

Further, the display control system 1 displays, on the user terminal 20, the app screen SC2 including the service area A20 and the promotion area A21. Thus, the display control system 1 is able to further improve the convenience of the user because the user is able to view the selected service in the service area A20 of the app screen SC2 and view the promotion in the promotion area A21. For example, when the service area A20 and the promotion area A21 are included in the same app screen SC2, the user becomes able to grasp which promotion belongs to which service on the same app screen SC2.

### 2. SECOND EMBODIMENT

Next, the second embodiment, which is an example of another embodiment according to the present disclosure, is described. In the first embodiment, the configuration for displaying the promotion corresponding to the selected service is mainly described, but in the second embodiment, a configuration for displaying a function corresponding to the usage status of a certain service is described. The configuration of the second embodiment is a configuration for displaying the function area A22 in the examples of the app screen SC2 in the lower left part and the lower right part of FIG. 2. In the second embodiment, description of the same matters as those of the first embodiment is omitted.

### 2-1. Overview of Display Control System According to Second Embodiment

In the second embodiment, similarly to the first embodiment, a case in which the user uses the management service from the management app is given as an example. The second embodiment is similar to the first embodiment in that the services available to the user are not limited to the management service. The second embodiment is also similar to the first embodiment in that the user may use the service by means other than the app. An example of the other means is as described in the first embodiment.

For example, when the user registers a plurality of pieces of management target information in the management service, the user terminal 20 displays the app screen SC2 similar to the lower left part of FIG. 2 on the display unit 25. The app screen SC2 includes the function area A22. In the example in the lower left part of FIG. 2, the function area A22 is an area for display regarding a function corresponding to the selected service. For example, in the function area A22, a user interface part (for example, a button, a check box, a bar, an input form, or an icon) for the user to use a certain function, information managed by a certain function, content of information processing of a certain function, a link to a page of a certain function, or other information is displayed.

In the example in the lower left part of FIG. 2, the card of the service A is selected as the selected service. In the function area A22, information corresponding to the usage status of the user regarding the card of the service A is displayed. For example, in the function area A22, information on a shopping credit limit of the card of the service A of the user, information on the usage history of the card of the service A in a certain month, a user interface part for changing a payment method (for example, lump-sum payment, installment payment, revolving payment, or bonus-month-increased installment payment) in a certain payment, a link for transitioning to the page of the card of the service A, or other information is displayed.

For example, when the user changes the selected service, the user terminal 20 updates the display of the function area A22 based on the usage status of the user in the selected service after the change as illustrated in the lower right part of FIG. 2. In the example in the lower right part of FIG. 2, the selected service has been changed to the service C, and hence information corresponding to the usage status of the user in the service C is displayed in the function area A22. For example, a balance of loyalty points owned by the user, a loyalty point acquisition status, a loyalty point usage history, a link for transitioning to the page of the service C, or other information is displayed in the function area A22.

Similarly, when the user changes the selected service to another service, the user terminal 20 updates the display of the function area A22 based on the usage status of the user in the other service. For example, when the selected service is changed to the service B, information (for example, a deposit balance, a transfer destination registered by the user, or passbook details) corresponding to the usage status of the user in the service B is displayed in the function area A22. When the selected service is changed to the service E, information (for example, an entry history, an exit history, a usage history of electronic money attached to the card of the service E, or a money addition history of the electronic money) corresponding to the usage status of the user in the service E is displayed in the function area A22.

For example, when the selected service is changed to the service F, information (for example, a usage history of an identification card, a usage history of a membership card, a usage history of electronic money attached to the identification card and the membership card, or a money addition history of the electronic money) corresponding to the usage status of the user in the service F is displayed in the function area A22. When the selected service is changed to the service D, information (for example, content of purchased tickets, content of used tickets, or information on lottery results of tickets) corresponding to the usage status of the user in the service D is displayed in the function area A22.

As described above, the display control system 1 according to the second embodiment displays, on the user terminal 20, the app screen SC2 including information on a function corresponding to the usage status of the user in a certain service. Thus, the display control system 1 is able to improve the convenience of the user because the user is able to know information regarding the function corresponding to the usage status of the user. Details of the display control system 1 according to the second embodiment are described below.

### 2-2. Functions Implemented by Display Control System According to Second Embodiment

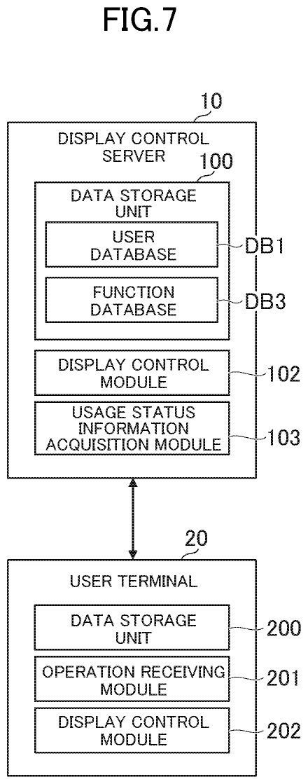

FIG. 7 is a diagram for illustrating an example of functions implemented by the display control system 1 according to the second embodiment. The respective functions of FIG. 7 can be configured by, for example, combining the functions in one device or further distributing the devices.

### 2-2-1. Functions Implemented by Display Control Server in Second Embodiment

For example, the display control server 10 in the second embodiment includes the data storage unit 100, the display control module 102, and a usage status information acquisition module 103. The usage status information acquisition module 103 is implemented by the control unit 11. Some functions of the data storage unit 100 and the display control module 102 in the second embodiment are different from those in the first embodiment.

In the example of FIG. 7, a case in which the display control system 1 does not include some of the functions described in the first embodiment is illustrated. The display control system 1 according to the second embodiment is not required to include some of the functions described in the first embodiment. That is, the display control system 1 according to the second embodiment is not required to include the selected-service identification module 101 and the function for displaying a promotion in the display control module 102. An aspect in which the display control system 1 according to the second embodiment does not include some of the functions described in the first embodiment and does not solve the problem corresponding to the first embodiment is also within the scope of the present disclosure. This point is a matter that can be naturally understood from the description of the present disclosure by those skilled in the art.

The display control system 1 according to the second embodiment may include the functions described in the first embodiment. That is, the display control system 1 according to the second embodiment may include the selected-service identification module 101 and the function for displaying a promotion in the display control module 102. In other words, the first embodiment and the second embodiment may be combined. An aspect in which the display control system 1 according to the second embodiment includes the functions described in the first embodiment and solves both the problem corresponding to the first embodiment and the problem corresponding to the second embodiment is also within the scope of the present disclosure. This point is also a matter that can be naturally understood from the description of the present disclosure by those skilled in the art.

### [Data Storage Unit]

The data storage unit 100 stores the user database DB1 and a function database DB3. In the second embodiment, a case in which the user database DB1 is different from that in the first embodiment is given as an example, but the user database DB1 may be similar to that in the first embodiment. In the second embodiment, the data storage unit 100 is not required to store the promotion database DB2. When the first embodiment and the second embodiment are combined, the data storage unit 100 may store the promotion database DB2.

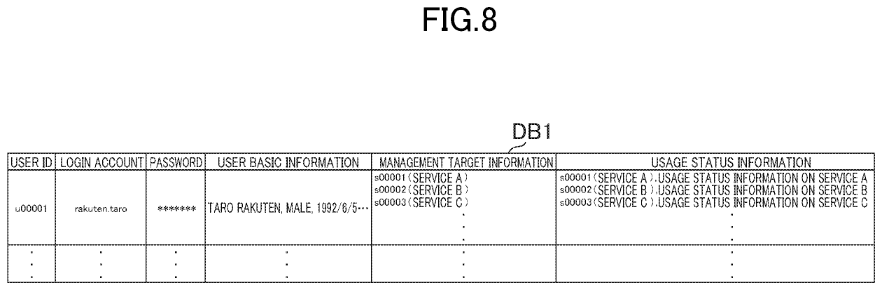

FIG. 8 is a table for showing an example of the user database DB1 in the second embodiment. In the second embodiment, a case in which usage status information is stored in the user database DB1 is given as an example. In the example of FIG. 8, information other than the usage status information may be similar to that in the first embodiment. For example, when the user uses a plurality of services, the usage status information on each of the plurality of services is stored in the user database DB1. When the user uses only one service, the usage status information on one service is stored in the user database DB1. The service indicated by the usage status information is a service different from the management service.

The usage status information is information regarding the usage status of the service. The usage status can also be said to be a usage history. For example, the usage status information may be a login date and time, a function (for example, payment, reservation application, or authentication) used by the user in the service, a usage date and time of the function, a browsing history of pages by the user, operation content on an app or a page, or other information. The usage status information may indicate whether or not the service is used (for example, whether or not the user possesses the card of the service A). In the second embodiment, the latest usage status information is assumed to be stored in the external system 3. When a certain user uses the service, the external system 3 updates the usage status information of the user. The display control server 10 acquires the latest usage status information of the user from the external system 3, and stores the latest usage status information in the user database DB1.

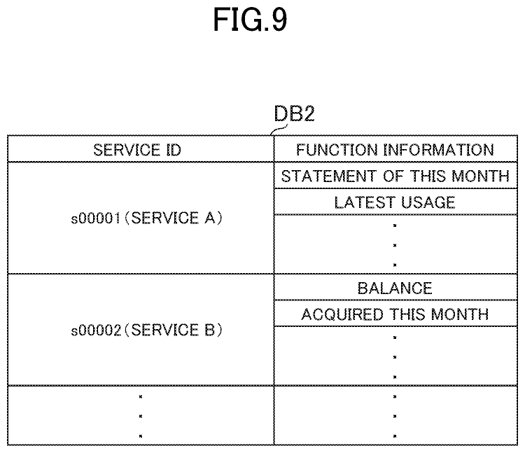

FIG. 9 is a table for showing an example of the function database DB3 in the second embodiment. The function database DB3 is a database storing information regarding a function of each of a plurality of services. For example, the service ID and function information are stored in the function database DB3. Information stored in the function database DB3 is not limited to the example of FIG. 9. Other information may be stored in the function database DB3.

The function information associated with a certain service ID indicates a function of a service identified by the service ID. The function information can also be said to be information for displaying the content of the function in the function area A22. The function information associated with a certain service ID indicates a function displayed in the function area A22 among the functions of the service identified by the service ID. The function information can also be said to be an item displayed in the function area A22. For example, the function information may indicate characters, symbols not classified as characters, images, moving images, or a combination thereof. When a plurality of functions are present for a certain single service, a plurality of pieces of function information may be associated with the service ID of the service. The function information may include information (for example, a link or an API request) for the user terminal 20 to access the external server 30 corresponding to the function indicated by the function information.

For example, the function information indicating a function in the card of the service A (for example, change of the payment method, transitioning to a page of the card of the service A, or another function) is associated with the service ID identifying the card of the service A. The function information indicating a function (for example, display of a deposit balance, display of a transfer destination registered by the user, display of passbook details, or another function) in the service B is associated with the service ID identifying the service B. Similarly for other services, the function information indicating a function in each of the other services is associated with the service ID identifying the corresponding service.

### [Usage Status Information Acquisition Module]

The usage status information acquisition module 103 acquires the usage status information regarding a usage status of the user in a service used by the user. For example, the usage status information acquisition module 103 acquires the usage status information on the selected service that is a service selected by the user among a plurality of services. In the second embodiment, a case in which the usage status information acquisition module 103 acquires the usage status information on the selected service is given as an example, but the usage status information acquisition module 103 may acquire the usage status information on a service other than the selected service. For example, the usage status information acquisition module 103 may acquire the usage status information on another service associated with the selected service. The service to be acquired by the usage status information acquisition module 103 may be determined in advance instead of being determined based on the selected service.

In the second embodiment, the case in which the usage status information is stored in the user database DB1 is given as an example, and hence the usage status information acquisition module 103 acquires the usage status information from the user database DB1. For example, when a certain user selects a certain selected service, the usage status information acquisition module 103 acquires the usage status information associated with the user ID of the user and the service ID of the selected service from the user database DB1. When the usage status information is stored in a database other than the user database DB1, a computer other than the display control server 10, or an information storage medium, the usage status information acquisition module 103 may acquire the usage status information from the other database, the other computer, or the information storage medium.

### [Display Control Unit]

The display control module 102 displays, on the user terminal 20 of the user, a function screen regarding a function f at least one of the service for which the usage status information has been acquired or another service different from the service based on the usage status information. The display control module 102 is a function on the display control server 10 side, and hence the display control module 102 displays, on the user terminal 20, the function screen by transmitting display data of the function screen to the user terminal 20. The function screen may indicate functions of both the service for which the usage status information has been acquired and the other service. The function screen may indicate the function of the service for which the usage status information has been acquired and may not indicate the function of the other service. The function screen may indicate the function of the other service without indicating the function of the service for which the usage status information has been acquired.

In the second embodiment, a case in which the app screen SC2 corresponds to the function screen is given as an example. For that reason, the portion described as the app screen SC2 can be read as the function screen. The function screen may be another screen other than the app screen SC2. For example, the function screen may be a screen of another app other than the management app. The function screen may be a screen of a browser not classified as an app of a specific service, or may be a screen displayed by processing of a program not classified as an app and a browser. The display data of the function screen may be data of the entire function screen or data of a part of the function screen. The display data may be in any format. For example, the display data may be data in a markup language such as HTML or data in an image format such as JPEG.

For example, the display control module 102 acquires the function information of a service (for example, the selected service) for which the usage status information has been acquired from the function database DB3, and identifies information of which function is to be displayed based on the acquired function information. The display control module 102 determines specific display content of the function based on the usage status indicated by the usage status information, and generates display data of the app screen SC2. The display data may be similar to that in the first embodiment.

In the second embodiment, the display control module 102 displays, on the user terminal 20, the app screen SC2 including the service area A20 for display regarding the service for which the usage status information has been acquired, and the function area A22 for display regarding a function of at least one of the service or another service. In the second embodiment, the service area A20 may be similar to that in the first embodiment, and a selection of the selected service may not be particularly received. A method by which the display control module 102 determines the content of the service area A20 may be similar to that in the first embodiment. The function area A22 is not limited to the example in the lower left part and the lower right part of FIG. 2. At least one function is only required to be displayed in the function area A22.

For example, the display control module 102 determines the content of the function area A22 based on the usage status information and the function information. The display control module 102 may arrange the specific usage status indicated by the usage status information in the function area A22 as a display item in the function indicated by the function information. When a plurality of pieces of function information are present, the display control module 102 may arrange specific usage statuses indicated by the usage status information in the function area A22 in a predetermined order as respective display items indicated by the plurality of pieces of function information. The display control module 102 generates display data of the app screen SC2 including the service area A20 and the function area A22 having the content determined as described above and transmits the generated display data to the user terminal 20, to thereby display the app screen SC2 on the user terminal 20.

The display control module 102 may display information on a function corresponding to the usage status information on the app screen SC2 not including the service area A20 and the function area A22. That is, the app screen SC2 is not required to be divided into the service area A20 and the function area A22. The app screen SC2 may include the function area A22 without particularly including the service area A20. When the app screen SC2 includes the service area A20 and the function area A22, a mutual positional relationship between the service area A20 and the function area A22 is not limited to the example in the lower left part and the lower right part of FIG. 2. For example, the service area A20 may be arranged below the function area A22.

Further, the display control module 102 may display the service area A20 and the function area A22 on different screens. In this case, when the user selects the selected service in the service area A20 of a certain screen, the display control module 102 may cause the screen of the user terminal 20 to transition to another screen including the function area A22. The other screen may be a screen such as a pop-up or a window. For example, when the user selects the selected service in the service area A20 of a payment source screen for selecting a payment source in payment, the display control module 102 may cause the screen of the user terminal 20 to transition to a top screen including the function area A22.

Further, the display control module 102 is only required to display, on the user terminal 20, the app screen SC2 corresponding to the usage status of the service used by the user. For example, when the user uses an application receiving service for a restaurant, the display control module 102 may display, in the function area A22, the user interface part for receiving an order at the restaurant. When the user uses an insurance service for golf insurance, the display control module 102 may display, in the function area A22, the user interface part for searching for golf-related products.

### 2-2-2. Functions Implemented by User Terminal in Second Embodiment

The functions implemented by the user terminal 20 in the second embodiment may be similar to those in the first embodiment.

### 2-3. Processing Executed by Display Control System According to Second Embodiment

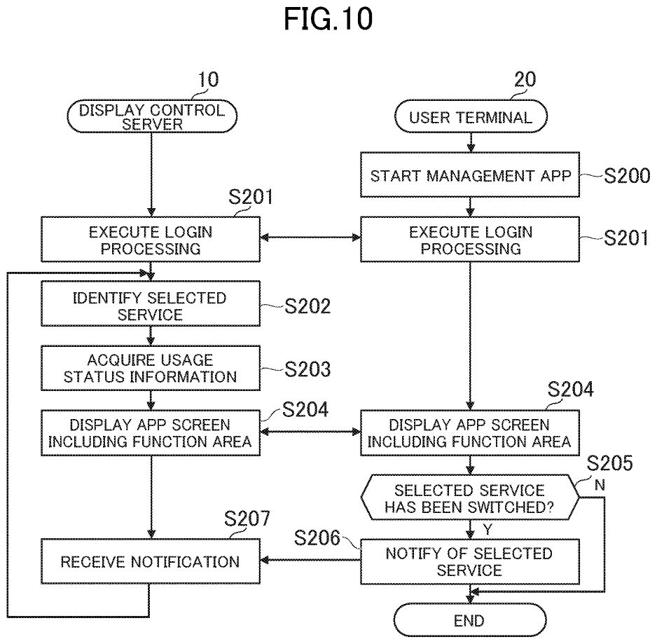

FIG. 10 is a flow chart for illustrating an example of processing executed by the display control system 1 according to the second embodiment. In FIG. 10, processing for displaying the app screen SC2 is illustrated among processes executed by the display control system 1. The control units 11 and 21 execute programs stored in the storage units 12 and 22, respectively, to thereby execute the processing of FIG. 10. The steps of FIG. 10 are an example of the display control method.

The processing steps of from Step S200 to Step S202 are the same as the processing steps of from Step S100 to Step S102. The display control server 10 acquires the usage status information on the selected service based on the user database DB1 (Step S203). The processing executed in Step S203 is as described in the processing of the usage status information acquisition module 103 in the second embodiment. The display control server 10 is assumed to cooperate with the external server 30 to store the latest usage status information in the user database DB1.

The display control server 10 cooperates with the user terminal 20 to execute processing for displaying the app screen SC2 including the function area A22 corresponding to the usage status of the user in the selected service based on the usage status information acquired in Step S203 and the function database DB3 (Step S204). The processing executed in Step S204 is as described in the processing of the display control module 102 in the second embodiment. In Step S204, the display control server 10 generates display data of the app screen SC2 and transmits the display data to the user terminal 20, to thereby display the app screen SC2 on the user terminal 20.

Subsequent processing steps of from Step S205 to Step S207 are the same as the processing steps of from Step S104 to Step S106. When a new selected service is identified after the processing step of Step S207, the processing steps of Step S203 and Step S204 are subsequently executed to update the app screen SC2. When the user selects the function of the function area A22, the user terminal 20 transmits a request to use the function to the external server 30 corresponding to the function. When the external server 30 receives the request from the user terminal 20, the external server 30 provides the user with the function indicated by the request. For example, in a case in which the function is a function for the user to view a statement of the card of the service A, the external server 30 generates display data of a screen indicating the statement of the card of the service A and transmits the display data to the user terminal 20. The user terminal 20 displays a statement screen based on the display data.

For example, in a case in which the function is a function for the user to make installment payment through use of the card of the service A, when the user selects the function in the function area A22, the user terminal 20 requests the external server 30 for the card of the service A to change the payment method to installment payment. The external server 30 executes processing for changing the payment method to installment payment in response to the request. Similarly, when the user selects another function, the user terminal 20 is only required to transmit a request for the user to use the function to the external server 30 corresponding to the function. The external server 30 executes, based on the request, processing for providing the function to the user. The processing may be similar to processing adopted in a publicly-known service.

### 2-4. Summary of Second Embodiment

The display control system 1 according to the second embodiment acquires the usage status information on the service used by the user. The display control system 1 displays, on the user terminal 20, the app screen SC2 regarding the function of at least one of the service for which the usage status information has been acquired or another service different from the service, based on the usage status information. Thus, the display control system 1 is able to improve the convenience of the user because the user is able to know information regarding the function corresponding to the usage status of the user. The user becomes able to use an appropriate function corresponding to the usage status of the user from the app screen SC2.

Further, the display control system 1 displays, on the user terminal 20, the app screen SC2 including the service area A20 and the function area A22. Thus, the display control system 1 is able to further improve the convenience of the user because the user is able to view the selected service in the service area A20 of the app screen SC2 and view the function in the function area A22 of the same app screen SC2.

Further, the service area A20 allows the user to select each of the plurality of services. The display control system 1 acquires the usage status information on the selected service selected by the user among the plurality of services. The display control system 1 displays the app screen SC2 on the user terminal 20 based on the usage status information on the selected service. Thus, the display control system 1 is able to further improve the convenience of the user because the user is able to know information regarding the function corresponding to the usage status of the user in the selected service selected by the user.

### 3. THIRD EMBODIMENT

Next, the third embodiment, which is an example of another embodiment according to the present disclosure, is described. In the first embodiment and the second embodiment, the configuration regarding specific content displayed on the app screen SC2 has mainly been described, but in the third embodiment, a configuration regarding cooperation with the external system 3 for displaying the app screen SC2 is described. In the third embodiment, description of the same matters as those of the first embodiment and the second embodiment is omitted.

### 3-1. Overview of Display Control System According to Third Embodiment

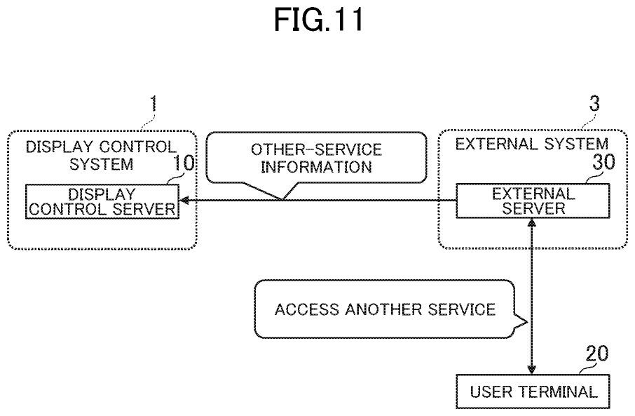

FIG. 11 is a diagram for illustrating an example of cooperation between the display control system 1 and the external system 3 in the third embodiment. The display control system 1 provides a service to the user. In the third embodiment, similarly to the first embodiment and the second embodiment, a case in which the service is a management service is given as an example. The external system 3 provides another service different from the service provided by the display control system 1. In the example of FIG. 11, the service provided by the external system 3 is assumed to be the card of the service A.

For example, it is assumed that the user applies for the card of the service A through the service A while not possessing the card of the service A. In this case, the card company issues the card of the service A through a flow similar to a publicly-known flow, and card information of the service A such as a card number of the service A is registered in the external system 3. A flow in which the card information of the service A is registered in the external system 3 may also be similar to a publicly-known flow.

The card information of the service A may be registered in the external system 3 before the physical card of the service A is issued. For example, the card information of the service A may be registered in the external system 3 after an examination of the card of the service A is completed and before the physical card of the service A is issued. In this case, the user may be notified of the card information of the service A before the physical card of the service A reaches the user, and may be allowed to use the card payment of the service A.

For example, when the card information of the service A is associated with the user ID of a certain user and registered in the external system 3, the external server 30 notifies the display control server 10 that the card of the service A of the user has been issued. This notification includes at least a part of the card information of the service A registered in the external system 3. The display control server 10 detects that the card of the service A of the user has been issued by receiving the notification from the external server 30. The display control server 10 registers the management target information of the card of the service A in the management service. Thus, the card face indicating the card of the service A is displayed in the service area A20 even without the user performing an operation for registration in the management service.

Similarly for services other than the card of the service A, when the user uses the other service in some form, the external server 30 of the other service notifies the display control server 10 that the other service has been used. When the display control server 10 receives the notification from the external server 30, the display control server 10 registers the management target information of the other service in the management service. In this manner, in the third embodiment, the card face indicating the card of the service A is displayed in the service area A20 even without the user performing an operation to register the management target information of a certain service in the management service. Details of the display control system 1 according to the third embodiment are described below.

### 3-2. Functions Implemented by Display Control System according to Third Embodiment

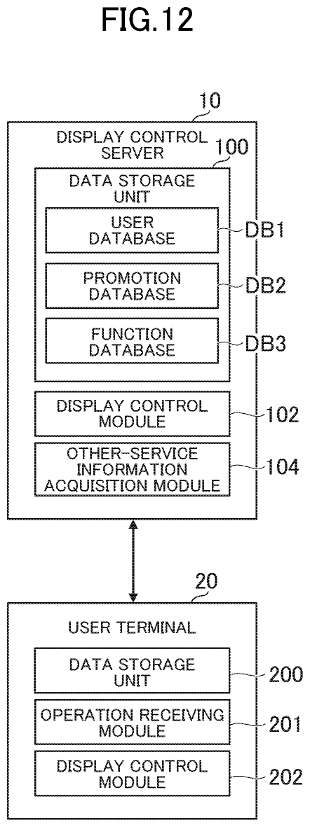

FIG. 12 is a diagram for illustrating an example of functions implemented by the display control system 1 according to the third embodiment. The respective functions of FIG. 12 can be configured by, for example, combining the functions in one device or further distributing the devices.

### 3-2-1. Functions Implemented by Display Control Server in Third Embodiment

For example, the display control server 10 in the third embodiment includes the data storage unit 100, the display control module 102, and an other-service information acquisition module 104. The other-service information acquisition module 104 is implemented by the control unit 11. Some functions of the data storage unit 100 and the display control module 102 in the third embodiment are different from those in the first embodiment and the second embodiment.

In the example of FIG. 12, a case in which the display control system 1 does not include some of the functions described in the first embodiment and the second embodiment is illustrated. The display control system 1 according to the third embodiment is not required to include some of the functions described in the first embodiment and the second embodiment. That is, the display control system 1 according to the third embodiment is not required to include the selected-service identification module 101, the function for displaying a promotion in the display control module 102, the usage status information acquisition module 103, and the function for displaying the function screen in the display control module 102. An aspect in which the display control system 1 according to the third embodiment does not include some of the functions described in the first embodiment and the second embodiment and does not solve problems corresponding to the first embodiment and the second embodiment is also within the scope of the present disclosure. This point is a matter that can be naturally understood from the description of the present disclosure by those skilled in the art.

The display control system 1 according to the third embodiment may include the functions described in the first embodiment. That is, the display control system 1 according to the third embodiment may include the selected-service identification module 101 and the function for displaying a promotion in the display control module 102. In other words, the first embodiment and the third embodiment may be combined. An aspect in which the display control system 1 according to the third embodiment includes the functions described in the first embodiment and solves both the problem corresponding to the first embodiment and the problem corresponding to the third embodiment is also within the scope of the present disclosure. This point is also a matter that can be naturally understood from the description of the present disclosure by those skilled in the art.

Further, the display control system 1 according to the third embodiment may include the functions described in the second embodiment. That is, the display control system 1 according to the third embodiment may include the usage status information acquisition module 103 and the function for displaying the function screen in the display control module 102. In other words, the second embodiment and the third embodiment may be combined. An aspect in which the display control system 1 according to the third embodiment includes the functions described in the second embodiment and solves both the problem corresponding to the second embodiment and the problem corresponding to the third embodiment is also within the scope of the present disclosure. This point is also a matter that can be naturally understood from the description of the present disclosure by those skilled in the art.

### [Data Storage Unit]

The data storage unit 100 stores the user database DB1. In the third embodiment, a case in which the user database DB1 has the same configuration as that in the second embodiment is given as an example, but the user database DB1 may have the same configuration as that in the first embodiment. The user database DB1 may be different from that in at least one of the first embodiment or the second embodiment. The data storage unit 100 may store the promotion database DB2, and may store the function database DB3. The data storage unit 100 is not required to store the promotion database DB2, and is not required to store the function database DB3.

### [Other-Service Information Acquisition Module]

The other-service information acquisition module 104 acquires other-service information regarding the user in another service from the external system 3 providing the user with the other service different from the service provided by the display control system 1. The service provided by the display control system 1 is not limited to the management service given as an example in the third embodiment. The management service as used herein can be read as a service provided by the display control system 1. For example, the service provided by the display control system 1 can be said to be a service provided by default by the app on the app screen SC2. The other services are also not limited to the card of the service A given as an example in the third embodiment. The card of the service A as used herein can be read as another service. Similarly to the first embodiment and the second embodiment, those services may be any services.

The other-service information is information provided from the external system 3 to the display control system 1. The other-service information may be information registered in another service, and may be information not particularly registered in another service. For example, the other-service information may be information of the user registered in the other service (for example, personal information such as the full name of the user, demographic information of the user, or the attribute of the user), the usage status of the user in the other service (for example, an operation by the user, a payment made by the user, a product purchased by the user, a specific service used by the user, or a browsing history of the user), or other information. The management target information described in the first embodiment is an example of the other-service information. For that reason, the management target information as used herein can be read as the other-service information.

In the third embodiment, the other-service information acquisition module 104 may acquire behavior information regarding a behavior of the user in the other service as the other-service information. That is, the behavior information may correspond to the other-service information. The behavior of the user may be an operation on the user terminal 20, or may be a behavior not particularly relating to an operation on the user terminal 20. For example, the behavior information may indicate purchase of a product, payment, usage of a service, browsing of a page, visit to a brick-and-mortar store, or another behavior. The other-service information acquisition module 104 may store the behavior information acquired as the other-service information in the user database DB1.

It is assumed that the external system 3 stores the user ID of a certain user and the other-service information of the user in association with each other. For example, when a certain user operates the user terminal 20 to register the other-service information of the user, the external server 30 registers the other-service information in a database of the other service in association with the user ID. When a certain user operates the user terminal 20 to use another service, the external server 30 generates other-service information so as to indicate the usage status of the user, and registers the other-service information in a database of the other service in association with the user ID. For example, the usage status information described in the second embodiment may correspond to the other-service information or the behavior information.

For example, the external server 30 transmits the other-service information to the display control server 10 at any timing. The external server 30 may automatically transmit the other-service information to the display control server 10 when the other-service information is registered. When a predetermined date and time (for example, a determined time of every day) arrives, the external server 30 may automatically transmit the other-service information to the display control server 10. The external server 30 may transmit the other-service information in response to a request received from the display control server 10. The other-service information acquisition module 104 acquires the other-service information transmitted by the external server 30.

In the example of FIG. 11, the card information of the card of the service A for which the user has applied corresponds to the other-service information. When the card information of the card of the service A of the user is registered, the external server 30 transmits the user ID of the user and the card information of the service A to the display control server 10. The other-service information acquisition module 104 stores the user ID and the card information of the service A received from the external server 30 in association with each other in the user database DB1. When different user IDs are used in the display control system 1 and the external system 3, the other-service information acquisition module 104 converts the user ID received from the external server 30 into the user ID of the display control system 1 based on the association of the user IDs described in the first embodiment, and stores the converted user ID and the card information of the service A in association with each other in the user database DB1.

### [Display Control Unit]

The display control module 102 displays, on the user terminal 20, a service screen relating to the service provided by the display control system 1 based on the other-service information. The display control module 102 is a function on the display control server 10 side, and hence the display control module 102 displays, on the user terminal 20, the service screen by transmitting display data of the service screen to the user terminal 20. The display data of the service screen may be data of the entire service screen or data of a part of the service screen. The display data may be in any format. For example, the display data may be data in a markup language such as HTML or data in an image format such as JPEG.

In the third embodiment, a case in which the app screen SC2 corresponds to the service screen is given as an example. For that reason, the portion described as the app screen SC2 can be read as a service screen. The service screen may be a screen other than the app screen SC2. The service screen may be a screen of a browser not classified as an app of a specific service, or may be a screen displayed by processing of a program not classified as an app and a browser.

In the third embodiment, the behavior information is acquired as the other-service information, and hence the display control module 102 displays the app screen SC2 on the user terminal 20 based on the behavior information. For example, when the behavior information indicates that the user has performed a specific behavior in a certain service, the display control module 102 displays the card face corresponding to the service in the service area A20. In the example of FIG. 11, the display control module 102 displays the card face corresponding to the card of the service A in the service area A20 based on the card information of the service A because the card information of the card of the service A issued as a result of the behavior performed by the user is acquired as the behavior information when the user has performed the behavior of applying for the card of the service A through the service A.

The other-service information may be at least one of the management target information or the usage status information. For that reason, processing in which the display control module 102 displays the app screen SC2 based on the other-service information may be similar to that in the first embodiment or the second embodiment. For example, the display control module 102 may display, in the service area A20, the card face indicating another service having the management target information stored as the other-service information in the user database DB1. The display control module 102 may display, in the function area A22, a function of another service having the usage status information stored as the other-service information in the user database DB1. In the third embodiment, the app screen SC2 is not required to include at least one of the promotion area A21 or the function area A22.

### 3-2-2. Functions Implemented by User Terminal in Third Embodiment

The functions implemented by the user terminal 20 in the third embodiment may be similar to those in at least one of the first embodiment or the second embodiment.

### 3-3. Processing Executed by Display Control System according to Third Embodiment

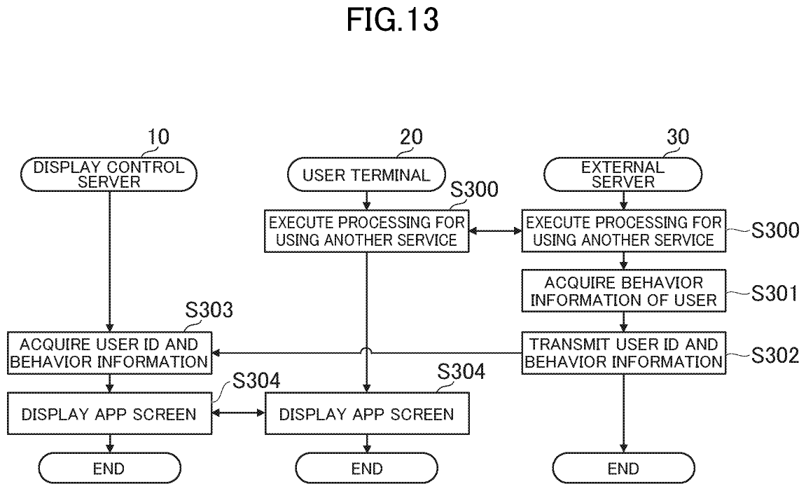

FIG. 13 is a flow chart for illustrating an example of processing executed by the display control system 1 according to the third embodiment. In FIG. 13, processing for cooperation with the external system 3 is illustrated among processes executed by the display control system 1. The control units 11, 21, and 31 execute programs stored in the storage units 12, 22, and 32, respectively, to thereby execute the processing of FIG. 13. The steps of FIG. 13 are an example of the display control method.

As illustrated in FIG. 13, when the user selects an app of a certain service, the user terminal 20 cooperates with the external server 30 providing the service to execute processing for the user to use the service (Step S300). The external server 30 acquires the behavior information of the user based on the content of communication to and from the user terminal 20 (Step S301). The external server 30 transmits the user ID of the logged-in user and the behavior information acquired in Step S301 to the display control server 10 (Step S302). The user may use the service without using the user terminal 20. For example, the user may visit a store providing an insurance service and apply for the insurance service. The external server 30 may acquire the behavior information of the user and transmit the behavior information to the display control server 10 based on information input by a person in charge at the store.

The display control server 10 acquires the user ID and the behavior information from the external server 30 (Step S303). The display control server 10 cooperates with the user terminal 20 to execute processing for displaying the app screen SC2 (Step S304), and this process ends. Details of the processing in Step S304 may be similar to those of the flow of FIG. 6, or may be similar to those of the flow of FIG. 10.

### 3-4. Summary of Third Embodiment

The display control system 1 according to the third embodiment acquires the other-service information from the external system 3. The display control system 1 displays the app screen SC2 on the user terminal 20 based on the other-service information. Thus, the display control system 1 is able to improve the convenience of the user because the user becomes able to view information of another service such as the card of the service A in the management service. For example, the user can use a plurality of services such as the management service and the other service from one management app.

Further, the display control system 1 acquires the behavior information in another service as the other-service information. The display control system 1 displays the app screen SC2 on the user terminal 20 based on the behavior information. Thus, the display control system 1 is able to further improve the convenience of the user because the user becomes able to view information corresponding to a behavior in another service such as the card of the service A in the management service.

### 4. MODIFICATION EXAMPLES

The present disclosure is not limited to the first to third embodiments described above. The present disclosure can be modified as required without departing from the purport of the present disclosure.

### 4-1. Modification Examples regarding First Embodiment

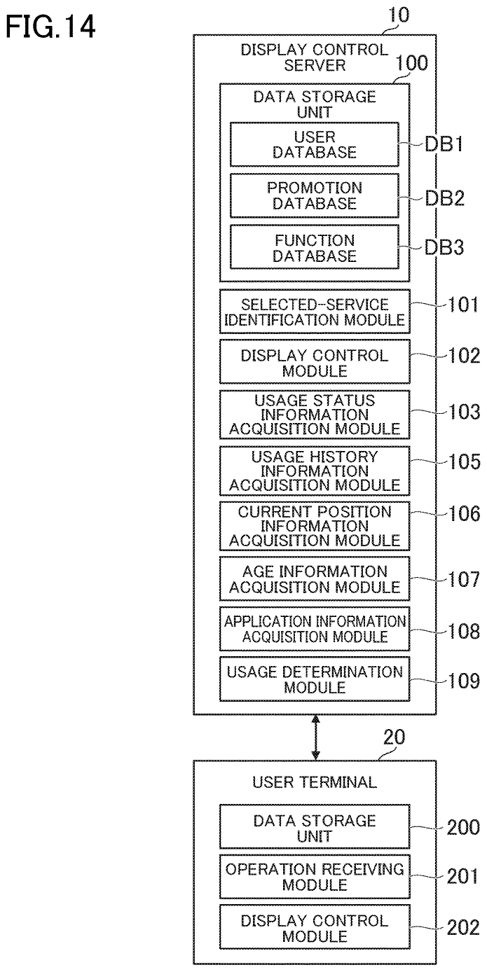

FIG. 14 is a diagram for illustrating an example of functions implemented in modification examples regarding the first embodiment. For example, the display control server 10 includes the usage status information acquisition module 103, a usage history information acquisition module 105, a current position information acquisition module 106, an age information acquisition module 107, an application information acquisition module 108, and a usage determination module 109. The usage status information acquisition module 103 may be similar to that in the second embodiment. Each of the usage history information acquisition module 105, the current position information acquisition module 106, the age information acquisition module 107, the application information acquisition module 108, and the usage determination module 109 is implemented by the control unit 11.

### Modification Example 1-1

For example, the promotion displayed on the app screen SC2 is not limited to the promotion for advertising the selected service described in the first embodiment. The promotion displayed on the app screen SC2 may be a promotion that the selected service and another service different from the selected service among the plurality of services have in common. This promotion is hereinafter referred to as “common promotion.” In Modification Example 1-1, a case in which the common promotion is preferentially displayed on the app screen SC2 is given as an example.

The common promotion is a promotion for advertising both the selected service and the other service. In other words, the common promotion is a promotion including content of both the selected service and the other service. The common promotion may be a promotion that the selected service and one other service have in common, or may be a promotion that the selected service and a plurality of other services have in common.

In Modification Example 1-1, it is assumed that the promotion information of the common promotion is also stored in the promotion database DB2. The service ID of each of the plurality of services is associated with the promotion information of the common promotion. The service ID of one service advertised by the promotion is associated with the promotion information of a promotion that is not the common promotion. When the promotion information itself indicates which service the promotion belongs to, the promotion information of the common promotion indicates the respective service IDs of the plurality of services. In this case, the promotion information of a promotion that is not the common promotion indicates the service ID of one service advertised by the promotion.

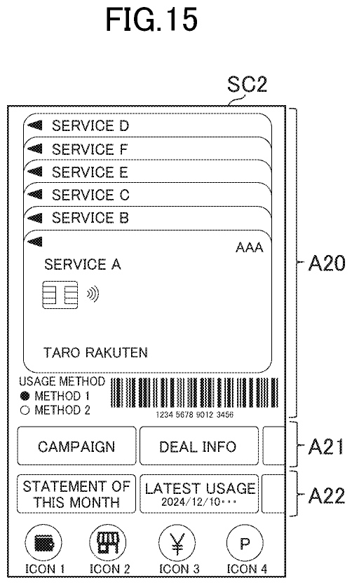

FIG. 15 is a view for illustrating an example of the app screen SC2 in Modification Example 1-1. The display control module 102 in Modification Example 1-1 preferentially displays the common promotion on the app screen SC2 when a plurality of promotions are present. The case in which a plurality of promotions are present means that a plurality of promotions targeted for display are present on the app screen SC2. That is, the presence of a plurality of promotions selected based on the selected service corresponds to the case in which a plurality of promotions are present.

For example, when the selected service is identified by the selected-service identification module 101, the display control module 102 acquires the promotion information associated with the service ID of the selected service from the promotion database DB2. The acquisition of a plurality of pieces of promotion information by the display control module 102 corresponds to the presence of a plurality of promotions. When the display control module 102 acquires a plurality of pieces of promotion information, the display control module 102 displays, on the user terminal 20, the app screen SC2 including the common promotion to be displayed preferentially.

In Modification Example 1-1, a case in which the display control module 102 preferentially displays the common promotion on the app screen SC2 by setting an order position of the common promotion so as to precede order positions of other promotions is given as an example. The order is an arrangement on the app screen SC2. For example, a promotion placed further to the left side or the upper side on the app screen SC2 may have a higher priority. A promotion placed further to the left side or the upper side on the app screen SC2 corresponds to a promotion having a higher priority. Depending on a layout of the app screen SC2, a promotion placed further to the right side or the lower side on the app screen SC2 may have a higher priority.

In the example of FIG. 15, the selected service is the card of the service A. The common promotion is a promotion “campaign” that the service A and the service C have in common. In this case, as illustrated in FIG. 15, the display control module 102 preferentially displays the common promotion by arranging the common promotion on the left side relative to other promotions that are not common promotions.

Other promotions that are not common promotions may be promotions having content relating only to the selected service, or may be promotions having content relating only to another service different from the selected service. When promotions are arranged vertically in the promotion area A21, the display control module 102 may preferentially display the common promotion by arranging the common promotion above other promotions that are not common promotions.

A method by which the display control module 102 preferentially displays the common promotion is not limited to the above-mentioned example. For example, when a plurality of promotions are present, the display control module 102 may preferentially display the common promotion by displaying the common promotion on the app screen SC2 and not displaying other promotions on the app screen SC2. The display control module 102 may preferentially display the common promotion by making the number of common promotions displayed on the app screen SC2 larger than that of other promotions.

Further, when only one promotion is present, the display control module 102 is only required to display the app screen SC2 including the promotion on the user terminal 20. The processing in this case may be similar to that in the first embodiment. The acquisition of only one piece of promotion information by the display control module 102 corresponds to the presence of only one promotion.

The display control system 1 according to Modification Example 1-1 preferentially displays the common promotion on the app screen SC2 when a plurality of promotions are present. The display control system 1 is able to improve the convenience of the user because the common promotion is an important promotion relating to both the selected service and other services, and hence the user becomes able to preferentially view the important common promotion. For example, the display control system 1 is also able to improve a sales promotion effect of the important common promotion.

### Modification Example 1-2

For example, when a plurality of promotions that can be displayed on the app screen SC2 are present, a sales promotion effect of a promotion is enhanced in a case in which a promotion in which the user is interested is displayed. In this regard, the user may be interested in a promotion corresponding to the usage history of the user in the selected service. Accordingly, in Modification Example 1-2, a case in which a promotion corresponding to the usage history of the user in the selected service is displayed on the app screen SC2 is described.

The display control system 1 according to Modification Example 1-2 includes the usage history information acquisition module 105. The usage history information acquisition module 105 acquires the usage history information regarding the usage history of the user in the selected service. The usage history information is information indicating how the user has used the selected service. For example, the usage history information may be a login history of the user to the selected service, a payment made by the user in the selected service, a product purchased by the user in the selected service, an application history of the user in the selected service, a browsing history of pages of the selected service, or other information. The usage history information acquisition module 105 may acquire the usage history information of services other than the selected service.

In Modification Example 1-2, it is assumed that the usage history information is stored in the user database DB1 in association with the user ID. For example, when the user uses a service provided by the external server 30 itself, the external server 30 stores the usage history information received from the user terminal 20 in the database of the external server 30. The display control server 10 acquires the usage history information of a service provided by the external server 30 together with the user ID from the external server 30, and stores the usage history information in the user database DB1 such that the usage history information is associated with the user ID.

When the user ID in the display control system 1 and the user ID in the external system 3 are different from each other, it is only required to identify which user has which user ID in at least one of the display control system 1 or the external system 3 based on the association information of the user IDs described in the first embodiment, and to store the usage history information in the user database DB1 based on the identification result.

Further, the usage history information may indicate which service the usage history belongs to. The usage history information acquisition module 105 acquires the usage history information of the selected service from the user database DB1. When the usage history information is stored in a database other than the user database DB1, a computer other than the display control server 10, or an information storage medium, the usage history information acquisition module 105 may acquire the usage history information from the other database, the other computer, or the information storage medium.

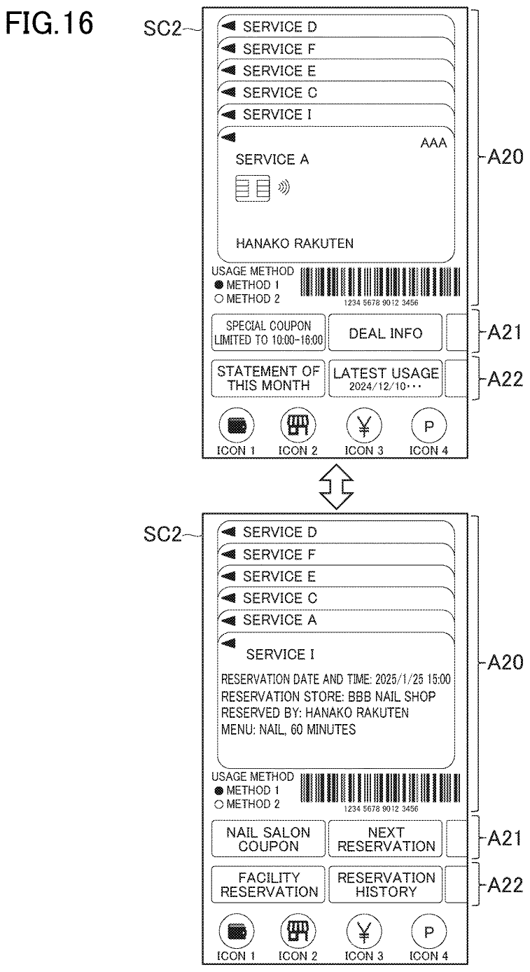

FIG. 16 is a view for illustrating an example of the app screen SC2 in Modification Example 1-2. The display control module 102 in Modification Example 1-2 displays the app screen SC2 on the user terminal 20 based on the usage history information. For example, the display control module 102 acquires the promotion information corresponding to the usage history information among pieces of promotion information stored in the promotion database DB2. The display control module 102 displays the acquired promotion information. Which usage history an individual promotion is appropriate for is assumed to be defined in the promotion information. The display control module 102 determines whether or not the promotion is appropriate based on the promotion information of a certain promotion and the usage history information. When it is determined that the promotion is appropriate, the display control module 102 displays the promotion on the app screen SC2.

For example, it is assumed that the selected service is the card of the service A. It is also assumed that the usage history information indicates that the user made card payment of the service A at a specific store during the daytime. In this case, as illustrated in the upper part of FIG. 16, the display control module 102 identifies that a coupon that can be used by the user at the store during the daytime is appropriate as a promotion based on the usage history information, acquires the promotion information of the promotion having such content from the promotion database DB2, and displays, on the user terminal 20, the app screen SC2 including the promotion. As the usage history of the card payment of the service A, a payment time, a payment amount, a payment store, or a product subjected to payment may be indicated in the usage history information. The display control module 102 may display, on the user terminal 20, the app screen SC2 including a promotion corresponding to the usage history information.

For example, it is assumed that the selected service is an application receiving service that receives reservation applications for nail salons and the like. It is also assumed that the usage history information indicates that the user frequently makes reservations for nail salons in the application receiving service. In this case, as illustrated in the lower part of FIG. 16, the display control module 102 identifies that a coupon for a nail salon for which the user frequently makes reservations is appropriate as a promotion based on the usage history information, acquires the promotion information of the promotion having such content from the promotion database DB2, and displays, on the user terminal 20, the app screen SC2 including the promotion.

In addition, for example, it is assumed that the selected service is an insurance service. It is also assumed that the usage history information indicates that the user contracted a specific insurance (for example, golf insurance) in the insurance service. In this case, the display control module 102 may identify that a promotion (for example, a campaign to support the purchase of a golf set) corresponding to content of an insurance to which the user subscribes is appropriate based on the usage history information, acquire the promotion information of the promotion having such content from the promotion database DB2, and display the app screen SC2 including the promotion on the user terminal 20.

The display control system 1 according to Modification Example 1-2 acquires the usage history information of the user in the selected service. The display control system 1 displays the app screen SC2 on the user terminal 20 based on the usage history information. Thus, the display control system 1 is able to further improve the convenience of the user because the user becomes able to view a promotion corresponding to the usage history of the user in the selected service.

### Modification Example 1-3

For example, in Modification Example 1-2, the usage history information may indicate the usage history in a predetermined period. Assuming that a service for which the usage history is to be acquired is the service E, a place in which the user is currently located may be estimated based on the latest usage history in the service E, and a coupon corresponding to the place may be displayed as a promotion. Similarly for services other than the service E, a promotion corresponding to the usage history in a predetermined period may be displayed on the app screen SC2.

The usage history information acquisition module 105 in Modification Example 1-3 acquires the usage history information regarding the usage history in a predetermined period. The predetermined period is a part of the entire past period. The predetermined period may be the latest period (for example, the latest one month), or may not particularly be the latest period. When the usage history information of periods other than the predetermined period is also stored in the user database DB1, the usage history information also indicates a usage date and time of the usage history. The usage history information acquisition module 105 acquires the usage history information indicating the usage history in a predetermined period based on a usage date and time indicated by the usage history information.

The display control module 102 in Modification Example 1-3 displays the app screen SC2 on the user terminal 20 based on the usage history information regarding the usage history in the predetermined period. The display control module 102 displays the app screen SC2 on the user terminal 20 based on the usage history information regarding the usage history in the predetermined period without being based on the usage history information regarding the usage history in a period other than the predetermined period. The usage history information referred to when the app screen SC2 is displayed is different from that in Modification Example 1-2, but the processing for displaying the app screen SC2 based on the usage history information is as described in Modification Example 1-2.

The display control system 1 according to Modification Example 1-3 acquires the usage history information regarding the usage history in a predetermined period. The display control system 1 displays the app screen SC2 on the user terminal 20 based on the usage history information regarding the usage history in the predetermined period. Thus, the display control system 1 is able to further improve the convenience of the user because the user becomes able to view a promotion corresponding to the usage history of the user in the predetermined period. For example, when the predetermined period is the latest period, the user becomes able to view a promotion corresponding to a more recent tendency of the user, and hence the display control system 1 is able to enhance an effect of a promotion.

### Modification Example 1-4

For example, in Modification Examples 1-2 and 1-3, a case in which the app screen SC2 including a promotion corresponding to the usage history of the user in the selected service is displayed has been described, but the app screen SC2 including a promotion corresponding to the usage history of the user in another service different from the selected service may be displayed. That is, the usage history information referred to when the app screen SC2 is displayed may indicate the usage history of the user in another service.

In Modification Example 1-4, it is assumed that other-service definition data defining a relationship between each of the plurality of services and another service for which the usage history information is acquired when the service is selected as the selected service is stored in the data storage unit 100. In the other-service definition data, a certain service and another service when the certain service is the selected service are associated with each other. The other-service definition data may be in any format, for example, a table format, a mathematical formula format, a part of a program code, or another format.

The display control system 1 according to Modification Example 1-4 includes the usage history information acquisition module 105. The usage history information acquisition module 105 is different from those in Modification Examples 1-2 and 1-3 in that the usage history information acquisition module 105 acquires the usage history information not of the selected service but of another service. The usage history information acquisition module 105 in Modification Example 1-4 acquires the usage history information regarding the usage history of the user in another service different from the selected service among the plurality of services. The usage history information acquisition module 105 identifies another service associated with the selected service based on the other-service definition data, and acquires the usage history information of the identified other service.

When the other-service definition data is not prepared, the usage history information acquisition module 105 may acquire the usage history information of the other service having a relatively large or the largest usage frequency, payment amount, or access count by the user from among a plurality of other services different from the selected service. The usage history information acquisition module 105 may acquire the usage history information of another service randomly selected from among a plurality of other services. Further, which usage history an individual promotion is appropriate for is assumed to be defined in the promotion information, similarly to Modification Example 1-2. The display control module 102 identifies, based on the definition, which usage history an individual promotion is appropriate for, and displays an appropriate promotion on the app screen SC2.

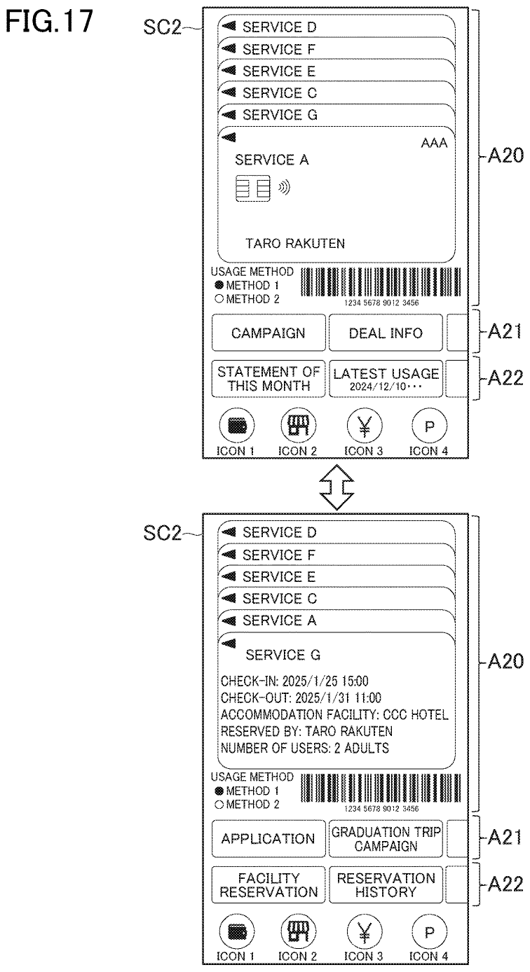

FIG. 17 is a view for illustrating an example of the app screen SC2 in Modification Example 1-4. The display control module 102 in Modification Example 1-4 displays the app screen SC2 on the user terminal 20 based on the usage history information regarding the usage history of the user in another service. For example, the display control module 102 displays the app screen SC2 on the user terminal 20 based on the usage history information regarding the usage history of the user in another service, without being based on the usage history information regarding the usage history of the user in the selected service. When Modification Examples 1-2 to 1-4 are combined, the display control module 102 may display, on the user terminal 20, the app screen SC2 based on the usage history information regarding the usage history of the user in the selected service and the usage history information regarding the usage history of the user in another service.

For example, it is assumed that the selected service is the card of the service A. It is also assumed that the service C is defined in the other-service definition data as another service when the selected service is the card of the service A. In this case, as illustrated in the upper part of FIG. 17, the display control module 102 identifies that the other service associated with the selected service is the service C based on the other-service definition data. When the display control module 102 identifies that there is evidence that the user has used loyalty points based on the usage history information of the service C, the display control module 102 displays a promotion of a loyalty point increase campaign in the card payment of the service A.

For example, it is assumed that the selected service is a travel reservation service. It is also assumed that the insurance service is defined in the other-service definition data as another service when the selected service is the travel reservation service. In this case, as illustrated in the lower part of FIG. 17, the display control module 102 identifies that the other service associated with the selected service is the insurance service based on the other-service definition data. When the display control module 102 identifies that there is no evidence that the user has applied for travel insurance in the insurance service based on the usage history information of the insurance service, the display control module 102 displays a promotion of travel insurance handled by the insurance service.

The display control system 1 according to Modification Example 1-4 acquires the usage history information regarding the usage history of the user in another service different from the selected service among the plurality of services. The display control system 1 displays the app screen SC2 on the user terminal 20 based on the usage history information in another service different from the selected service. Thus, the display control system 1 is able to further improve the convenience of the user because the user becomes able to view a promotion corresponding to the usage history of the user in another service.

### Modification Example 1-5

For example, the user terminal 20 may be capable of acquiring current position information regarding the current position of the user. The current position information may be in any format. For example, the current position information may be latitude and longitude, coordinates, address, wireless communication device information, mobile base station information, or other information. An acquisition method for the current position information may be a publicly-known method. For example, the user terminal 20 may acquire the current position information based on a GNSS such as a GPS, a wireless communication function of the communication unit 23, a check-in function for a facility such as a store, or another function.

The display control system 1 according to Modification Example 1-5 includes the current position information acquisition module 106. The current position information acquisition module 106 acquires the current position information. For example, when the user terminal 20 acquires the current position information by a publicly-known method, the user terminal 20 transmits the current position information to the display control server 10. The current position information acquisition module 106 acquires the current position information from the user terminal 20. The current position information acquisition module 106 may regularly acquire the latest current position information, or may acquire the current position information at any timing such as when the management app is started. The current position information acquisition module 106 may acquire the current position information from the external server 30 that detects check-in at a facility such as an accommodation facility or a store.

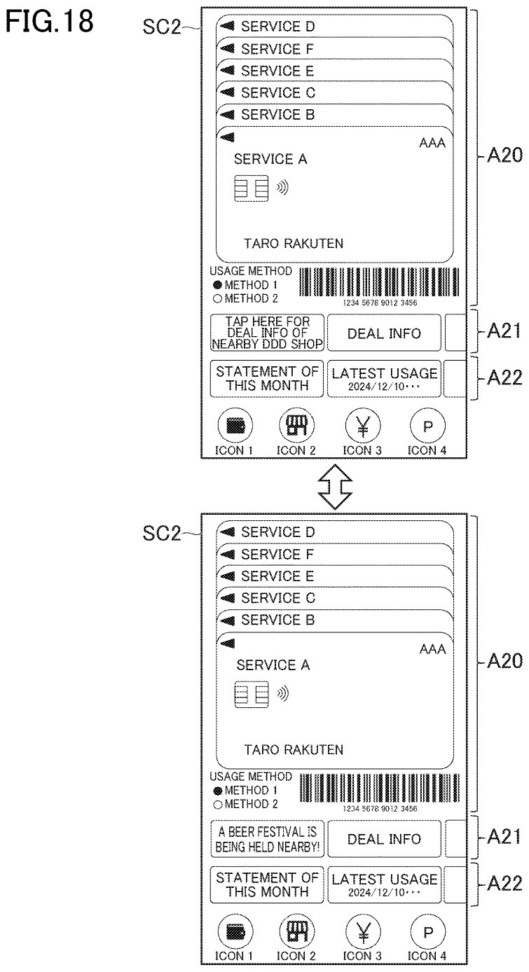

FIG. 18 is a view for illustrating an example of the app screen SC2 in Modification Example 1-5. The display control module 102 in Modification Example 1-5 displays the app screen SC2 on the user terminal 20 based on the current position information. Which current position an individual promotion is appropriate for is assumed to be defined in the promotion information. The display control module 102 determines whether or not the promotion is appropriate based on the promotion information of a certain promotion and the current position information. When it is determined that the promotion is appropriate, the display control module 102 displays the promotion on the app screen SC2.

For example, as illustrated in the upper part of FIG. 18, the display control module 102 displays a campaign on the app screen SC2 based on campaign information indicating the campaign at a store around the position indicated by the current position information. The position of the store is assumed to be indicated in the campaign information. As illustrated in the lower part of FIG. 18, the display control module 102 may display a campaign on the app screen SC2 based on campaign information indicating the campaign for an event around the position indicated by the current position information.

The display control system 1 according to Modification Example 1-5 acquires the current position information regarding a current position of the user. The display control system 1 displays the app screen SC2 on the user terminal 20 based on the current position information. Thus, the display control system 1 is able to further improve the convenience of the user because the user becomes able to grasp a campaign corresponding to a position at which the user is present.

### Modification Example 1-6

For example, an effective promotion for the user may differ depending on the age or age group of the user. Accordingly, in Modification Example 1-6, a case in which promotion corresponding to age information regarding the age of the user is performed is given as an example. The age information indicates the age or age group of the user. In Modification Example 1-6, a case in which the age information of the user is stored in the user database DB1 is given as an example.

The display control system 1 according to Modification Example 1-6 further includes the age information acquisition module 107. The age information acquisition module 107 acquires the age information regarding the age of the user. For example, the age information acquisition module 107 acquires the age information of the user from the user database DB1. The age information may be stored in a database other than the user database DB1, a computer other than the display control server 10, or an information storage medium. In this case, the age information acquisition module 107 is only required to acquire the age information of the user from the other database, the other computer, or the information storage medium.

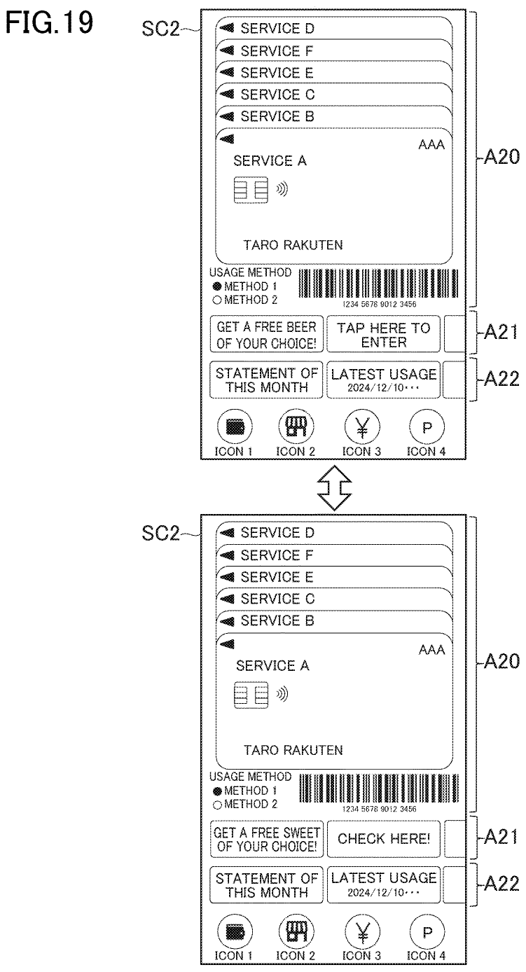

FIG. 19 is a view for illustrating an example of the app screen SC2 in Modification Example 1-6. The display control module 102 in Modification Example 1-6 displays the app screen SC2 on the user terminal 20 based on the age information. Which age or age group an individual promotion is appropriate for is assumed to be defined in the promotion information. The display control module 102 determines whether or not the promotion is appropriate based on the promotion information of a certain promotion and the age information. When it is determined that the promotion is appropriate, the display control module 102 displays the promotion on the app screen SC2.

For example, as illustrated in the upper part of FIG. 19, when the age information indicates an age or age group equal to or older than a predetermined age or age group (for example, adult or older, or 60 years old or older), the display control module 102 displays, on the user terminal 20, the app screen SC2 including a campaign targeting users of the predetermined age or age group or older. As illustrated in the lower part of FIG. 19, when the age information indicates an age or age group younger than the predetermined age or age group (for example, minor, or less than 60 years old), the display control module 102 displays, on the user terminal 20, the app screen SC2 including a campaign targeting users of less than the predetermined age or age group.

The display control system 1 according to Modification Example 1-6 acquires the age information. The display control system 1 displays the app screen SC2 on the user terminal 20 based on the age information. Thus, the display control system 1 is able to further improve the convenience of the user because the user becomes able to grasp a campaign corresponding to the age of the user.

### Modification Example 1-7

For example, the selected service may be an application receiving service that receives an application from the user. That is, the application receiving service may be included in the plurality of services (services respectively provided by the plurality of external systems 3) available to the user from the management app. For example, the application receiving service may receive a reservation application, a usage application, a purchase application, a participation application, or another application. An application target may be any target, and may be, for example, a restaurant, a beauty facility such as a hair salon or a nail salon, a public facility, a tourist facility, an accommodation facility, a product, a service, a seminar, an event, or another target.

The display control system 1 according to Modification Example 1-7 further includes the application information acquisition module 108. The application information acquisition module 108 acquires application information regarding an application. The application information is specific content of the application. That is, the application information indicates content of an application designated by the user in the application receiving service. For example, when the application target is a restaurant, the application information indicates information capable of identifying a restaurant reserved by the user, the number of people to reserve, a reservation date and time, or a combination thereof. When the application target is a product, the application information indicates information capable of identifying a product reserved by the user, the number of products, a date and time of sale of a product, or a combination thereof. When the application target is a target other than restaurant and a product, the application information is only required to indicate specific content of the application of the other target.

In Modification Example 1-7, it is assumed that the application information is stored in the user database DB1 in association with the user ID. For example, the external server 30 stores, when the user makes an application through the application receiving service provided by the external server 30 itself, the application information indicating the content of the application designated by the user in the database of the external server 30. The display control server 10 acquires the application information of the application receiving service provided by the external server 30 together with the user ID from the external server 30, and stores the application information in the user database DB1 such that the application information is associated with the user ID.

When the user ID in the display control system 1 and the user ID in the external system 3 are different from each other, it is only required to identify which user has which user ID in at least one of the display control system 1 or the external system 3 based on the association information of the user IDs described in the first embodiment, and to store the application information in the user database DB1 based on the identification result. The application information may indicate which application receiving service the application belongs to, or the service ID indicating which application receiving service the application belongs to may be associated with the application information. Which application receiving service the application belongs to may be identified by the application information or the service ID.

For example, the application information acquisition module 108 acquires the application information of the selected service from the user database DB1. When the application information is stored in a database other than the user database DB1, a computer other than the display control server 10, or an information storage medium, the application information acquisition module 108 may acquire the application information from the other database, the other computer, or the information storage medium.

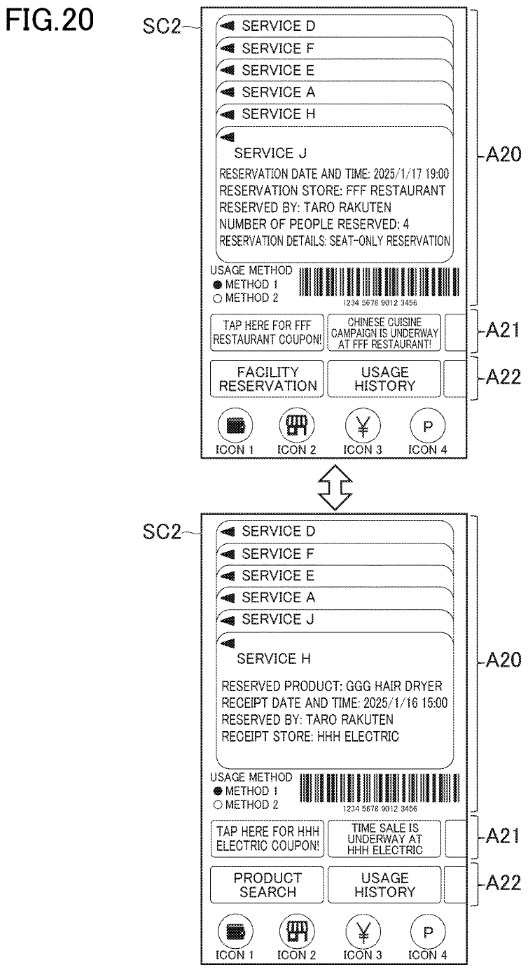

FIG. 20 is a view for illustrating an example of the app screen SC2 in Modification Example 1-7. The display control module 102 in Modification Example 1-7 displays the app screen SC2 on the user terminal 20 based on the application information. For example, the display control module 102 acquires the promotion information corresponding to the application information among pieces of promotion information stored in the promotion database DB2. The display control module 102 displays the acquired promotion information. Which application information an individual promotion is appropriate for is assumed to be defined in the promotion information. The display control module 102 determines whether or not the promotion is appropriate based on the promotion information of a certain promotion and the application information. When it is determined that the promotion is appropriate, the display control module 102 displays the promotion on the app screen SC2.

For example, it is assumed that the selected service is the application receiving service that receives reservation applications for restaurants. In this case, as illustrated in the upper part of FIG. 20, the display control module 102 identifies that a coupon usable by the user at the restaurant or a nearby store (for example, a bowling alley) is appropriate as a promotion based on the application information of the restaurant reserved by the user, acquires the promotion information of the promotion from the promotion database DB2, and displays, on the user terminal 20, the app screen SC2 including the promotion.

For example, it is assumed that the selected service is the application receiving service (for example, one service attached to the electronic commerce service) that receives a reservation application for a product. In this case, as illustrated in the lower part of FIG. 20, the display control module 102 identifies that a coupon usable by the user at a store in which the user ordered the product is appropriate as a promotion based on the application information of the product reserved by the user, acquires the promotion information of the promotion from the promotion database DB2, and displays, on the user terminal 20, the app screen SC2 including the promotion.

The selected service in Modification Example 1-7 is the application receiving service that receives an application from the user. The display control system 1 acquires the application information. The display control system 1 displays the app screen SC2 on the user terminal 20 based on the application information. Thus, the display control system 1 is able to further improve the convenience of the user because the user becomes able to view a promotion corresponding to the application made by the user.

### Modification Example 1-8

For example, an effective promotion for the user may differ depending on a timing at which the user uses the selected service. Some promotions are effective before the user uses the selected service, and some promotions are effective after the user uses the selected service. Accordingly, in Modification Example 1-8, a case in which a promotion corresponding to a determination result of whether or not the user is using the selected service is displayed on the app screen SC2 is given as an example.

The display control system 1 according to Modification Example 1-8 further includes the usage determination module 109. The usage determination module 109 determines whether or not the user is using the selected service. The usage determination module 109 is only required to perform a determination by any method. For example, when the user tends to use the selected service in a specific time slot, the usage determination module 109 may determine whether or not the user is using the selected service by determining whether or not a current time is in the time slot. It is assumed that information indicating the time slot is stored in the user database DB1.

For example, when the application information in Modification Example 1-7 indicates that the selected service is used at a specific time or in a specific time slot, the usage determination module 109 may determine whether or not the user is using the selected service by determining whether or not the time or the time slot at which the selected service is used has arrived based on the application information. When the selected service is provided at a specific place, the usage determination module 109 may determine whether or not the user is using the selected service by acquiring location information from the user terminal 20 and determining whether or not the user is at the place.

For example, when the user is using the selected service from an app installed in the user terminal 20, the usage determination module 109 determines whether or not the user is using the selected service by determining whether or not the app is active. In this case, the user terminal 20 transmits information capable of identifying an active app to the display control server 10. The usage determination module 109 identifies an active app in the user terminal 20 based on the information received from the user terminal 20, and determines whether or not an app of the selected service is active. The usage determination module 109 determines that the user is not using the selected service when the app of the selected service is not active, and determines that the user is using the selected service when the app of the selected service is active.

For example, the display control server 10 may cooperate with the external server 30 of the selected service to acquire the usage status f the selected service by the user and determine whether or not the user is using the selected service. In this case, the usage determination module 109 may inquire of the external server 30 whether or not the user has used the selected service, and determine whether or not the user has used the selected service based on a response from the external server 30. The external server 30 may transmit, without particularly receiving an inquiry, the user ID of the user who has used the selected service to the display control server 10. The usage determination module 109 determines whether or not the user is using the selected service based on information acquired from the external server 30 of the selected service.

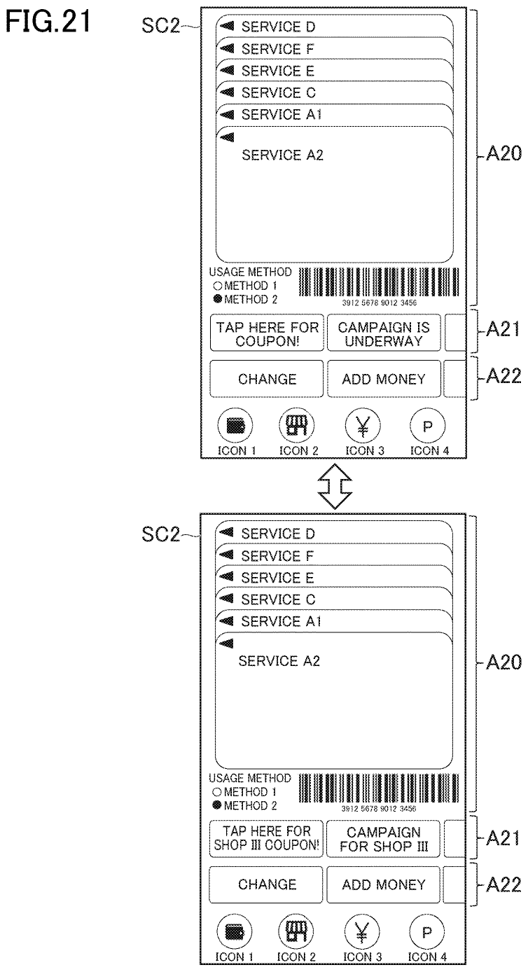

FIG. 21 is a view for illustrating an example of the app screen SC2 in Modification Example 1-8. The display control module 102 in Modification Example 1-8 displays the app screen SC2 on the user terminal 20 based on a determination result of the usage determination module 109. Which determination result an individual promotion is appropriate for is assumed to be defined in the promotion information. The display control module 102 determines whether or not the promotion is appropriate based on the promotion information of a certain promotion and a determination result of the usage determination module 109. When it is determined that the promotion is appropriate, the display control module 102 displays the promotion on the app screen SC2.

For example, the display control module 102 displays, on the user terminal 20, the app screen SC2 including a promotion corresponding to a determination result of the usage determination module 109. For example, when it is determined that the user is not using the selected service, the display control module 102 may display, on the user terminal 20, the app screen SC2 including a promotion indicated by the promotion information of the selected service. When it is determined that the user is using the selected service, the display control module 102 may display, on the user terminal 20, the app screen SC2 including a promotion indicated by other promotion information different from the promotion information of the selected service.

For example, it is assumed that the selected service is a payment service. It is also assumed that making a payment through the payment service is equivalent to the user using the payment service. In this case, as illustrated in the upper part of FIG. 21, before the user uses the payment service, the display control module 102 may display, on the user terminal 20, the app screen SC2 including a first coupon (in the example in the upper part of FIG. 21, a loyalty point increase coupon) for promoting the use of the payment service as a promotion.

For example, when the user uses the payment service through use of the first coupon (in the example in the upper part of FIG. 21, a loyalty point increase coupon) at a store, the display control module 102 displays, on the user terminal 20, the app screen SC2 including a second coupon (in the example in the lower part of FIG. 21, a coupon for a shop III) that is different from the first coupon and can be used at the store as a promotion, as illustrated in the lower part of FIG. 21. The display control module 102 may display a campaign of the store other than the second coupon (in the example in the lower part of FIG. 21, a deal campaign for the shop III) in the promotion area A21.

For example, before the user uses the payment service, the display control module 102 may display, on the user terminal 20, the app screen SC2 including a store coupon for promoting the use of a certain store as a promotion. When the user uses the payment service at the store through use of the store coupon, the display control module 102 may display, on the user terminal 20, the app screen SC2 including a product coupon relating to a product purchased by the user, which is different from the store coupon, as a promotion.

For example, it is assumed that the selected service is a travel reservation service. It is also assumed that checking in to a reserved accommodation facility by the user is equivalent to using the travel reservation service. In this case, when the user checks in to the reserved accommodation facility, the display control module 102 may display, on the user terminal 20, the app screen SC2 including a campaign relating to an area in which the accommodation facility is located as a promotion.

The display control system 1 according to Modification Example 1-8 determines whether or not the user is using the selected service. The display control system 1 displays the app screen SC2 on the user terminal 20 based on the result of the determination. Thus, the display control system 1 is able to improve the convenience of the user because the user becomes able to grasp a flexible promotion corresponding to whether or not the user himself or herself is using the selected service.

### Modification Example 1-9

For example, the app screen SC2 in the first embodiment may include the function area A22. In Modification Example 1-9, a case in which the first embodiment and the second embodiment are combined is given as an example. For that reason, the display control server 10 in Modification Example 1-9 includes the usage status information acquisition module 103. The usage status information acquisition module 103 is as described in the second embodiment. In Modification Example 1-9, a case in which the app screen SC2 as in the lower left part or the lower right part of FIG. 2 is displayed is given as an example.

The display control module 102 in Modification Example 1-9 displays, on the user terminal 20, the app screen SC2 including the function area A22 for display regarding a function of the selected service. In Modification Example 1-9, a case in which the first embodiment and the second embodiment are combined is given as an example, and hence the display control module 102 displays, on the user terminal 20, the app screen SC2 including the function area A22 based on the usage status information. The processing for this display is as described in the second embodiment.

The display control module 102 may display, on the user terminal 20, the app screen SC2 including the function area A22 without being particularly based on the usage status information. In this case, the display control server 10 does not include the usage status information acquisition module 103. The display control module 102 displays, on the user terminal 20, the app screen SC2 including the function area A22 regardless of the usage status of the user in the selected service. The display content of the function area A22 is determined in advance for individual services, and is not required to dynamically change depending on the usage status of the user. In this manner, an aspect in which the display control module 102 displays, on the user terminal 20, the app screen SC2 including the function area A22 without being particularly based on the usage status information is also within the scope of the present disclosure. Further, the display control module 102 may display, on the user terminal 20, the app screen SC2 including the function area A22 based on user settings (for example, settings indicating which function the user wishes to display).

The display control system 1 according to Modification Example 1-9 displays, on the user terminal 20, the app screen SC2 including the function area A22 for display regarding a function of the selected service. Thus, the display control system 1 is able to improve the convenience of the user because the user is able to know information regarding a function corresponding to the selected service.

### Modification Example 1-10

For example, in Modification Example 1-9, when there is relevance between a promotion displayed in the promotion area A21 and a function displayed in the function area A22, the user may be interested in the promotion. For that reason, in Modification Example 1-10, a case in which a promotion corresponding to a function displayed in the function area A22 is displayed in the promotion area A21 is described.

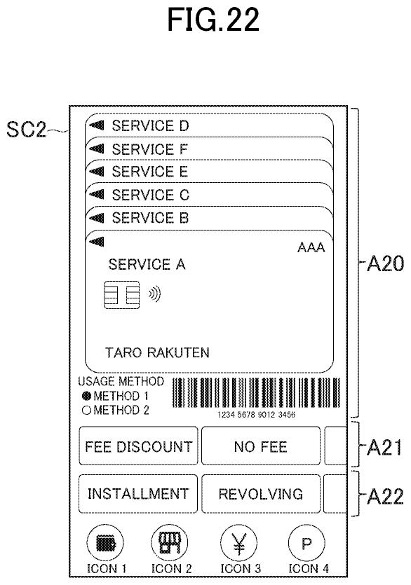

FIG. 22 is a view for illustrating an example of the app screen SC2 in Modification Example 1-10. The display control module 102 in Modification Example 1-10 displays, on the user terminal 20, the app screen SC2 including a promotion corresponding to a function displayed in the function area A22. Which function each promotion corresponds to may be defined in the promotion information. The display control module 102 determines whether or not the promotion is appropriate based on the promotion information of a certain promotion and a function displayed in the function area A22. When it is determined that the promotion is appropriate, the display control module 102 may display the promotion on the app screen SC2.

For example, the display control module 102 may identify a function corresponding to the selected service similarly to the second embodiment, and acquire the promotion information corresponding to the function based on the promotion database DB2. In Modification Example 1-10, a relationship between a function and a promotion may be defined in the promotion database DB2. The display control module 102 acquires the promotion information associated with the identified function in the promotion database DB2, and displays, on the user terminal 20, the app screen SC2 including the promotion based on the promotion information.

In the example of FIG. 22, it is assumed that the selected service is the card of the service A. For example, the display control module 102 arranges the user interface parts respectively indicating “installment payment” and “revolving payment”, which are functions of the card of the service A, in the function area A22. The display control module 102 arranges promotions corresponding to those functions, “installment fee discount” and “no revolving fee,” in the promotion area A21. The display control module 102 displays, on the user terminal 20, the app screen SC2 including the promotion area A21 and the function area A22.

The display control system 1 according to Modification Example 1-10 displays, on the user terminal 20, the app screen SC2 including a promotion corresponding to a function displayed in the function area A22. Thus, the display control system 1 is able to improve the convenience of the user because the user is able to know a promotion corresponding to a function displayed in the function area A22.

### Modification Example 1-11

For example, in Modification Examples 1-9 and 1-10, the function area A22 may be configured such that the user is able to select each of a plurality of functions. This point is similar to that of the second embodiment. When there are a plurality of functions available to the user in the selected service, the display control module 102 may display, on the user terminal 20, the app screen SC2 including the function area A22 indicating each of the plurality of functions.

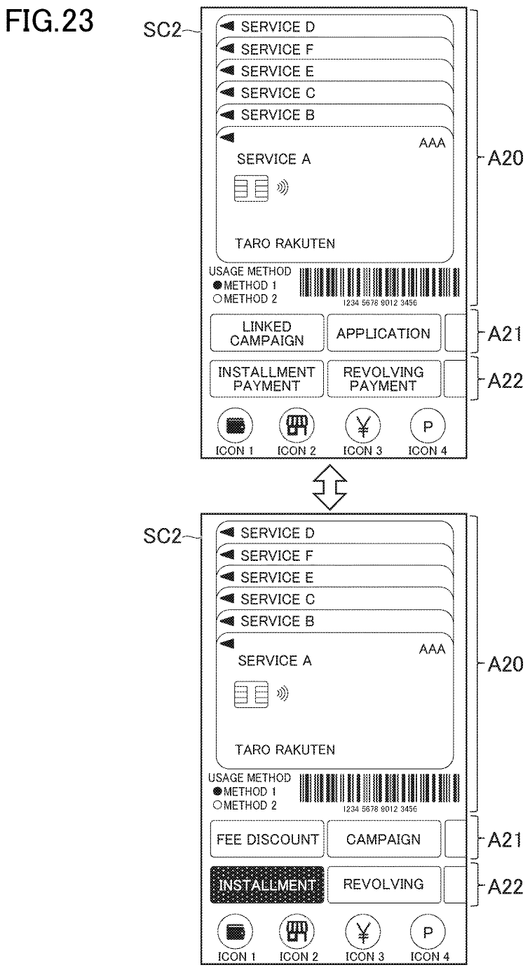

FIG. 23 is a view for illustrating an example of the app screen SC2 in Modification Example 1-11. The display control module 102 in Modification Example 1-11 displays, on the user terminal 20, the app screen SC2 including a promotion corresponding to a selected function, which is a function selected by the user among the plurality of functions. In the upper part of FIG. 23, the app screen SC2 before the user selects the selected function is illustrated. In the example of FIG. 23, the selected service is the card of the service A. In the function area A22, a plurality of functions such as an installment payment function and a revolving payment function are displayed. In the promotion area A21, a general promotion for the card of the service A that is not a promotion specific to a particular function is displayed.

For example, when the user selects the installment payment function in the function area A22, the display control module 102 displays, on the user terminal 20, the app screen SC2 including a promotion corresponding to the installment payment function selected by the user, as illustrated in the lower part of FIG. 23. When the user selects a bonus-month-increased installment payment function in the function area A22, the display control module 102 displays, on the user terminal 20, the app screen SC2 including a promotion corresponding to the bonus-month-increased installment payment function selected by the user. When the user selects the revolving payment function in the function area A22, the display control module 102 displays, on the user terminal 20, the app screen SC2 including a promotion corresponding to the revolving payment function selected by the user.

The function area A22 in Modification Example 1 -11 is configured such that the user is able to select each of a plurality of functions. The display control system 1 displays, on the user terminal 20, the app screen SC2 including a promotion corresponding to the selected function among the plurality of functions. Thus, the display control system 1 is able to improve the convenience of the user because the user becomes able to grasp a promotion corresponding to a selected function. For example, because the selected function is a function intentionally selected by the user, the selected function is a function of which the user is particularly conscious.

### Modification Example 1-12

For example, when the function area A22 is included in the app screen SC2 as in Modification Examples 1-9 to 1-11, the function area A22 corresponding to the usage status may be displayed on the app screen SC2 as in the second embodiment. The display control system 1 according to Modification Example 1-12 further includes the usage status information acquisition module 103. The usage status information acquisition module 103 acquires the usage status information regarding the usage status of the selected function by the user. The usage status information acquisition module 103 in the second embodiment may acquire the usage status information on a function that is not particularly the selected function, but the usage status information acquisition module 103 in Modification Example 1-12 acquires the usage status information on the selected function. The function on which the usage status information is acquired by the usage status information acquisition module 103 is different from that in the second embodiment, but the processing for acquiring the usage status information may be similar to that in the second embodiment.

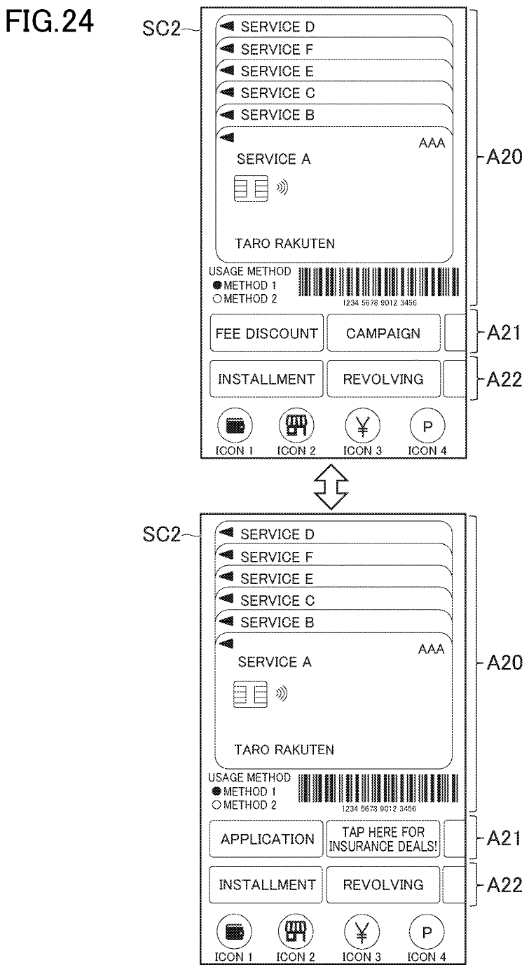

FIG. 24 is a view for illustrating an example of the app screen SC2 in Modification Example 1-12. The display control module 102 in Modification Example 1-12 displays the app screen SC2 on the user terminal 20 based on the usage status information. In the upper part of FIG. 24, the selected service is assumed to be the card of the service A. For example, the display control module 102 determines whether or not the user has used the installment payment function based on the usage status information. When it is determined that the user has never used the installment payment function, the display control module 102 displays a campaign indicating a discount on an installment payment fee in the promotion area A21 as illustrated in the upper part of FIG. 24.

For example, the display control module 102 determines whether or not the user has the second card of the service A based on the usage status information. When it is determined that the user does not have the second card of the service A, the display control module 102 displays a campaign for applying for the second card of the service A in the promotion area A21 as illustrated in the lower part of FIG. 24. In addition, for example, it is assumed that the selected service is the application receiving service. The display control module 102 determines whether or not the user subscribes to insurance in the application receiving service based on the usage status information. When it is determined that the user does not subscribe to insurance in the application receiving service, the display control module 102 displays a promotion indicating subscription to insurance in the promotion area A21.

The display control system 1 according to Modification Example 1-12 acquires the usage status information regarding the usage status of a selected function by the user. The display control system 1 displays the app screen SC2 on the user terminal 20 based on the usage status information. Thus, the display control system 1 is able to improve the convenience of the user because the user becomes able to know a promotion corresponding to the usage status of the user.

### Modification Example 1-13

For example, the plurality of services may include a payment service. When the selected service is a payment service, the display control module 102 in Modification Example 1-13 displays, on the user terminal 20, the app screen SC2 including the function area A22 for display regarding a payment function of the payment service. The payment function is a function included in the payment service. For example, the payment function may be a function of paying a payee such as a store, a function of remittance to another user, a function of adding money to a balance of a payment type used for payment, a function of paying a bill, or another function. The payment function itself may be similar to a function adopted in a publicly-known payment service.

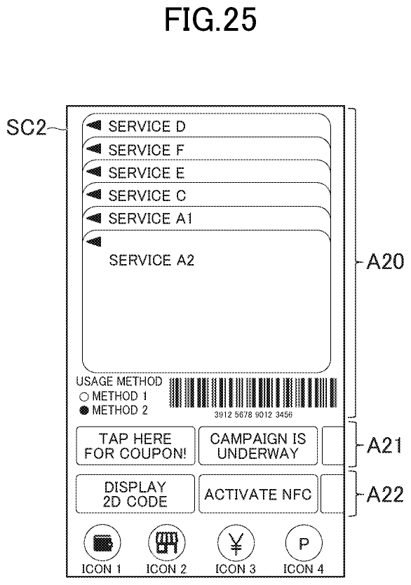

FIG. 25 is a view for illustrating an example of the app screen SC2 in Modification Example 1-13. When the selected service is a payment service, the display control module 102 in Modification Example 1-13 displays, on the user terminal 20, the app screen SC2 including the function area A22 for display regarding a payment function of the payment service. In the example of FIG. 25, the display control module 102 displays, on the user terminal 20, the app screen SC2 including the function area A22 indicating a payment function for displaying a two-dimensional code for payment and a payment function for activating an NFC used for payment. The payment function displayed in the function area A22 is assumed to be indicated in the function information stored in the function database DB3. The payment function is not limited to the example of FIG. 25.

For example, when the user selects a payment function for displaying a two-dimensional code for payment, the user terminal 20 communicates to and from the external server 30 of the payment service, and displays the two-dimensional code for payment on the app screen SC2. The display of the two-dimensional code itself may be performed by processing similar to that of a publicly-known payment service. When the user selects a payment function for activating an NFC, the user terminal 20 activates the NFC of the communication unit 23. The user terminal 20 communicates to and from a terminal of a store or the like through the NFC, and executes processing for payment. Processing for the flow of payment using the NFC may also be performed by processing similar to that of a publicly-known payment service.

The plurality of services in Modification Example 1-13 include a payment service. When the selected service is a payment service, the display control system 1 displays, on the user terminal 20, the app screen SC2 including the function area A22 for display regarding a payment function of the payment service. Thus, the display control system 1 is able to further improve the convenience of the user because the user becomes able to more easily use the payment function.

### 4-2. MODIFICATION EXAMPLES REGARDING SECOND EMBODIMENT

Next, modification examples regarding the second embodiment are described.

### Modification Example 2-1

For example, when the service used by the user in the second embodiment is a payment service, the usage status information acquisition module 103 may acquire the usage status information on the payment service. For example, the usage status information on the payment service may indicate a store in which payment was made, information on a payment type used for the payment, a payment amount, a payment date and time, a product or service subject to the payment, or other information. When remittance between users is possible in the payment service, the usage status information on the payment service may indicate another user to whom the remittance was made, a remittance amount to the other user, and a remittance date and time. For example, when the usage status information indicating that the user has completed an application for the card of the service A is acquired, a function corresponding to the card of the service A (for example, payment using the card of the service A or payment using a code) may be displayed on the app screen SC2. In addition, for example, when the usage status information indicates that a balance of electronic money owned by the user is equal to or less than a predetermined amount, a function for adding electronic money may be displayed on the app screen SC2. When the usage status information indicates that the balance of the electronic money is equal to or greater than the predetermined amount, the function is not required to be displayed on the app screen SC2.

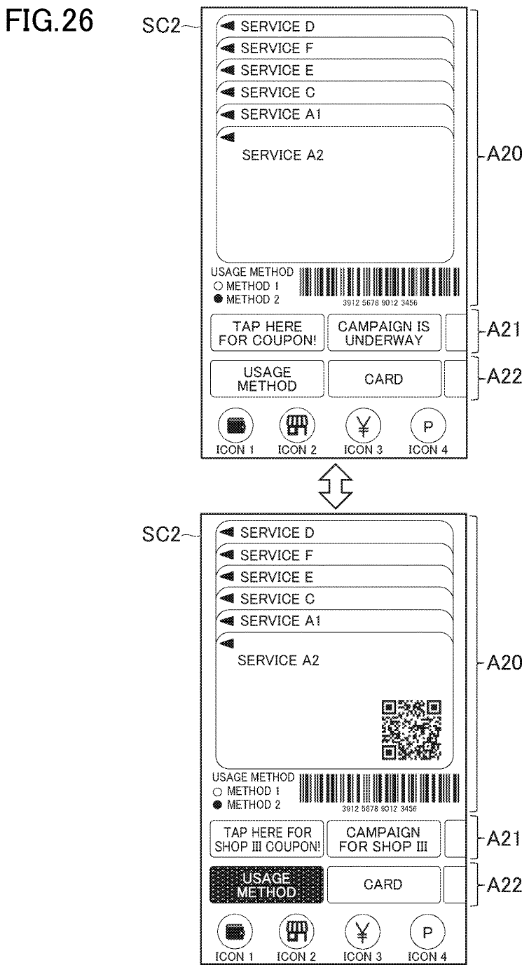

FIG. 26 is a view for illustrating an example of the app screen SC2 in Modification Example 2-1. The display control module 102 in Modification Example 2-1 displays, on the user terminal 20, the app screen SC2 including the service area A20 of the payment service and the function area A22 for display regarding a payment function of the payment service. For example, when the user selects a payment service in the service area A20, the display control module 102 displays, on the app screen SC2, the function area A22 in which any payment type among a plurality of payment types (for example, code payment, credit payment, and near-field communication (NFC) payment) available in the payment service can be selected, as illustrated in the upper part of FIG. 26.

For example, when the user selects a payment type, the display control module 102 displays, on the app screen SC2, information for making payment through the payment type selected by the user, as illustrated in the lower part of FIG. 26. In the example in the lower part of FIG. 26, the user has selected the code payment, and hence the display control module 102 displays, on the app screen SC2, a code for the code payment (for example, a two-dimensional code in the service area A20). When the user selects a payment type other than the code payment, the display control module 102 is only required to display information corresponding to the other payment type on the app screen SC2.

In Modification Example 2-1, the user uses a payment service. The display control system 1 acquires the usage status information on the payment service. The display control system 1 displays, on the user terminal 20, the app screen SC2 including the service area A20 of the payment service and the function area A22 for display regarding a payment function of the payment service. Thus, the display control system 1 can improve the convenience of the user because the user becomes able to more easily use the payment service from the app screen SC2. For example, hitherto, when the user makes payment through use of the user terminal 20 at a brick-and-mortar store, the user makes payment through a plurality of payment services (for example, the card of the service A) associated with a predetermined payment type (for example, code payment using a code). In this case, the payment service corresponds to a funding source for payment. When a plurality of funding sources are associated or changed, it is difficult for the user to grasp which funding source is used to make payment. In this regard, in Modification Example 2-1, when a payment service serving as the funding source is displayed in the service area A20, the funding source is selected. Accordingly, it becomes easier for the user to grasp from the beginning which funding source is used to make payment.

### Modification Example 2-2

For example, the service used by the user may be the application receiving service that receives an application from the user. Details of the application receiving service are as described in Modification Example 1-7. The usage status information acquisition module 103 in Modification Example 2 -2 acquires the application information regarding an application as the usage status information. Details of the application information are also as described in Modification Example 1-7. The usage status information acquisition module 103 in Modification Example 2-2 may be similar to the application information acquisition module 108 in Modification Example 1-7.

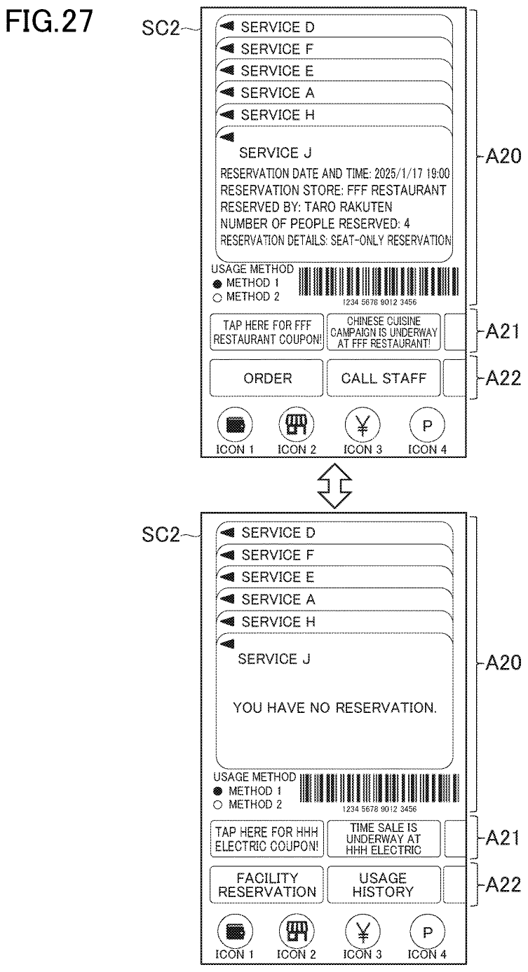

FIG. 27 is a view for illustrating an example of the app screen SC2 in Modification Example 2-2. The display control module 102 in Modification Example 2-2 displays the app screen SC2 on the user terminal 20 based on the application information. Which application information the function displayed on the app screen SC2 is appropriate for is assumed to be defined in the function information. The display control module 102 determines whether or not the function is appropriate based on the function information of a certain function and the application information. When it is determined that the function is appropriate, the display control module 102 displays the function on the app screen SC2.

For example, the display control module 102 displays specific application content indicated by the application information in the function area A22. In the example in the upper part of FIG. 27, it is assumed that the user has reserved a restaurant in the application receiving service that receives a reservation application for a restaurant. In this case, as illustrated in the upper part of FIG. 27, the display control module 102 displays the user interface part for making an order at the restaurant in the function area A22. The function information of the application receiving service indicates that an ordering function is displayed when the application information indicates that the user has made a reservation. The display control module 102 displays, on the user terminal 20, the app screen SC2 as illustrated in the upper part of FIG. 27 based on the function information.

In the example in the lower part of FIG. 27, it is assumed that the user has not reserved a restaurant. In this case, as illustrated in the lower part of FIG. 27, the display control module 102 does not display the user interface part for making an order at the restaurant in the function area A22. The display control module 102 displays the user interface part for receiving a reservation application for a restaurant in the application receiving service in the function area A22. The function information of the application receiving service indicates that the part is displayed when the application information indicates that the user has not made a reservation. The display control module 102 displays, on the user terminal 20, the app screen SC2 as illustrated in the lower part of FIG. 27 based on the function information. When the user has not reserved a restaurant, the display control module 102 may display a function (for example, a function of browsing past reservation history) other than reserving a restaurant in the function area A22.

In Modification Example 2-2, the service used by the user is the application receiving service that receives an application from the user. The display control system 1 acquires the application information as the usage status information. The display control system 1 displays the app screen SC2 on the user terminal 20 based on the application information. This allows the user to view a function corresponding to the application made by himself or herself, and hence the display control system 1 can further improve the convenience of the user.

### Modification Example 2-3

For example, as described somewhat in Modification Example 2-2, the display control module 102 may display, on the user terminal 20, the app screen SC2 for the user to make an application in the application receiving service when the user has not made an application in the application receiving service. As illustrated in the lower part of FIG. 27, the display control module 102 does not display the user interface part for making an order at a restaurant in the function area A22. The display control module 102 may display the user interface part for receiving a reservation application for a restaurant in the application receiving service in the function area A22.

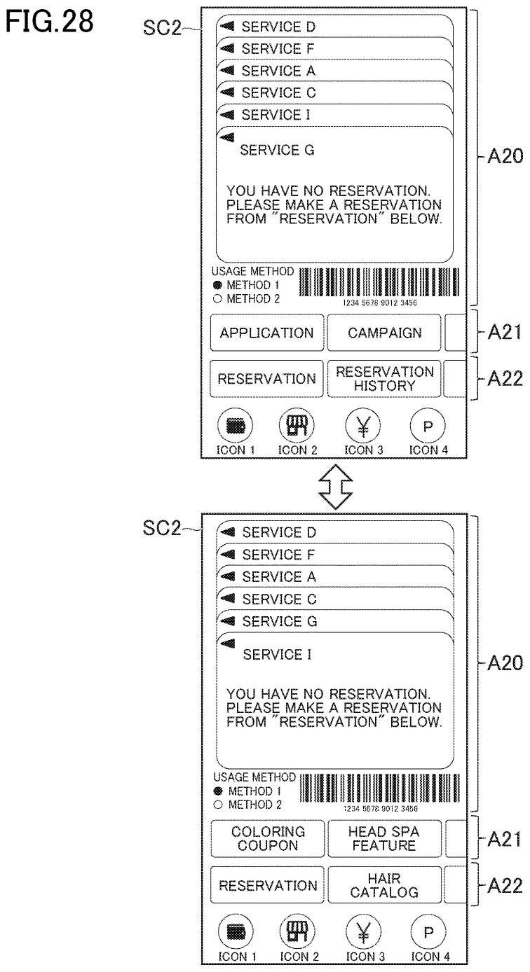

FIG. 28 is a view for illustrating an example of the app screen SC2 in Modification Example 2-3. In the upper part of FIG. 28, a case in which the application receiving service receives a reservation application for an accommodation facility is given as an example. For example, as illustrated in the upper part of FIG. 28, the display control module 102 displays the user interface part for the user to apply for a reservation for an accommodation facility in the function area A22. In the lower part of FIG. 28, a case in which the application receiving service receives a reservation application for a hair salon is given as an example. For example, as illustrated in the lower part of FIG. 28, the display control module 102 displays the user interface part for the user to apply for a reservation for a hair salon in the function area A22.

When the user has not made an application in the application receiving service, the display control system 1 according to Modification Example 2-3 displays, on the user terminal 20, the app screen SC2 for the user to make an application in the application receiving service. Thus, the user who has not made an application in the application receiving service can make the application from the app screen SC2, and hence the display control system 1 can further improve the convenience of the user.

### Modification Example 2-4

For example, as described somewhat in Modification Example 2-3, when the user makes an application in the application receiving service, the display control module 102 may display, on the user terminal 20, the app screen SC2 regarding the application target that is the target of the application. The application target may be any target as described in Modification Example 1-7. The display control module 102 in Modification Example 2-4 displays, on the user terminal 20, the app screen SC2 indicating a function available to the user at the application target. The function information associated with the application receiving service indicates that the function is displayed on the app screen SC2 when the user makes an application.

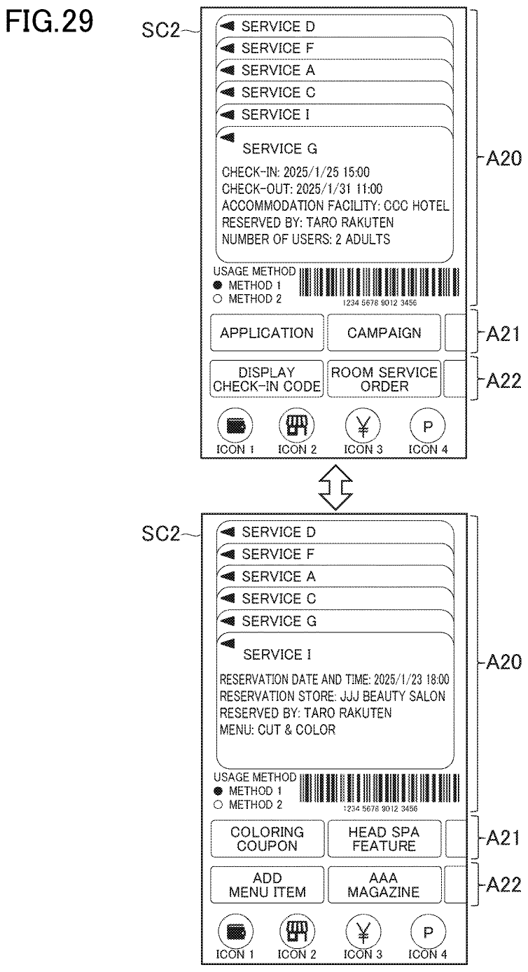

FIG. 29 is a view for illustrating an example of the app screen SC2 in Modification Example 2-4. Which function regarding the application target is to be displayed on the app screen SC2 is assumed to be defined in the function information. For example, the function may be a function of checking in to the application target, a function of making payment at the application target, a function of checking out from the application target, a function of purchasing a product or service sold at the application target, or another function. For example, when the application information indicates that the user has made an application, the display control module 102 displays the function indicated by the function information on the app screen SC2.

In the upper part of FIG. 29, a case in which the application receiving service receives a reservation application for an accommodation facility is given as an example. For example, the display control module 102 displays the user interface part for the user to use a service provided at an accommodation facility indicated by the application information in the function area A22. In the example in the upper part of FIG. 29, the display control module 102 displays a part for checking in to an accommodation facility, a part for ordering room service at an accommodation facility, a part for calling a front desk of an accommodation facility, or another part in the function area A22.

In the lower part of FIG. 29, a case in which the application receiving service receives a reservation application for a hair salon is given as an example. For example, the display control module 102 displays the user interface part for the user to use a service provided at a hair salon indicated by the application information in the function area A22. In the example in the lower part of FIG. 29, the display control module 102 displays a part for ordering an additional menu at a hair salon, a part for browsing magazines at a hair salon, a part for receiving a next reservation application, or another part in the function area A22.

When the user makes an application in the application receiving service, the display control system 1 according to Modification Example 2-4 displays, on the user terminal 20, the app screen SC2 regarding the application target that is the target of the application. Thus, the user who has made an application in the application receiving service can view information of the application target that is the target of the application made by himself or herself, and hence the display control system 1 can further improve the convenience of the user.

### Modification Example 2-5

For example, in Modification Example 2-4, when the user uses the application target, the user may make payment. In a case in which the application target is a restaurant, the user may make payment at the restaurant. In a case in which the application target is an accommodation facility, the user may make payment at the accommodation facility. In this case, it is considered that the convenience of the user is improved when the function displayed in the function area A22 of the app screen SC2 is a payment function. Accordingly, in Modification Example 2-5, a case in which the function area A22 for payment regarding the application target is displayed is described.

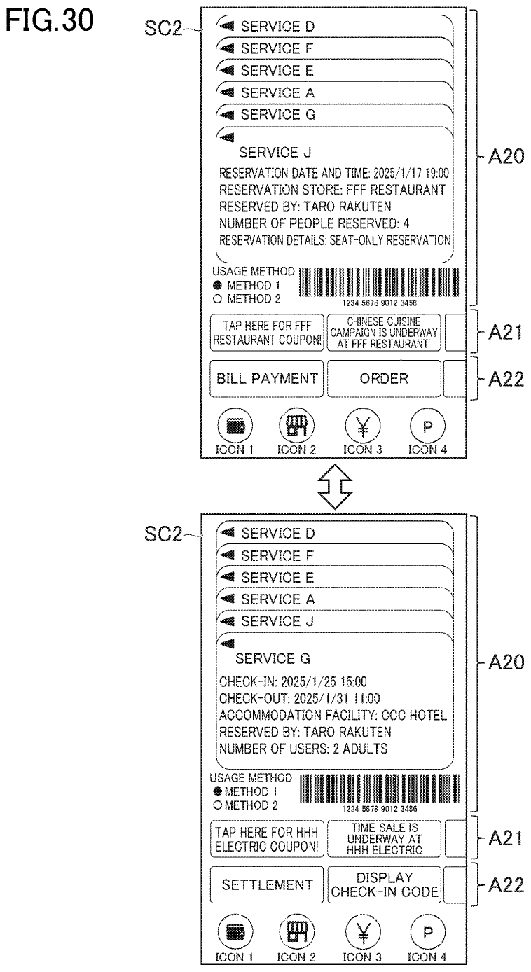

FIG. 30 is a view for illustrating an example of the app screen SC2 in Modification Example 2-5. The display control module 102 in Modification Example 2-5 displays, on the user terminal 20, the app screen SC2 for payment regarding the application target when the user uses the application target. Whether or not the user uses the application target may be determined by a method similar to that of the usage determination module 109 in Modification Example 1-8. That is, the display control system 1 according to Modification Example 2-5 may include the usage determination module 109. The fact that the usage determination module 109 determines that the user uses the selected service may correspond to determining that the user uses the application target in Modification Example 2-5. The case in which the user uses the application target may be a case in which a reservation date and time of the application target arrives, or a date and time a predetermined time after or before the reservation date and time arrives, even when the user does not actually use the application target. In such a case, a function for payment may be displayed on the app screen SC2.

In Modification Example 2-5, which function is appropriate when the user uses the application target is assumed to be defined in the function information. When the user uses the application target, the display control module 102 displays the function indicated by the function information on the app screen SC2. When the user does not use the application target, the display control module 102 displays a function indicated by other function information on the app screen SC2.

For example, assuming that the user has reserved a restaurant, as illustrated in the upper part of FIG. 30, the display control module 102 displays, on the user terminal 20, the app screen SC2 including the function area A22 for payment at the restaurant (bill payment in the example in the upper part of FIG. 30). The payment function may be used through a staff member of the restaurant, or may be used without a staff member (for example, table payment). When the user selects the payment function, the user terminal 20 notifies a terminal of a store or the external server 30 that the payment function is used. The terminal of the store or the external server 30 executes processing for payment based on the notification. The processing for payment may be similar to processing used in a publicly-known payment service.

For example, assuming that the user has reserved an accommodation facility, as illustrated in the lower part of FIG. 30, the display control module 102 displays, on the user terminal 20, the app screen SC2 including the function area A22 for payment at the accommodation facility. The payment function may be used through a staff member of the accommodation facility, or may be used without a staff member (for example, payment at a check-in machine). When the user selects the payment function, the user terminal 20 notifies a terminal of the accommodation facility or the external server 30 that the payment function is used. Similarly to the example in the upper part of FIG. 30, the processing for payment may be similar to processing used in a publicly-known payment service.

When the user uses the application target, the display control system 1 according to Modification Example 2-5 displays, on the user terminal 20, the app screen SC2 for payment regarding the application target. This allows the user to more easily make payment regarding the application target, and hence the display control system 1 can improve the convenience of the user.

### Modification Example 2-6

For example, the application receiving service in Modification Examples 2-2 to 2-5 may receive an application in which a date and time is designated by the user. The user designates a date and time at the time of application. The date and time designated by the user may be a date and time designated in a publicly-known application receiving service. For example, the user designates a reservation date and time, an accommodation date and time, a visit date and time, a usage date and time, or another date and time. The user is only required to designate those dates and times in the application target such as a restaurant or an accommodation facility. The application information indicates the date and time designated by the user.

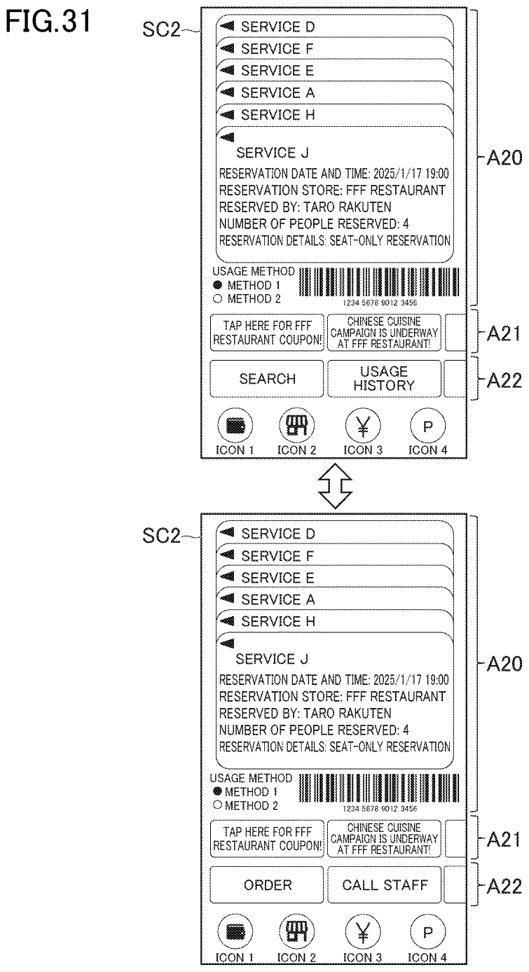

FIG. 31 is a view for illustrating an example of the app screen SC2 in Modification Example 2-6. The display control module 102 in Modification Example 2-6 displays, on the user terminal 20, the app screen SC2 corresponding to the date and time in the application. For example, the display control module 102 determines whether or not to display a function corresponding to the application information based on the date and time in the application. Which function is displayed depending on the determination result may be indicated in the application information. The display control module 102 may determine that a function corresponding to the application information is to be displayed when the date and time in the application arrives. The display control module 102 may determine that a function corresponding to the application information is to be displayed when a date and time a predetermined time before the date and time in the application (for example, a date and time 10 minutes before a reservation date and time of a restaurant) arrives.

In the example in the upper part of FIG. 31, it is assumed that the application receiving service is a service for receiving a reservation application for a restaurant. For example, when a date and time reserved by the user has not arrived, or when a date and time a predetermined time before the date and time reserved by the user has not arrived, as illustrated in the upper part of FIG. 31, the display control module 102 does not display a function corresponding to the application information (for example, a function for making an order at a restaurant that is the application target), and displays, on the user terminal 20, the app screen SC2 including the function area A22 indicating other functions (for example, a function for searching for a restaurant).

For example, when the date and time reserved by the user has arrived, or when the date and time a predetermined time before the date and time reserved by the user has arrived, as illustrated in the lower part of FIG. 31, the display control module 102 displays, on the user terminal 20, the app screen SC2 including the function area A22 indicating a function corresponding to the application information (for example, a function for making an order at a restaurant that is the application target). When the user selects the function, the user terminal 20 communicates to and from a terminal of a store or the external server 30 as required, and executes processing for the user to use the function.

The application receiving service in Modification Example 2-6 receives an application in which a date and time is designated by the user. The display control system 1 displays, on the user terminal 20, the app screen SC2 corresponding to the date and time in the application. This allows the user to grasp a function corresponding to a date and time designated by himself or herself, and hence the display control system 1 can improve the convenience of the user. For example, when a date and time designated by the user has not arrived, a function corresponding to a date and time may be unrequired. In such a case, the display control system 1 does not display a function corresponding to a date and time in the function area A22, to thereby be able to prevent an unrequired function from being displayed. For example, when a date and time designated by the user has arrived, a function corresponding to a date and time may be required. In such a case, the display control system 1 displays a function corresponding to a date and time in the function area A22, to thereby be able to prevent an unrequired function from being displayed.

### Modification Example 2-7

For example, the application receiving service in Modification Examples 2-2 to 2-6 may receive an application in which a place is designated by the user. The user designates a place at the time of application. The place designated by the user may be a place designated in a publicly-known application receiving service. For example, the user designates a place of a facility such as a store, a place at which an event is held, or another place. The user is only required to designate those places in the application target such as a restaurant or an accommodation facility. The application information indicates the place designated by the user.

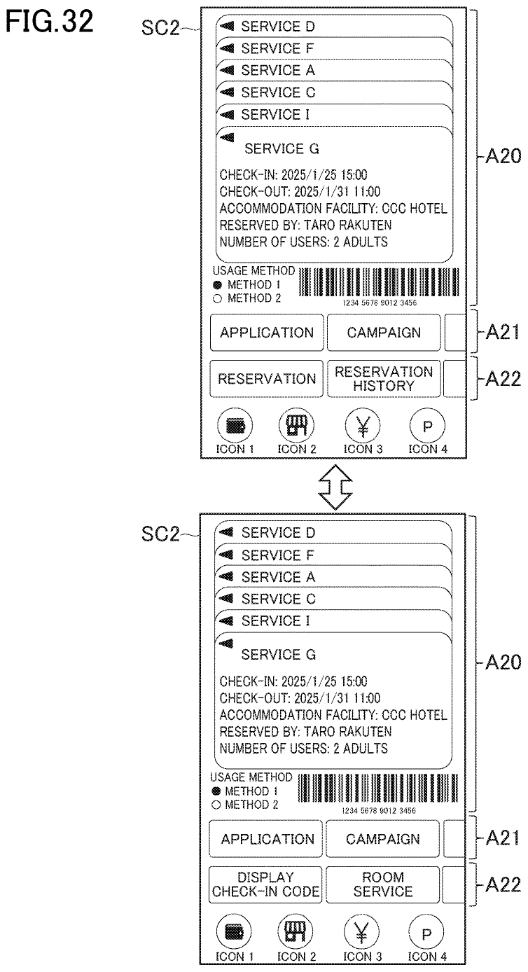

FIG. 32 is a view for illustrating an example of the app screen SC2 in Modification Example 2-7. The display control module 102 in Modification Example 2-7 displays, on the user terminal 20, the app screen SC2 corresponding to the place in the application. For example, the display control module 102 determines whether or not to display a function corresponding to the application information based on a current position of the user. The current position of the user may be acquired similarly to Modification Example 1-5. The display control server 10 in Modification Example 2-7 may include the current position information acquisition module 106. The display control module 102 may determine that a function corresponding to the application information is to be displayed when the user visits the place in the application. The display control module 102 may display a function corresponding to a place indicated by the application information on the app screen SC2 regardless of the current position of the user.

In the example in the upper part of FIG. 32, it is assumed that the application receiving service is a service for receiving a reservation application for an accommodation facility. For example, when the user has not visited a reserved accommodation facility, as illustrated in the upper part of FIG. 32, the display control module 102 does not display a function corresponding to the application information, and displays, on the user terminal 20, the app screen SC2 including the function area A22 indicating other functions. When the user visits the reserved accommodation facility, as illustrated in the lower part of FIG. 32, the display control module 102 displays, on the user terminal 20, the app screen SC2 including the function area A22 indicating a function corresponding to the application information.

The application receiving service in Modification Example 2-7 receives an application in which a place is designated by the user. The display control system 1 displays, on the user terminal 20, the app screen SC2 corresponding to the place in the application. This allows the user to grasp a function corresponding to a place designated by himself or herself, and hence the display control system 1 can improve the convenience of the user. For example, when the user has not visited a designated place, a function corresponding to a place may be unrequired. In such a case, the display control system 1 does not display a function corresponding to a place in the function area A22, to thereby be able to prevent an unrequired function from being displayed. For example, when the user has visited a designated place, a function corresponding to a place may be required. In such a case, the display control system 1 displays a function corresponding to a place in the function area A22, to thereby be able to prevent an unrequired function from being displayed.

### Modification Example 2-8

For example, as described somewhat in the second embodiment, a function of another service different from a service indicated by the usage status information (for example, the selected service) may be displayed in the function area A22. In Modification Example 2-8, a case in which a function of another service is displayed in the function area A22 is given as an example. The display control module 102 in Modification Example 2-8 displays, on the user terminal 20, the app screen SC2 for the other service based on the usage status information. In the function information in Modification Example 2-8, a function of another service different from the selected service is indicated as a function corresponding to the usage status information.

For example, it is assumed that a service indicated by the usage status information is an insurance service. It is assumed that the selected service is a travel reservation service. Thus, the usage status information may indicate the usage status of a service other than the selected service. When the usage status information indicates that the user subscribes to overseas travel insurance in the insurance service, the display control module 102 may display, on the user terminal 20, the app screen SC2 including the function area A22 indicating a function (for example, a function of reserving a destination hotel entered at the time of joining the insurance) relating to the travel reservation service, which is the selected service.

The display control system 1 according to Modification Example 2-8 displays, on the user terminal 20, the app screen SC2 for another service based on the usage status information. This allows the user to use a function of another service different from a service indicated by the usage status information on the app screen SC2, and hence the display control system 1 can improve the convenience of the user.

### Modification Example 2-9

For example, in Modification Example 2-8, a service indicated by the usage status information may be the service F regarding identity verification of the user. The usage status information acquisition module 103 in Modification Example 2-9 acquires the usage status information on the service F. For example, the usage status information on the service F may indicate presence or absence of identity verification, a medium used for identity verification (for example, an identification card or the card of the service A), a date and time at which identity verification was performed, or another usage status. In Modification Example 2-9, a case in which the other service of which a function is displayed in the function area A22 is a payment service is given as an example.

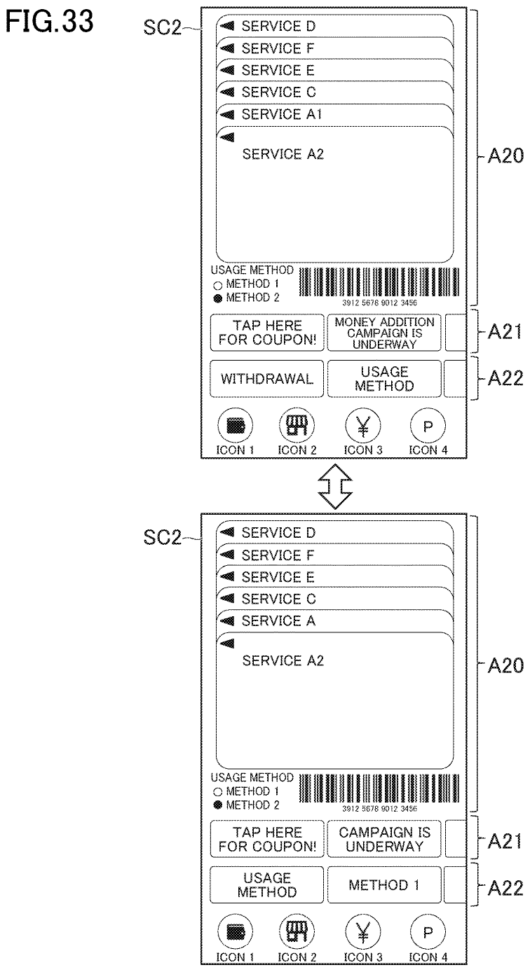

FIG. 33 is a view for illustrating an example of the app screen SC2 in Modification Example 2-9. The display control module 102 in Modification Example 2-9 displays, on the user terminal 20, the app screen SC2 for the payment service based on the usage status information on the service F. For example, when the usage status information indicates that identity verification has been completed, as illustrated in the upper part of FIG. 33, the display control module 102 displays, on the user terminal 20, the app screen SC2 including the function area A22 indicating a “withdrawal” function requiring identity authentication as a function of the payment service.

For example, when the usage status information indicates that identity verification has not been completed, as illustrated in the lower part of FIG. 33, the display control module 102 displays, on the user terminal 20, the app screen SC2 including the function area A22 not indicating the “withdrawal” function requiring identity authentication as a function of the payment service. In this case, the display control module 102 may display a link to the service F in the function area A22. When the user selects the link, the user terminal 20 may access the external server 30 of the service F, and identity verification may be performed. A flow of identity verification may be similar to that of the publicly-known service F.

In Modification Example 2-9, a service indicated by the usage status information is the service F. The other service of which a function is displayed is a payment service. The display control system 1 acquires the usage status information on the service F. The display control system 1 displays, on the user terminal 20, the app screen SC2 for the payment service based on the usage status information on the service F. This allows the user to use a function of the payment service corresponding to the usage status of the service F, and hence the display control system 1 can further improve the convenience of the user.

### Modification Example 2-10

For example, as described in Modification Example 2-9, the usage status information acquisition module 103 acquires identity verification information regarding identity verification as the usage status information. In this case, when identity verification in the service F has been completed, the display control module 102 may display, on the user terminal 20, the app screen SC2 regarding a payment function of the payment service based on the identity verification information. The payment function is a function for executing payment based on a payment type of the user. The payment type may be any type. For example, the payment type may be the card of the service A, electronic money, a balance not called electronic money, another card other than the card of the service A, loyalty points, a bank account, another account other than a bank account, crypto assets, or a wallet.

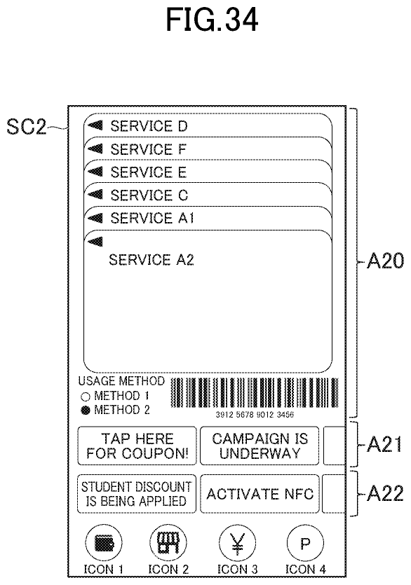

FIG. 34 is a view for illustrating an example of the app screen SC2 in Modification Example 2-10. For example, when the usage status information indicates that identity authentication has been completed, as illustrated in FIG. 34, the display control module 102 may display, on the user terminal 20, the app screen SC2 including the function area A22 indicating that a discount (for example, student discount, mother discount, or senior discount) corresponding to identity verification is provided in association with information (for example, a barcode or a two-dimensional code) for the user to use a payment function. The display control module 102 may display information indicating that a discount has been applied on a payment confirmation screen for confirming payment or a payment completion screen indicating that payment has been completed.

In addition, for example, when the usage status information indicates that identity verification has been completed through use of an individual number card, the display control module 102 refers to the age information of the user stored in the user database DB1, and when a specific discount (for example, senior discount) can be applied, the display control module 102 may display, on the user terminal 20, the app screen SC2 indicating the fact. When the usage status information does not indicate that identity verification has been completed, the display control module 102 may display, on the user terminal 20, the app screen SC2 including the function area A22 that does not indicate information on a specific payment function to which a student discount or the like is applied.

The display control system 1 according to Modification Example 2-10 acquires the identity verification information regarding identity verification as the usage status information. When identity verification in the service F is completed, the display control system 1 displays, on the user terminal 20, the app screen SC2 regarding the payment function of the payment service based on the identity verification information. This allows the user to use a payment function corresponding to completion of identity verification on the app screen SC2, and hence the display control system 1 can further improve the convenience of the user.

### Modification Example 2-11

For example, in Modification Example 2-10, in the service F, a plurality of types of identity verification may be possible. In this case, in the payment service, payment corresponding to the identity verification executed by the user may be executed. For example, when a student card is used for identity verification, payment to which a student discount is applied may be executed. When an employee ID card is used for identity verification, payment to which an employee discount is applied may be executed. When the card of the service A of a specific card company is used for identity verification, payment to which a discount unique to the card company is applied may be executed.

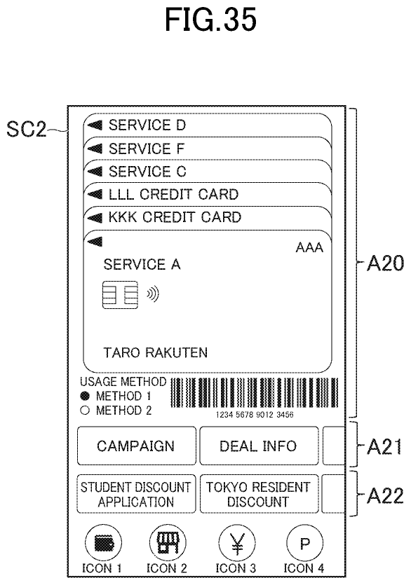

FIG. 35 is a view for illustrating an example of the app screen SC2 in Modification Example 2-11. When a plurality of types of identity verification have been completed, the display control module 102 in Modification Example 2-11 displays the app screen SC2 on the user terminal 20 based on the identity verification information of each of the plurality of types of identity verification. For example, the display control module 102 may display, on the user terminal 20, the app screen SC2 including the function area A22 in which respective payment functions corresponding to a plurality of types of identity verification are arranged in a predetermined order. The predetermined order may be an order designated by the user, or may be a descending order of discount rates. In the example of FIG. 35, the display control module 102 displays a student discount payment with a relatively high discount rate before a card company discount with a relatively low discount rate.

When a plurality of types of identity verification have been completed, the display control system 1 according to Modification Example 2-11 displays the app screen SC2 on the user terminal 20 based on the identity verification information of each of the plurality of types of identity verification. This allows the user to grasp a function corresponding to each of a plurality of types of identity verification, and hence the display control system 1 can further improve the convenience of the user.

### 4-3. MODIFICATION EXAMPLES REGARDING THIRD EMBODIMENT

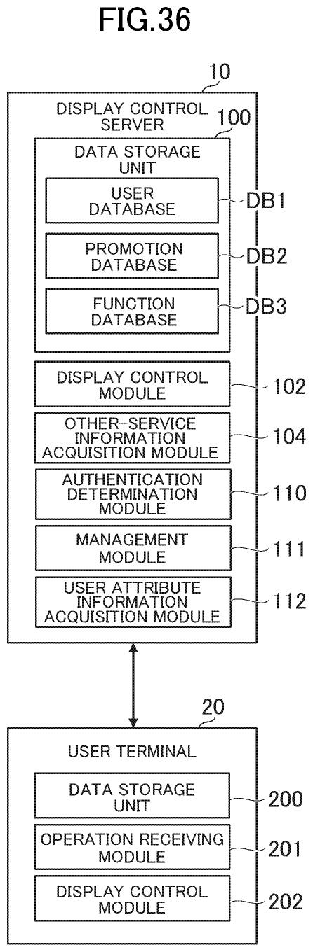

FIG. 36 is a diagram for illustrating an example of functions implemented in modification examples regarding the third embodiment. For example, the display control server 10 includes an authentication determination module 110, a management module 111, and a user attribute information acquisition module 112. Each of the authentication determination module 110, the management module 111, and the user attribute information acquisition module 112 is implemented by the control unit 11.

### Modification Example 3-1

For example, an information amount on the app screen SC2 may change depending on authentication regarding the user. The authentication is identity verification of the user. The authentication may be any authentication adopted in the publicly-known service F. For example, the authentication may be any one of knowledge authentication, possession authentication, or biometric authentication. In Modification Example 3-1, a case in which possession authentication in which a medium such as an identification card or the card of the service A is used is executed is given as an example. The external system 3 provides the service F to the user, and communicates to and from the user terminal 20 to execute authentication. The identity verification executed as authentication may be similar to the example described in the first embodiment and the like.

The display control system 1 according to Modification Example 3-1 further includes the authentication determination module 110. The authentication determination module 110 determines whether or not authentication regarding the user has been completed. The authentication is executed by the external system 3. For example, when the external server 30 of the service F communicates to and from the user terminal 20 to execute authentication, the external server 30 stores the user ID of the user for whom authentication has been completed. When the authentication is completed, the external server 30 transmits the user ID of the user for whom authentication has been completed to the display control server 10. When the display control server 10 receives the user ID from the external server 30, the display control server 10 stores authentication completion information indicating that the authentication of the user having the user ID has been completed in the user database DB1. The authentication determination module 110 determines whether or not the authentication of the user has been completed based on the authentication completion information.

The authentication completion information is not particularly required to be stored in the user database DB1. For example, the authentication determination module 110 may determine whether or not authentication of the user having a certain user ID has been completed by receiving, from the external server 30, information indicating that the authentication of the user has been completed. The authentication determination module 110 may inquire of the external server 30 whether or not authentication of the user for whom authentication has not yet been completed has been completed. In response to the inquiry from the display control server 10, the external server 30 may transmit the user ID of the user for whom authentication has been completed to the display control server 10. The authentication determination module 110 may identify the user for whom authentication has been completed based on the user ID received from the external server 30.

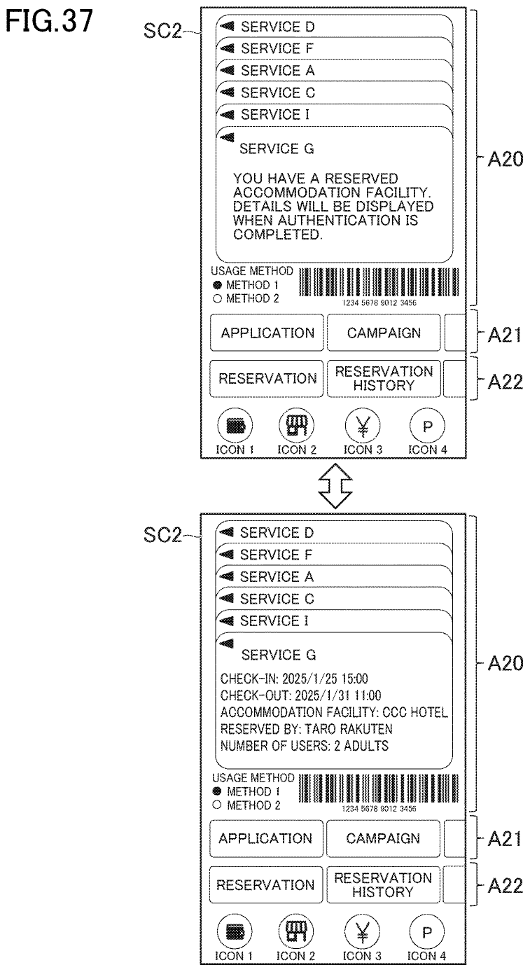

FIG. 37 is a view for illustrating an example of the app screen SC2 in Modification Example 3-1. The display control module 102 in Modification Example 3-1 varies an information amount on the app screen SC2 based on a determination result of the authentication determination module 110. The information amount is an amount of information displayed on the app screen SC2 based on the other-service information. The information amount can also be said to be a degree of detail of information. For example, the information amount may be the number of characters, the number of symbols other than characters, the number of digits of a number, the number of images, the number or length of a moving image, or the number of other pieces of information.

In the example of FIG. 37, it is assumed that the other service is a travel reservation service. For example, when it is determined that the authentication of the user has not been completed, the display control module 102 displays the app screen SC2 based on a part of the other-service information stored in the external system 3, as illustrated in the upper part of FIG. 37. In this case, the other-service information acquisition module 104 may acquire only a part of the other-service information from the external system 3. The other-service information acquisition module 104 may acquire all the other-service information from the external system 3, and the display control module 102 may use only a part of the other-service information to display the app screen SC2 on the user terminal 20. In the example in the upper part of FIG. 37, the display control module 102 displays on the app screen SC2 that the user has made some reservation through the travel reservation service, but does not display specific reservation content thereof on the app screen SC2.

For example, when it is determined that the authentication of the user has been completed, the display control module 102 displays the app screen SC2 based on all the other-service information stored in the external system 3, as illustrated in the lower part of FIG. 37. In the example in the lower part of FIG. 37, the display control module 102 displays details of reservation content reserved by the user in the travel reservation service on the app screen SC2. In this manner, when it is determined that the authentication of the user has not been completed, the display control module 102 may limit the display of the app screen SC2 based on the other-service information, and when it is determined that the authentication of the user has been completed, the display control module 102 may cancel the limitation of the display. The authentication may not be requested every time the app screen SC2 is displayed, but may be requested only at the first time at which the limitation is canceled.

The display control system 1 according to Modification Example 3-1 determines whether or not authentication regarding the user has been completed. The display control system 1 varies an information amount on the app screen SC2 based on a determination result of the authentication determination module 110. As a result, the display control system 1 is able to vary an information amount depending on whether or not authentication has been completed, and hence information can be prevented from leaking to the user terminal 20 of the user for whom authentication has not been completed. That is, the display control system 1 is able to improve the security of information that the user wishes to keep secret from others.

### Modification Example 3-2

For example, the other service provided by the external system 3 may be the application receiving service that receives an application from the user. The application receiving service is as described in Modification Example 1-7. The other-service information acquisition module 104 in Modification Example 3-2 may acquire the application information regarding an application made by the user in the application receiving service as the behavior information. The application information is also as described in Modification Example 1-7. The other-service information acquisition module 104 in Modification Example 3-2 may have a function similar to that of the application information acquisition module 108 in Modification Example 1-7.

The display control module 102 in Modification Example 3-2 displays the app screen SC2 on the user terminal 20 based on the application information. For example, the display control module 102 may display, on the user terminal 20, the app screen SC2 similar to that of FIG. 20 described in Modification Example 1-7 based on the application information. The display control module 102 may display, on the user terminal 20, the app screen SC2 different from that in Modification Example 1-7 based on the application information. The app screen SC2 in Modification Example 1-7 includes a promotion corresponding to the selected service, but the display control module 102 in Modification Example 3-2 may display, on the user terminal 20, the app screen SC2 not particularly including a promotion based on the application information.

In Modification Example 3-2, the other service is the application receiving service that receives an application from the user. The display control system 1 acquires the application information regarding an application made by the user in the application receiving service as the behavior information. The display control system 1 displays the app screen SC2 on the user terminal 20 based on the application information. This allows the user to view the app screen SC2 corresponding to the application made by himself or herself, and hence the display control system 1 can further improve the convenience of the user.

### Modification Example 3-3

For example, the service provided to the user by the display control system 1 may be a payment service available to the user for payment relating to an application. In Modification Example 3-3, the payment service provided by the display control system 1 is simply referred to as “payment service.” Another payment service different from the payment service provided by the display control system 1 is referred to as “another payment service.” The other payment service is provided by the external system 3.

The payment relating to an application refers to payment for the application target in the application receiving service. In a case in which the application target is an accommodation facility, payment of a usage fee for the accommodation facility corresponds to the payment relating to an application. In a case in which the application target is a restaurant, payment of a food and drink fee corresponds to the payment relating to an application. Specific examples of the payment service are as described in the first embodiment and the like. In Modification Example 3-3, it is assumed that the payment service is provided not by the external system 3 but by the display control system 1. Accordingly, in Modification Example 3-3, the management app is an app of a payment service.

In Modification Example 3-3, the other-service information acquisition module 104 acquires the application information when the user uses the payment service for payment relating to an application. For example, the display control server 10 communicates to and from the user terminal 20, a terminal of a store, or the like to execute payment. An execution method for payment may be similar to that of a publicly-known payment service. For example, payment may be executed through a code displayed on the user terminal 20, a code displayed on a terminal of a store, a code posted in a store, an IC chip of the user terminal 20, a wireless communication function of the user terminal 20, a physical card, or another method.

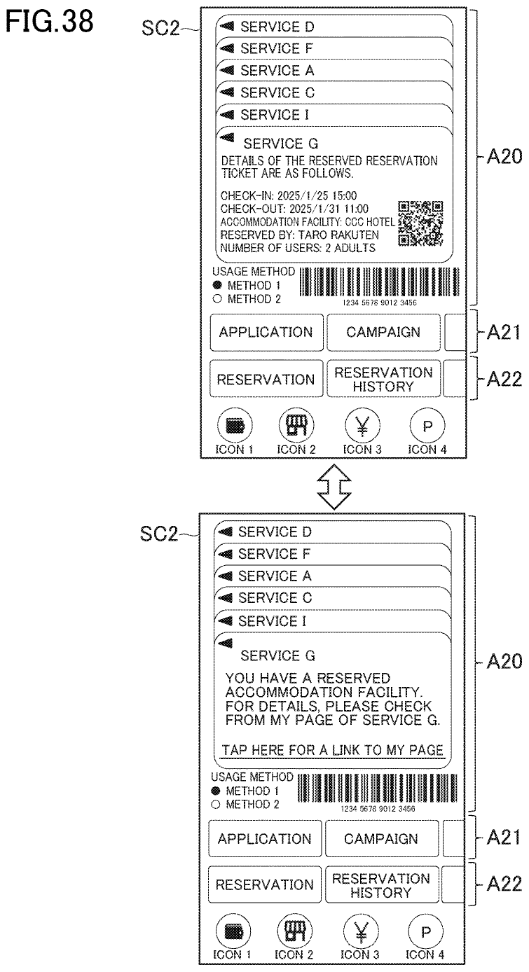

FIG. 38 is a view for illustrating an example of the app screen SC2 in Modification Example 3-3. The display control module 102 in Modification Example 3-3 displays the app screen SC2 on the user terminal 20 based on the application information when the user uses the payment service for payment relating to an application. That is, the display of the app screen SC2 based on the application information is conditioned on the user using the payment service for payment relating to an application. It is assumed that data indicating what type of information is displayed on the app screen SC2 in each of a case in which the payment service is used and a case in which another payment service is used is stored in the data storage unit 100. The display control module 102 refers to the data to identify what type of information is to be displayed on the app screen SC2.

For example, when the user reserves an accommodation facility through a travel reservation service, the user executes payment through a payment service provided by the display control system 1. In this case, as illustrated in the upper part of FIG. 38, the display control module 102 displays, on the user terminal 20, the app screen SC2 indicating a reservation ticket for the accommodation facility. The reservation ticket may include information required at the time of check-in (for example, a code or the like to be held up to a check-in machine by the user).

For example, it is assumed that, when the user reserves an accommodation facility through a travel reservation service, the user executes payment through a payment service other than the payment service provided by the display control system 1 or designates payment at the accommodation facility. In this case, as illustrated in the lower part of FIG. 38, the display control module 102 displays, on the user terminal 20, the app screen SC2 that does not indicate such a reservation ticket for an accommodation facility as in the upper part of FIG. 38. For example, the display control module 102 may display, on the user terminal 20, the app screen SC2 indicating that some reservation has been made, or the app screen SC2 indicating information on an accommodation facility reserved by the user but not indicating a reservation ticket.

The display control system 1 according to Modification Example 3-3 provides a payment service available to the user for payment relating to an application. The display control system 1 acquires the application information when the user uses the payment service for payment relating to an application. When the user uses the payment service for payment relating to an application, the display control system 1 displays the app screen SC2 on the user terminal 20 based on the application information. This allows the user to view the app screen SC2 corresponding to the application information when the user uses the payment service of the display control system 1 for payment relating to an application, and hence the display control system 1 can improve the convenience of the user.

### Modification Example 3-4

For example, in Modification Examples 3-2 and 3-3, the application receiving service may receive an application in which a date and time is designated by the user. The application in which a date and time is designated is as described in Modification Example 2-6. The other-service information acquisition module 104 in Modification Example 3-4 acquires date and time information regarding a date and time in an application as the application information. The date and time information may be similar to the application information described in Modification Example 2-6. The other-service information acquisition module 104 in Modification Example 3-4 may be similar to the application information acquisition module 108 in Modification Example 2-6.

The display control module 102 in Modification Example 3-4 displays the app screen SC2 on the user terminal 20 based on the date and time information. For example, the display control module 102 may display, on the user terminal 20, the app screen SC2 similar to that of FIG. 31 described in Modification Example 2-6 based on the date and time information. For example, when the application receiving service receives an application for a concert, the display control module 102 identifies a date of a concert for which the user has applied through use of the date and time information, displays reservation content indicated by the other-service information on the app screen SC2 until the date, and may not display the reservation content indicated by the other-service information on the app screen SC2 after the date has passed.

The display control module 102 may display, on the user terminal 20, the app screen SC2 different from that in Modification Example 2-6 based on the date and time information. For example, the app screen SC2 in Modification Example 2-6 includes the function area A22, but the display control module 102 in Modification Example 3-4 may display, on the user terminal 20, the app screen SC2 not particularly including the function area A22 based on the date and time information.

The application receiving service in Modification Example 3-4 receives an application in which a date and time is designated by the user. The display control system 1 acquires the date and time information regarding a date and time in an application as the application information. The display control system 1 displays the app screen SC2 on the user terminal 20 based on the date and time information. This allows the user to view the app screen SC2 corresponding to a date and time designated by himself or herself, and hence the display control system 1 can improve the convenience of the user. For example, before a date and time designated by the user has passed, information on reservation content is required, but after the date and time has passed, the information becomes unrequired, and hence the display control system 1 can prevent unrequired information from being displayed.

### Modification Example 3-5

For example, another service provided by the external system 3 may be provided to the user when the user applies for use of the other service. An application is an operation performed by the user to start using the other service. The user operates the user terminal 20 to access the external server 30 and apply for the other service. It is assumed that an application for the other service is performed from a web page of the other service or a screen on an app of the other service.

When the user makes an application, the other-service information acquisition module 104 in Modification Example 3-5 acquires usage information regarding use of the other service as the behavior information. The usage information may be similar to the usage status information in the second embodiment, or may be information not particularly indicating the usage status. For example, assuming that the other service is the card of the service A, the usage information may be card information of the service A such as a card number of the service A. The card of the service A is issued through the behavior of applying by the user, and hence the card information of the service A issued in response thereto is an example of the usage information. The usage information may be other information such as the user basic information registered in the other service.

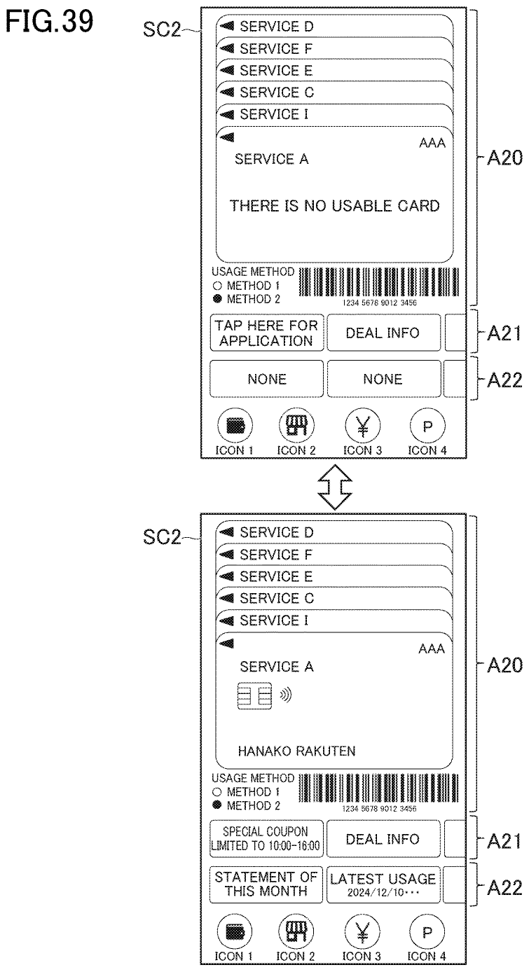

FIG. 39 is a view for illustrating an example of the app screen SC2 in Modification Example 3-5. When the user makes an application, the display control module 102 in Modification Example 3-5 displays the app screen SC2 on the user terminal 20 based on the usage information. It is assumed that data indicating what kind of app screen SC2 is displayed depending on content indicated by the usage information is stored in the data storage unit 100. The display control module 102 refers to the data to determine what kind of app screen SC2 is displayed in a case in which the usage information indicates what kind of content.

For example, when the usage information indicates that the user has not applied for the card of the service A through the service A, as illustrated in the upper part of FIG. 39, the display control module 102 displays, on the user terminal 20, the app screen SC2 not including information regarding use of the card of the service A. In this case, the app screen SC2 does not include information regarding usage content of the card of the service A. The app screen SC2 in this case may include information promoting the user to apply for the card of the service A. This information may indicate a link to the external server 30 of the card of the service A.

For example, when the usage information indicates that the user has applied for the card of the service A through the service A, as illustrated in the lower part of FIG. 39, the display control module 102 displays, on the user terminal 20, the app screen SC2 including information regarding use of the card of the service A. In the example in the lower part of FIG. 39, the content of the card of the service A issued through application by the user is shown in the service area A20. Similarly to the second embodiment, information such as the statement of the card of the service A is shown in the function area A22.

The other service in Modification Example 3-5 is provided to the user when the user applies for use of the other service. When the user makes an application, the display control system 1 acquires the usage information regarding use of the other service as the behavior information. When the user makes an application, the display control system 1 displays the app screen SC2 on the user terminal 20 based on the usage information. This allows the user to view the app screen SC2 corresponding to use of the other service for which the user has applied, and hence the display control system 1 can further improve the convenience of the user.

### Modification Example 3-6

For example, when a large amount of other-service information is acquired and a large number of card faces are displayed on the app screen SC2, display of the app screen SC2 may become complicated. Accordingly, in Modification Example 3-6, a case in which the display control system 1 preferentially displays the other-service information managed at a certain specific place on the app screen SC2, thereby reducing a burden on the user of managing the other-service information, is described.

The display control system 1 according to Modification Example 3-6 includes the management module 111. The management module 111 manages the other-service information in any one of a first place or a second place different from the first place. The place as used herein refers to a virtual place in which the other-service information is managed. For example, a database in which the other-service information is stored, a field in the database, an app in which the other-service information is stored, a storage area in the app, a storage area in the display control server 10, a storage area in a computer other than the display control server 10, or a storage area in an information storage medium corresponds to the place.

The first place is a place in which other-service information to be displayed preferentially is managed. The second place is a place in which the other-service information not to be displayed preferentially is managed. The other-service information managed in the first place is preferentially displayed on the app screen SC2 over the other-service information managed in the second place. That is, the other-service information managed in the second place is less prioritized in display on the app screen SC2 than the other-service information managed in the first place. For example, being displayed on the app screen SC2, having an earlier order on the app screen SC2, or being highlighted on the app screen SC2 corresponds to being preferentially displayed.

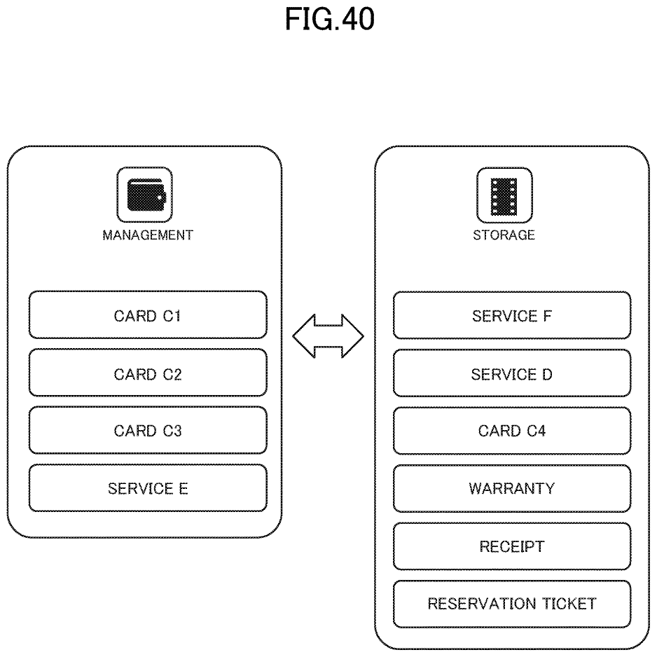

FIG. 40 is a diagram for illustrating an example of a concept of a first place and a second place. A case in which the first place and the second place are apps is described below. Further, a case in which the management app corresponds to the first place and a storage app corresponds to the second place is given as an example. Accordingly, the management app as used herein can be read as the first place. The storage app as used herein can be read as the second place.

The management app may be similar to that in any one of the first embodiment to the third embodiment and Modification Examples 1-1 to 3-5. The storage app is an app different from the management app. In Modification Example 3-6, a case in which the storage app is one service of the management service is given as an example, but the storage app may be a service different from the management service. The storage app is an app for managing the other-service information not managed by the management app. In an example of the menu screen SC1 in the upper left part of FIG. 2, an icon of the storage app is also shown.

For example, when the display control server 10 acquires the other-service information from the external server 30, the management module 111 manages the other-service information by any one of the management app or the storage app. The management module 111 determines whether to manage the other-service information by the management app or the storage app based on a predetermined condition. The predetermined condition may be any condition. For example, the predetermined condition may be: the user designating any one of the management app or the storage app; usage status of another service, current date and time, or content indicated by the other-service information; or another condition.

In Modification Example 3-6, a case in which the user designating any one of the management app or the storage app corresponds to the predetermined condition is given as an example. For example, when the user designates the other-service information to be preferentially displayed, the management module 111 manages the other-service information by the management app. In the example of FIG. 40, the user designates four pieces of other-service information, such as the first card of the service A in the card of the service A, the card of the service C in the service C, the card of the service B in the service B, and the card of the service E in the service E, as those to be managed by the management app. The management module 111 manages those four pieces of other-service information by the management app.

For example, the management module 111 manages the other-service information not designated by the user by the storage app. In the example of FIG. 40, the user does not designate six pieces of other-service information, such as the card of the service F in the service F, a ticket in the service D, the second card of the service A in the card of the service A, a warranty in an electronic commerce service, a receipt in an electronic receipt service, and a reservation ticket in a travel reservation service, as those to be managed by the management app. The management module 111 manages those six pieces of other-service information by the storage app.

For example, the user can change the place in which the other-service information is managed by the management app, the storage app, or another app. When the user performs an operation for managing the other-service information managed by the management app by the storage app, the management module 111 manages the other-service information by the storage app. When the user performs an operation for managing the other-service information managed by the storage app by the management app, the management module 111 manages the other-service information by the management app. In Modification Example 3-6, a case in which each of the other-service information managed by the management app and the other-service information managed by the storage app is stored in the user database DB1 is given as an example.

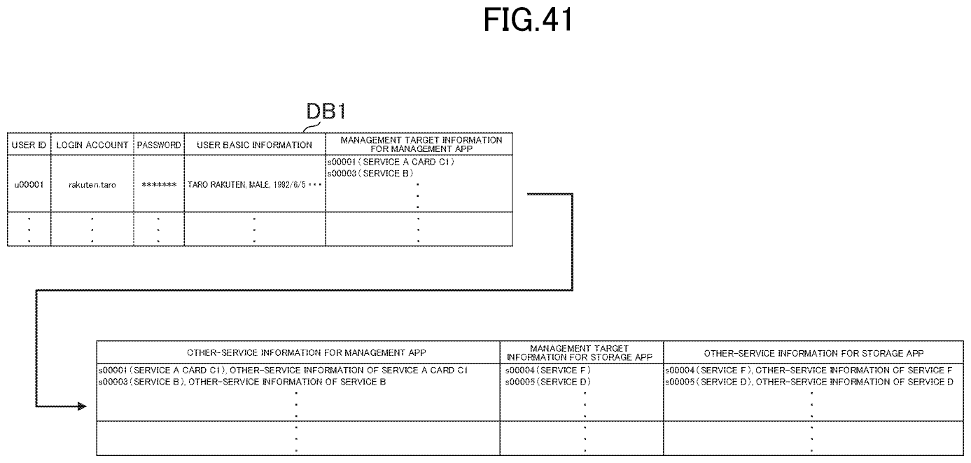

FIG. 41 is a table for showing an example of the user database DB1 in Modification Example 3-6. As shown in FIG. 41, the user database DB1 includes a field for the storage app and a field for the management app. The other-service information stored in the field for the management app is displayed on the management app. The other-service information stored in the field for the storage app is displayed on the storage app. For example, the management module 111 manages the other-service information by the management app by storing the other-service information in the field for the management app. The management module 111 manages the other-service information by the storage app by storing the other-service information in the field for the storage app.

A method of managing the other-service information by the management module 111 is not limited to the above-mentioned example. The management module 111 may manage the other-service information by another method instead of using separate fields as shown in FIG. 41. For example, the management module 111 may manage the other-service information by storing the other-service information and place identification information capable of identifying a place in which the other-service information is managed in association with each other in the user database DB1. The place identification information indicates any one of the management app or the storage app. When the user performs an operation to change a place in which the other-service information is managed, the management module 111 updates the place identification information of the other-service information based on the operation.

Further, the management module 111 may manage the other-service information in a database other than the user database DB1, a computer other than the display control server 10, or an information storage medium. For example, the management module 111 may manage the other-service information in a storage area of each of the management app and the storage app installed in the user terminal 20. In this case, the management module 111 may be implemented by the user terminal 20. The management module 111 records the other-service information managed by the management app in the storage area of the management app. The management module 111 records the other-service information managed by the storage app in the storage area of the storage app.

Further, when the other-service information is managed by the user terminal 20, the management module 111 may manage the other-service information by another method instead of managing the other-service information in the storage area of each of the management app and the storage app. For example, the management module 111 may manage the other-service information by recording the other-service information and the place identification information in the data storage unit 100 in association with each other. The management module 111 may manage the other-service information within one app instead of managing the other-service information by separate apps such as the management app and the storage app. The management module 111 may manage the other-service information without particularly using an app.

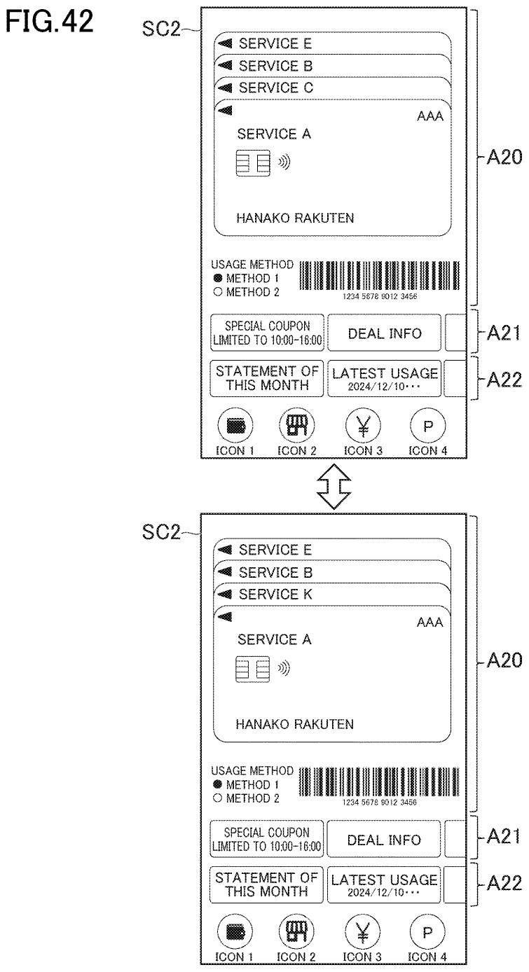

FIG. 42 is a view for illustrating an example of the app screen SC2 in Modification Example 3-6. The display control module 102 in Modification Example 3-6 displays the other-service information managed by the management app on the user terminal 20 preferentially over the other-service information managed by the storage app. In the example in the upper part of FIG. 42, the display control module 102 does not display the other-service information managed by the storage app on the app screen SC2, and displays the other-service information managed by the management app on the app screen SC2.

For example, it is assumed that the user has changed a place in which the other-service information of the card of the service C in the card service of the service C is managed from the management app to the storage app. It is also assumed that the user has changed a place in which the other-service information of a receipt in an electronic receipt service is managed from the storage app to the management app. In this case, as illustrated in the lower part of FIG. 42, the display control module 102 does not display the other-service information of the card of the service C (for example, the card face of the card of the service C) on the app screen SC2, and displays the other-service information of the receipt (for example, the card face of the receipt) on the app screen SC2.

A screen displayed by the display control module 102 is not limited to the example of FIG. 42. For example, the display control module 102 may display the other-service information managed by the storage app on the app screen SC2. The display control module 102 may display those pieces of other-service information on the app screen SC2 such that the other-service information managed by the management app is located at an earlier order position (for example, on a left side or an upper side of the app screen SC2) than the other-service information managed by the storage app. On the app screen SC2 including a plurality of tabs, the display control module 102 may display the other-service information managed by the management app in a first tab (for example, a tab selected by default or a tab arranged on a left side), and display the other-service information managed by the storage app in a second tab. Tabs displayed on the app screen SC2 may be switched in response to the user operation.

For example, within a certain single app, the display control module 102 may display the other-service information managed by the management app on a first screen, and display the other-service information managed by the storage app on a second screen. The first screen may be a top screen of the app, and the second screen may be a screen other than the top screen. When screens in an app have a hierarchical structure, the first screen may be a screen at a higher level than the second screen. The display control module 102 may display the other-service information managed by the management app on a certain screen, and display the other-service information managed by the storage app in a pop-up or a window of the screen.

The display control system 1 according to Modification Example 3-6 manages the other-service information by any one of the management app or the storage app. The display control system 1 displays, on the user terminal 20, the other-service information managed by the management app with priority over the other-service information managed by the storage app. This enables the display control system 1 to reduce a burden on the user of managing the other-service information. For example, the user can manage frequently used other-service information by the management app, and manage infrequently used other-service information by the storage app.

The display control system 1 according to Modification Example 3-6 is not required to include some of the functions described in the first to third embodiments. That is, the display control system 1 according to Modification Example 3-6 is not required to include the selected-service identification module 101, the function for displaying a promotion in the display control module 102, the usage status information acquisition module 103, the function for displaying the function screen in the display control module 102, the other-service information acquisition module 104, and the function for displaying the other-service information in the display control module 102.

For example, the management module 111 may manage each of a plurality of pieces of information in a service provided by the display control system 1, not in another service provided by the external system 3, by any one of the management app or the storage app. That is, the management module 111 may manage information of the own service, not the other-service information, by the management app and the storage app. The management module 111 may manage only information of the own service by the management app and the storage app without managing the other-service information. The display control module 102 may display information of the own service, not the other-service information, depending on the place in which the information is managed.

In this manner, an aspect in which the display control system 1 according to the third embodiment does not include some of the functions described in the first to third embodiments and does not solve the problems corresponding to the first to third embodiments is also within the scope of the present disclosure. Even with such an aspect, a problem of reducing a burden on the user of managing information can be solved. The problems in the present disclosure are not limited to the problems described in the “SUMMARY OF THE INVENTION” section. An aspect in which the display control system 1 solves the problem of reducing a burden on the user of managing information without solving the problems described in the “SUMMARY OF THE INVENTION” section is also within the scope of the present disclosure. When the present application is a divisional application of another patent application serving as a parent application, a claim such as Item (4) in Supplementary Notes described later is also supported by the present disclosure. This point is a matter that can be naturally understood from the description of the present disclosure by those skilled in the art. It is also a matter that can be naturally understood from the examination guidelines of the Japan Patent Office that such a claim satisfies the support requirement when the present application is a divisional application.

### Modification Example 3-7

For example, as described somewhat in the third embodiment, the other-service information acquisition module 104 may be able to acquire the other-service information of each of a plurality of other services. The number of other services may be any number. The other-service information acquisition module 104 may acquire a plurality of pieces of other-service information in one other service. When individual pieces of other-service information are managed by the management app or the storage app as in Modification Example 3-6, which app is to be used for management may be determined based on, for example, the usage frequency of the user. That is, the predetermined condition described in Modification Example 3-6 may be a condition such as the usage frequency of the user.

The management module 111 in Modification Example 3-7 manages the other-service information of each of a plurality of other services by any one of the management app or the storage app based on the usage frequency or the attribute of the user in the each of the plurality of other services. For example, the usage frequency may be the number of times that another service is used in a predetermined period (for example, the most recent one month), the number of times that another service is accessed in the predetermined period, or a payment amount in the predetermined period. In Modification Example 3-7, a case in which the usage frequency is indicated in the other-service information is given as an example, but the usage frequency may be indicated in information other than the other-service information.

For example, when the user uses another service, the external server 30 updates the other-service information so as to indicate the usage frequency of the user. The management module 111 acquires the other-service information indicating the usage frequency from the external server 30. When the usage frequency is indicated in information other than the other-service information, the external server 30 is only required to update the other information so as to indicate the usage frequency of the user when the user uses another service. The management module 111 is only required to acquire the other information from the external server 30. The attribute may be the same as an attribute described in Modification Example 3 -13 described later, or may be an attribute (for example, an attribute designated on the display control system 1 side or the external system 3 side) different from that in Modification Example 3-13. The attribute of the user may be acquired by the user attribute information acquisition module 112 in Modification Example 3-13 described later, or may be acquired by the management module 111.

For example, the management module 111 may manage the other-service information of another service having a relatively high usage frequency by the management app, and manage the other-service information of another service having a relatively low usage frequency by the storage app. The management module 111 may manage the other-service information of another service having a usage frequency a rank of which is equal to or higher than a predetermined rank (for example, the top five) by the management app, and manage the other-service information of another service having a usage frequency a rank of which is lower than the predetermined rank by the storage app. Information indicating the predetermined rank may be stored in the data storage unit 100. The management module 111 is only required to identify the predetermined rank by referring to the information.

For example, the management module 111 may manage the other-service information of another service of which a user attribute is a predetermined attribute by the management app, and manage the other-service information of another service of which the user attribute is not the predetermined attribute by the storage app. Conversely, the management module 111 may manage the other-service information of another service of which the user attribute is not the predetermined attribute by the management app, and manage the other-service information of another service of which the user attribute is the predetermined attribute by the storage app. The predetermined attribute is only required to be determined in advance. Information indicating the predetermined attribute may be stored in the data storage unit 100. The management module 111 is only required to identify the predetermined attribute by referring to the information.

The display control system 1 according to Modification Example 3-7 can acquire the other-service information of each of a plurality of other services. The display control system 1 manages the other-service information of another service by any one of the management app or the storage app based on the usage frequency or the attribute of the user in each of the plurality of other services. As a result, the other-service information is managed by an appropriate app corresponding to the usage frequency or the attribute without the user designating an app for managing the other-service information, and hence the display control system 1 can further reduce a burden on the user of managing the other-service information.

### Modification Example 3-8

For example, in Modification Example 3-7, the management module 111 may manage the other-service information of another service having a usage frequency equal to or higher than a predetermined frequency (for example, five times a month) by the management app, and manage the other-service information of another service having a usage frequency lower than the predetermined frequency by the storage app. Information indicating the predetermined frequency may be stored in the data storage unit 100. The management module 111 is only required to identify the predetermined frequency by referring to the information. The predetermined frequency may be able to be designated by the user. The predetermined frequency may be determined on the display control system 1 side. For example, the predetermined frequency may be determined based on the number of other services or pieces of other-service information.

The display control system 1 according to Modification Example 3-8 manages the other-service information of another service having a usage frequency equal to or higher than the predetermined frequency by the management app, and manages the other-service information of another service having a usage frequency lower than the predetermined frequency by the storage app. Thus, the other-service information is managed by an appropriate app corresponding to the usage frequency without the user designating an app for managing the other-service information, and hence the display control system 1 can further reduce a burden on the user of managing the other-service information.

### Modification Example 3-9

For example, in Modification Examples 3-6 to 3-8, the other-service information may indicate a date and time relating to another service. The date and time indicated by the other-service information may be the same as that in Modification Example 3-4, but in Modification Example 3-9, may be a date and time relating to a service other than the application receiving service in Modification Example 3-4. For example, an expiration date of a warranty of a product purchased by the user through an electronic commerce service may correspond to the date and time relating to another service. The date and time relating to another service is only required to be some date and time managed on the external system 3 side, and is not limited to the date and time in an application as in Modification Example 3-9.

The management module 111 in Modification Example 3-9 determines whether to manage the other-service information by the management app or the storage app based on the date and time indicated by the other-service information. For example, when a date and time indicated by the other-service information arrives, the management module 111 may determine that the other-service information is to be managed by the management app. When a date and time a predetermined time before the date and time indicated by the other-service information arrives, the management module 111 may determine that the other-service information is to be managed by the management app. When the date and time indicated by the other-service information has passed, the management module 111 may determine that the other-service information is to be managed by the management app. When a date and time a predetermined time after the date and time indicated by the other-service information arrives, the management module 111 may determine that the other-service information is to be managed by the management app.

For example, when the date and time indicated by the other-service information arrives, the management module 111 may determine that the other-service information is to be managed by the storage app. When a date and time a predetermined time before the date and time indicated by the other-service information arrives, the management module 111 may determine that the other-service information is to be managed by the storage app. When the date and time indicated by the other-service information has passed, the management module 111 may determine that the other-service information is to be managed by the storage app. When a date and time a predetermined time after the date and time indicated by the other-service information arrives, the management module 111 may determine that the other-service information is to be managed by the storage app.

The other-service information in Modification Example 3-9 indicates a date and time relating to another service. The display control system 1 determines whether to manage the other-service information by the management app or the storage app based on the date and time indicated by the other-service information. As a result, the other-service information is managed by an appropriate app corresponding to a date and time relating to another service without the user designating an app for managing the other-service information, and hence the display control system 1 can further reduce a burden on the user of managing the other-service information.

### Modification Example 3-10

For example, the management module 111 may manage the other-service information by the storage app when the user makes payment relating to another service through a specific payment service. The specific payment service is any one of a plurality of payment services available to the user for the other service. The display control system 1 may provide the specific payment service, or the external system 3 may provide the specific payment service. Assuming that the other-service information is an electronic commerce service, the other-service information may indicate a warranty issued by the electronic commerce service. For example, when the user purchases a product of the electronic commerce service through use of the payment service, the electronic commerce service issues a warranty. The other-service information indicating the warranty is managed by the storage app.

The other-service information indicating the warranty is managed in the second place, and may be moved to the first place as required. A history of a service (for example, a payment service) corresponding to the warranty may be managed in the second place. A history of a service not corresponding to the warranty is not managed in the second place. The warranty may be issued not by an electronic commerce service but by a brick-and-mortar store. In this case, the other-service information indicating the warranty may be provided from a system of a retail service provided by the brick-and-mortar store. For example, an electronic warranty may be issued instead of a paper warranty received by the user at the brick-and-mortar store. The management app or another app (for example, a payment app) may be designated as one of link destinations of the electronic warranty.

For example, assuming that the other service is a travel reservation service, the user can use any payment service among a plurality of payment services including a specific payment service for payment for an accommodation facility in the travel reservation service. Assuming that the other service is an electronic commerce service, the user can use any payment service among a plurality of payment services including a specific payment service for payment for a product sold in the electronic commerce service.

For example, the payment service used by the user may be indicated in the other-service information, or may be indicated in information different from the other-service information. The management module 111 may identify the type of the payment service used by the user by referring to the other-service information, or may identify the type of the payment service used by the user by acquiring the different information from the external system 3. The management module 111 may determine whether or not payment relating to another service has been executed by the user with the specific payment service based on the identified type.

For example, the management module 111 does not manage the other-service information by the storage app when the user does not execute payment relating to another service through a specific payment service, and manages the other-service information by the storage app when the user executes payment relating to another service through a specific payment service. The display control module 102 may display a history of the payment (hereinafter referred to as “normal payment”) on a screen different from the management app and the storage app when the user does not execute payment relating to another service through a specific payment service. The history of the normal payment may be managed in a place different from the management app and the storage app. The display control module 102 may display the history of the normal payment in the function area A22 of the app screen SC2.

The display control system 1 according to Modification Example 3-10 manages the other-service information by the storage app when the user executes payment relating to another service through a specific payment service. This allows the user to manage the other-service information of another service for which payment has been executed through a specific payment service by the storage app, and hence the display control system 1 can improve the convenience of the user.

### Modification Example 3-11

For example, the other service provided by the external system 3 may be the service F. The service F may be similar to that in the first embodiment, Modification Example 2-9, or the like. The other-service information acquisition module 104 in Modification Example 3-11 acquires the identity verification information regarding identity verification of the user in another service as the other-service information. In Modification Example 3-11, the other-service information acquisition module 104 may be similar to the usage status information acquisition module in Modification Example 2-9.

The display control module 102 in Modification Example 3-11 displays the app screen SC2 on the user terminal 20 based on the identity verification information. For example, the display control module 102 may display, on the user terminal 20, the app screen SC2 similar to that of FIG. 33 described in Modification Example 2-9 based on the identity verification information. The display control module 102 may display, on the user terminal 20, the app screen SC2 different from that in Modification Example 2-9 based on the identity verification information. The app screen SC2 in Modification Example 2-9 includes the function area A22, but the display control module 102 in Modification Example 3-11 may display, on the user terminal 20, the app screen SC2 not particularly including the function area A22 (for example, the app screen SC2 including information of an identity verification document such as an individual number card) based on the identity verification information.

The display control system 1 according to Modification Example 3-11 acquires the identity verification information regarding identity verification of the user in another service as the other-service information. The display control system 1 displays the app screen SC2 on the user terminal 20 based on the identity verification information. This allows the user to view the app screen SC2 corresponding to the identity verification information, and hence the display control system 1 can further improve the convenience of the user.

### Modification Example 3-12

For example, the app screen SC2 may include a display area prepared for a specific other service. The display area is used for the specific other service regardless of which service the selected service is. The display control module 102 in Modification Example 3-12 displays, on the user terminal 20, the app screen SC2 including a display area prepared for the specific other service based on the other-service information of the specific other service.

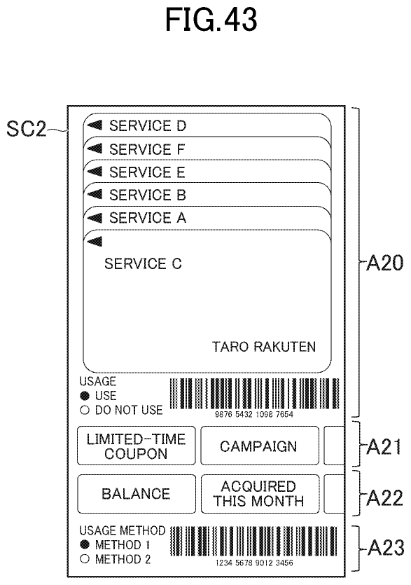

FIG. 43 is a view for illustrating an example of the app screen SC2 in Modification Example 3-12. For example, it is assumed that the specific other service is the card of the service A. The app screen SC2 includes a display area A23 prepared for the card of the service A. As illustrated in FIG. 43, when the selected service is the service C, the display control module 102 displays a promotion of the service C in the promotion area A21 and displays a function of the service C in the function area A22, while displaying information of the card of the service A in the display area A23.

For example, an application status of the card of the service A may be displayed in the display area A23. To combine Modification Example 3-12 with Modification Example 3-1, all information of the card of the service A may be displayed in the display area A23 when the user has completed authentication. When the user changes the selected service to the service B, the display control module 102 displays a promotion of the service B in the promotion area A21 and displays a function f of the service B in the function area A22, while displaying information of the card of the service A in the display area A23. That is, information of the card of the service A is displayed in the display area A23 regardless of the selected service.

The display control system 1 according to Modification Example 3-12 displays, on the user terminal 20, the app screen SC2 including the display area A23 prepared for the specific other service based on the other-service information of the specific other service. This allows the user to reliably view information of the specific other service, and hence the display control system 1 can further improve the convenience of the user. For example, the user may become interested in the other service by viewing information of the other service. Accordingly, the display control system 1 can give the user an incentive to use the other service.

### Modification Example 3-13

For example, the user who uses the display control system 1 may have an attribute associated therewith. The attribute is a classification of the user. For example, the user may be associated with an attribute corresponding to demographic information of the user, an attribute corresponding to the usage status of the user, or another attribute. In Modification Example 3-13, it is assumed that the app screen SC2 corresponding to the other-service information is a screen corresponding to the attribute of the user.

The display control system 1 according to Modification Example 3-13 further includes the user attribute information acquisition module 112. The user attribute information acquisition module 112 acquires user attribute information regarding the user attribute. The user attribute information indicates the user attribute. For example, the user attribute information may indicate an age or an age group, a gender, an area, an annual income bracket, a preference, or another attribute of the user.

In Modification Example 3-13, a case in which the user attribute information is stored in the user database DB1 is given as an example. For example, the user attribute information acquisition module 112 acquires the user attribute information from the user database DB1. The user attribute information may be stored in a database other than the user database DB1, a computer other than the display control Server 10, or an information storage medium. The user attribute information acquisition module 112 may acquire the user attribute information from the other database, the other computer, or the information storage medium.

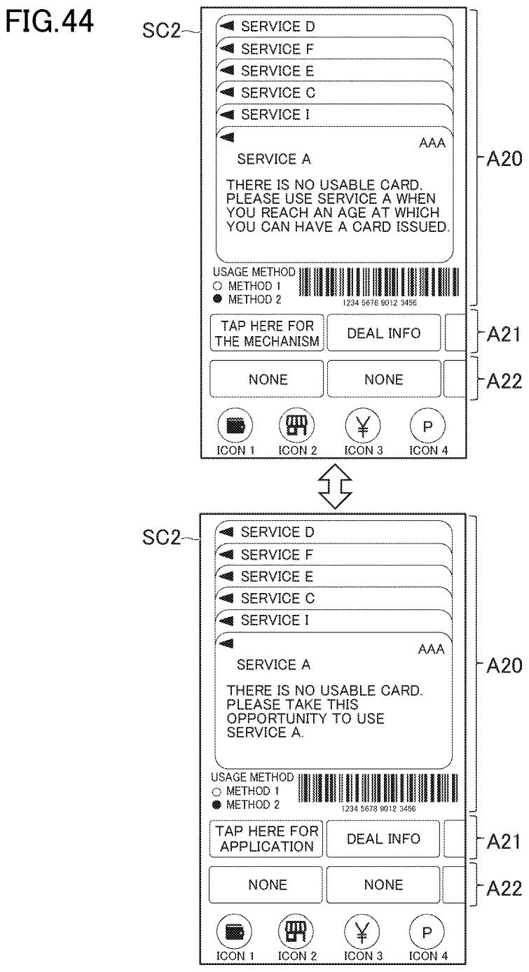

FIG. 44 is a view for illustrating an example of the app screen SC2 in Modification Example 3-13. The display control module 102 in Modification Example 3-13 displays, on the user terminal 20, the app screen SC2 further based on the user attribute information. For example, the display control module 102 determines information to be displayed on the app screen SC2 based on the user attribute information. Assuming that the user attribute information indicates an age, the display control module 102 determines whether or not the age indicated by the user attribute information is a predetermined age. The display control module 102 may determine information to be displayed on the app screen SC2 based on a determination result of whether or not the age is the predetermined age.

In the example in the upper part of FIG. 44, when the age indicated by the user attribute information indicates a minor, the display control module 102 displays, on the user terminal 20, the app screen SC2 that does not include information for applying for the card of the service A. In the example in the lower part of FIG. 44, when the age indicated by the user attribute information indicates an adult, the display control module 102 displays, on the user terminal 20, the app screen SC2 including information for applying for the card of the service A.

The display control system 1 according to Modification Example 3-13 acquires the user attribute information regarding the user attribute. The display control system 1 displays, on the user terminal 20, the app screen SC2 further based on the user attribute information. This allows the user to view the app screen SC2 corresponding to the attribute of the user, and hence the display control system 1 can further improve the convenience of the user.

### Modification Example 3-14

For example, when the other service provided by the external system 3 is a payment service, the other-service information acquisition module 104 may acquire payment type information regarding the payment type of the user in the payment service as the other-service information. The payment type information is information capable of identifying the payment type. For example, when the payment type is the card of the service A, the payment type information may indicate a card number of the card of the service A. When the payment type is electronic money, the payment type information may indicate a number capable of identifying the electronic money. The payment type information may indicate the statement of the card of the service A, a credit limit of the card of the service A, a balance of electronic money, the usage history of electronic money, or other information.

The display control module 102 in Modification Example 3-14 displays the app screen SC2 on the user terminal 20 based on the payment type information. The app screen SC2 in Modification Example 3-14 may be similar to that of FIG. 26 in Modification Example 2-1. For example, the display control module 102 may display information capable of identifying payment type indicated by the payment type information on the app screen SC2. The display control module 102 may display, on the user terminal 20, the app screen SC2 different from that in Modification Example 2-1 based on the payment type information. The app screen SC2 in Modification Example 2-1 includes the function area A22, but the display control module 102 in Modification Example 3-14 may display, on the user terminal 20, the app screen SC2 not particularly including the function area A22 based on the payment type information.

The other service in Modification Example 3-14 is a payment service. The display control system 1 acquires the payment type information regarding the payment type of the user in the payment service as the other-service information. The display control system 1 displays the app screen SC2 on the user terminal 20 based on the payment type information. This allows the user to more easily use the payment service, and hence the display control system 1 can improve the convenience of the user.

### 4-4. OTHER MODIFICATION EXAMPLES

For example, the modification examples described above may be combined.

For example, the external system 3 is not particularly required to be present. That is, the display control system 1 is not particularly required to be able to communicate to and from the external system 3. When the external system 3 is not present, the data described as being stored in the external system 3 may be stored in the display control system 1. The display control system 1 may execute the processing described in the first to third embodiments and the modification examples thereof based on the data stored in the display control system 1 itself. An aspect in which the external system 3 is not present is also within the scope of the present disclosure. Even when the external system 3 is not present, it is a matter that can be naturally understood by those skilled in the art that each problem described in the present disclosure is solved by the processing executed by the display control system 1.

For example, the functions described as being implemented by the display control server 10 may be implemented by the user terminal 20 or another computer. The functions described as being implemented by the display control server 10 may be distributed to a plurality of computers.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A display control system, comprising at least one processor configured to:
acquire usage status information regarding a usage status of a selected application, which is, among a plurality of applications used by a user, one of the plurality of applications that is selected by the user;
display a user interface (UI) screen including an application area that includes a first UI part corresponding to each of the plurality of applications and a function area that includes a second UI part corresponding to a function of at least one of the selected application or another application, on a user terminal of the user based on the usage status information on the selected application; and
switch the selected application based on a selection made for the first UI part in the application area, and change the second UI part displayed in the function area based on the usage status information on the selected application after switching.

2. The display control system according to claim 1,
wherein the plurality of applications include an application receiving application configured to receive an application from the user, and
wherein the at least one processor is configured to:
acquire application information regarding the application as the usage status information; and
display the UI screen on the user terminal based on the application information.

3. The display control system according to claim 2, wherein the at least one processor is configured to display, on the user terminal, the UI screen for the user to make the application by the application receiving application when the user has not made the application by the application receiving application.

4. The display control system according to claim 3, wherein the at least one processor is configured to display, on the user terminal, the UI screen regarding an application target that is a target of the application when the user makes the application by the application receiving application.

5. The display control system according to claim 4, wherein the at least one processor is configured to display, on the user terminal, the UI screen for payment regarding the application target when the user uses the application target.

6. The display control system according to claim 2,
wherein the application receiving application is configured to receive the application in which a date and time is designated by the user, and
wherein the at least one processor is configured to display, on the user terminal, the UI screen corresponding to the date and time in the application.

7. The display control system according to claim 2,
wherein the application receiving application is configured to receive the application in which a place is designated by the user, and
wherein the at least one processor is configured to display, on the user terminal, the UI screen corresponding to the place in the application.

8. The display control system according to claim 1, wherein the at least one processor is configured to display the UI screen of the another application on the user terminal based on the usage status information.

9. The display control system according to claim 8,
wherein the plurality of applications include an application regarding identity verification of the user,
wherein the another application is a payment application, and
wherein the at least one processor is configured to:
acquire the usage status information on the selected application; and
display the UI screen of the payment application on the user terminal based on the usage status information on the selected application.

10. The display control system according to claim 9, wherein the at least one processor is configured to:
acquire identity verification information regarding the identity verification as the usage status information; and
display, on the user terminal, the UI screen regarding a payment function of the payment application based on the identity verification information when the identity verification in the selected application has been completed.

11. The display control system according to claim 10, wherein the at least one processor is configured to display, when a plurality of types of the identity verification have been completed, the UI screen on the user terminal based on the identity verification information of each of the plurality of types of the identity verification.

12. The display control system according to claim 1,
wherein the plurality of applications include a payment application, and
wherein the at least one processor is configured to:
acquire the usage status information on the payment application; and
display, on the user terminal, the UI screen including the application area of the payment application and the function area for display regarding a payment function of the payment application.

13. A display control method, comprising:
acquiring usage status information regarding a usage status of a selected application, which is, among a plurality of applications used by a user, one of the plurality of applications that is selected by the user;
displaying a user interface (UI) screen including an application area that includes a first UI part corresponding to each of the plurality of applications and a function area that includes a second UI part corresponding to a function of at least one of the selected application or another application, on a user terminal of the user based on the usage status information on the selected application; and
switching the selected application based on a selection made for the first UI part in the application area, and changing the second UI part displayed in the function area based on the usage status information on the selected application after switching.

14. A non-transitory information storage medium having stored thereon a program for causing a computer to:
acquire usage status information regarding a usage status of a selected application, which is, among a plurality of applications used by a user, one of the plurality of applications that is selected by the user;
display a user interface (UI) screen including an application area that includes a first UI part corresponding to each of the plurality of applications and a function area that includes a second UI part corresponding to a function of at least one of the selected application or another application, on a user terminal of the user based on the usage status information on the selected application; and
switch the selected application based on a selection made for the first UI part in the application area, and change the second UI part displayed in the function area based on the usage status information on the selected application after switching.
